(19) United States
(12) Patent Application Publication
(10) Pub. No.: US 2016/0189177 A1
(43) Pub. Date: Jun. 30, 2016

(54) Determination of a Purchase Recommendation

(71) Applicant: DecisionGPS, LLC, Irving, TX (US)

(72) Inventors: Ijaz Husain PARPIA, Southlake, TX (US); Gurdip SINGH, Coppell, TX (US)

(21) Appl. No.: 14/584,598

(22) Filed: Dec. 29, 2014

(51) Int. Cl. G06Q 30/02

(52) U.S. Cl. CPC G06Q 30/0202; G06Q 30/0204

(57) ABSTRACT

A method comprising receiving information indicative of a product candidate attribute selection input that identifies a product candidate attribute comprised by a product candidate, the product candidate attribute corresponding with a product attribute that is comprised by a customer store segment sales model, and the customer store segment sales model comprising a set of customer store segments, causing display of a quadrant image that depicts a set of quadrant representations such that each quadrant representation of the set of quadrant representations represents a customer store segment of the set of customer store segments, causing display of a store count indicator that indicates a store count in response to the product candidate attribute selection input, and causing display of a projected buy quantity indicator that indicates a projected buy quantity in response to the product candidate attribute selection input.

### TECHNICAL FIELD

The present application relates generally to determination of a purchase recommendation.

### BACKGROUND

In many circumstances, merchants, purchasers, and/or similar individuals or entities may desire to purchase merchandise, stock inventory, purchase goods, and/or the like. In such circumstances, it may be desirable to allow such a party to make informed and educated purchasing decisions.

### SUMMARY

One or more embodiments may provide an apparatus, a computer readable medium, a non-transitory computer readable medium, a computer program product, and a method for receiving information indicative of a product candidate that comprises a plurality of product candidate attributes, the product candidate attributes corresponding with product attributes that are comprised by a customer store segment sales model, the customer store segment sales model comprising a set of customer store segments, determining a relative intersegment quantity of sales for each customer store segment of the set of customer store segments, determining a relative intrasegment quantity of sales for each customer store segment of the set of customer store segments, generating a set of quadrant representations such that each quadrant representation of the set of quadrant representations represents a customer store segment of the set of customer store segments, and the quadrant representation orthogonally correlates the relative intersegment quantity of sales for the customer store segment and the relative intrasegment quantity of sales for the customer store segment, and determining a purchase recommendation for a customer store segment based, at least in part, on a quadrant representation that represents the customer store segment.

One or more embodiments may provide an apparatus, a computer readable medium, a computer program product, and a non-transitory computer readable medium having means for receiving information indicative of a product candidate that comprises a plurality of product candidate attributes, the product candidate attributes corresponding with product attributes that are comprised by a customer store segment sales model, the customer store segment sales model comprising a set of customer store segments, means for determining a relative intersegment quantity of sales for each customer store segment of the set of customer store segments, means for determining a relative intrasegment quantity of sales for each customer store segment of the set of customer store segments, means for generating a set of quadrant representations such that each quadrant representation of the set of quadrant representations represents a customer store segment of the set of customer store segments, and the quadrant representation orthogonally correlates the relative intersegment quantity of sales for the customer store segment and the relative intrasegment quantity of sales for the customer store segment, and means for determining a purchase recommendation for a customer store segment based, at least in part, on a quadrant representation that represents the customer store segment.

In at least one example embodiment, the determination of the relative intersegment quantity of sales for each customer store segment of the set of customer store segments comprises identification, by way of the customer store segment sales model, of a quantity of sales for the customer store segment that represents a quantity of sales that corresponds with the product candidate attributes, identification, by way of the customer store segment sales model, of a quantity of sales for the set of customer store segments that represents a quantity of sales that correspond with the product candidate attributes, and determination of the relative intersegment quantity of sales for the customer store segment to be the quotient of the quantity of sales for the customer store segment and the quantity of sales for the set of customer store segments.

In at least one example embodiment, the identification of the quantity of sales for the customer store segment comprises receipt of information indicative of the quantity of sales for the customer store segment from at least one of a memory, a repository, a database, or a separate apparatus.

In at least one example embodiment, the identification of the quantity of sales for the set of customer store segments comprises receipt of information indicative of the quantity of sales for the set of customer store segments from at least one of a memory, a repository, a database, or a separate apparatus.

In at least one example embodiment, the identification of the quantity of sales for the set of customer store segments comprises receipt of information indicative of the quantity of sales for each customer store segment of the set of customer store segments from at least one of a memory, a repository, a database, or a separate apparatus, and determination of the quantity of sales for the set of customer store segments to be a summation of the quantity of sales for each customer store segment of the set of customer store segment.

In at least one example embodiment, the determination of the relative intrasegment quantity of sales for each customer store segment of the set of customer store segments comprises identification, by way of the customer store segment sales model, of a quantity of sales for the customer store segment that represents a quantity of sales that corresponds with the product candidate attributes, and determination of the relative intrasegment quantity of sales for the customer store segment to be the quantity of sales for the customer store segment.

In at least one example embodiment, the identification of the quantity of sales for the customer store segment comprises receipt of information indicative of the quantity of sales for the customer store segment from at least one of a memory, a repository, a database, or a separate apparatus.

In at least one example embodiment, the determination of the purchase recommendation for the customer store segment comprises determination of a quadrant of the customer store segment based, at least in part, on the quadrant representation for the customer store segment, wherein the determination of the purchase recommendation is based, at least in part, on the quadrant.

In at least one example embodiment, the quadrant is quadrant one, and the purchase recommendation is based, at least in part, on the quadrant being quadrant one.

In at least one example embodiment, quadrant one is characterized by relative intersegment quantity of sales that is greater than an average of relative intersegment quantity of sales for the set of customer store segments and relative intrasegment quantity of sales that is greater than an average of relative intrasegment quantity of sales for each customer store segment of the set of customer store segments.

In at least one example embodiment, the purchase recommendation is a favorable purchase recommendation.

In at least one example embodiment, the favorable purchase recommendation is a purchase recommendation that strongly recommends purchase of the product candidate for the customer store segment.

In at least one example embodiment, the quadrant is quadrant two, and the purchase recommendation is based, at least in part, on the quadrant being quadrant two.

In at least one example embodiment, quadrant two is characterized by relative intersegment quantity of sales that is greater than an average of relative intersegment quantity of sales for the set of customer store segments and relative intrasegment quantity of sales that is less than an average of relative intrasegment quantity of sales for each customer store segment of the set of customer store segments.

In at least one example embodiment, the purchase recommendation is a favorable purchase recommendation.

In at least one example embodiment, the favorable purchase recommendation is a purchase recommendation that mandates purchase of the product candidate for the customer store segment.

In at least one example embodiment, the quadrant is quadrant three, and the purchase recommendation is based, at least in part, on the quadrant being quadrant three.

In at least one example embodiment, quadrant three is characterized by relative intersegment quantity of sales that is less than an average of relative intersegment quantity of sales for the set of customer store segments and relative intrasegment quantity of sales that is less than an average of relative intrasegment quantity of sales for each customer store segment of the set of customer store segments.

In at least one example embodiment, the purchase recommendation is an unfavorable purchase recommendation.

In at least one example embodiment, the unfavorable purchase recommendation is a purchase recommendation that recommends avoidance of purchase of the product candidate for the customer store segment.

In at least one example embodiment, the quadrant is quadrant four, and the purchase recommendation is based, at least in part, on the quadrant being quadrant four.

In at least one example embodiment, quadrant four is characterized by relative intersegment quantity of sales that is less than an average of relative intersegment quantity of sales for the set of customer store segments and relative intrasegment quantity of sales that is greater than an average of relative intrasegment quantity of sales for each customer store segment of the set of customer store segments.

In at least one example embodiment, the purchase recommendation is a conditional purchase recommendation.

In at least one example embodiment, the conditional purchase recommendation is a favorable purchase recommendation subject to a non-sales criteria.

In at least one example embodiment, the non-sales criteria is at least one of availability of inventory space, historical inventory data, product assortment strategy, or sales duration data.

In at least one example embodiment, the conditional purchase recommendation is a purchase recommendation that conditionally recommends purchase of the product candidate for the customer store segment based, at least in part, on availability of inventory space.

One or more example embodiments further perform receipt of information indicative of the availability of inventory space.

In at least one example embodiment, the receipt of information indicative of the availability of inventory space comprises receipt of information indicative of the availability of inventory space from at least one of a memory, a repository, a database, or a separate apparatus.

In at least one example embodiment, the purchase recommendation is a favorable purchase recommendation based, at least in part, on the information indicative of the availability of inventory space.

In at least one example embodiment, the set of quadrant representations is comprised by at least one of a table representation, a chart representation, a graph representation, or a Cartesian representation.

One or more example embodiments further perform derivation of at least one inference based, at least in part, on the quadrant representation, wherein the determination of the purchase recommendation for the customer store segment is based, at least in part, on the inference.

In at least one example embodiment, the receipt of information indicative of the product candidate comprises receipt of information indicative of the product candidate from at least one of a memory, a repository, a database, or a separate apparatus.

One or more example embodiments further perform receipt of information indicative of the customer store segment sales model.

In at least one example embodiment, the receipt of information indicative of the customer store segment sales model comprises receipt of information indicative of the customer store segment sales model from at least one of a memory, a repository, a database, or a separate apparatus.

One or more example embodiments further perform receipt of information indicative of a product candidate attribute, wherein the plurality of product candidate attributes comprises the product candidate attribute.

In at least one example embodiment, the receipt of information indicative of the product candidate attribute comprises receipt of information indicative of a product candidate attribute selection input that identifies the product candidate attribute.

One or more embodiments may provide an apparatus, a computer readable medium, a non-transitory computer readable medium, a computer program product, and a method for receiving information indicative of a product candidate that comprises a plurality of product candidate attributes, the product candidate attributes corresponding with product attributes that are comprised by a customer store segment sales model, the customer store segment sales model comprising a set of customer store segments, determining a relative intrasegment quantity of sales for each customer store segment of the set of customer store segments, determining a relative product rate of sale for each customer store segment of the set of customer store segments, generating a set of quadrant representations such that each quadrant representation of the set of quadrant representations represents a customer store segment of the set of customer store segments, and the quadrant representation orthogonally correlates the relative intrasegment quantity of sales for the customer store segment and the relative product rate of sale for the customer store segment, and determining a purchase recommendation for a customer store segment based, at least in part, on a quadrant representation that represents the customer store segment.

One or more embodiments may provide an apparatus, a computer readable medium, a computer program product, and a non-transitory computer readable medium having means for receiving information indicative of a product candidate that comprises a plurality of product candidate attributes, the product candidate attributes corresponding with product attributes that are comprised by a customer store segment sales model, the customer store segment sales model comprising a set of customer store segments, means for determining a relative intrasegment quantity of sales for each customer store segment of the set of customer store segments, means for determining a relative product rate of sale for each customer store segment of the set of customer store segments, means for generating a set of quadrant representations such that each quadrant representation of the set of quadrant representations represents a customer store segment of the set of customer store segments, and the quadrant representation orthogonally correlates the relative intrasegment quantity of sales for the customer store segment and the relative product rate of sale for the customer store segment, and means for determining a purchase recommendation for a customer store segment based, at least in part, on a quadrant representation that represents the customer store segment.

In at least one example embodiment, the determination of the relative product rate of sale for each customer store segment of the set of customer store segments comprises identification, by way of the customer store segment sales model, of a quantity of sales for the customer store segment that represents a quantity of sales that corresponds with the product candidate attributes, identification, by way of the customer store segment sales model, of a quantity of products for the customer store segment that represents a quantity of products that correspond with the product candidate attributes, and determination of the relative product rate of sale for the customer store segment to be the quotient of the quantity of sales for the customer store segment and the quantity of products for the customer store segment.

In at least one example embodiment, the identification of the quantity of sales for the customer store segment comprises receipt of information indicative of the quantity of sales for the customer store segment from at least one of a memory, a repository, a database, or a separate apparatus.

In at least one example embodiment, the identification of the quantity of products for the customer store segment comprises receipt of information indicative of the quantity of products for the customer store segment from at least one of a memory, a repository, a database, or a separate apparatus.

In at least one example embodiment, the determination of the relative intrasegment quantity of sales for each customer store segment of the set of customer store segments comprises identification, by way of the customer store segment sales model, of a quantity of sales for the customer store segment that represents a quantity of sales that corresponds with the product candidate attributes, and determination of the relative intrasegment quantity of sales for the customer store segment to be the quantity of sales for the customer store segment.

In at least one example embodiment, the identification of the quantity of sales for the customer store segment comprises receipt of information indicative of the quantity of sales for the customer store segment from at least one of a memory, a repository, a database, or a separate apparatus.

In at least one example embodiment, the determination of the purchase recommendation for the customer store segment comprises determination of a quadrant of the customer store segment based, at least in part, on the quadrant representation for the customer store segment, wherein the determination of the purchase recommendation is based, at least in part, on the quadrant.

In at least one example embodiment, the quadrant is quadrant one, and the purchase recommendation is based, at least in part, on the quadrant being quadrant one.

In at least one example embodiment, quadrant one is characterized by relative intrasegment quantity of sales that is greater than an average of relative intrasegment quantity of sales for the set of customer store segments and relative product rate of sale that is greater than an average of relative product rate of sale for each customer store segment of the set of customer store segments.

In at least one example embodiment, the purchase recommendation is a favorable purchase recommendation.

In at least one example embodiment, the favorable purchase recommendation is a purchase recommendation that strongly recommends purchase of the product candidate for the customer store segment.

In at least one example embodiment, the quadrant is quadrant two, and the purchase recommendation is based, at least in part, on the quadrant being quadrant two.

In at least one example embodiment, quadrant two is characterized by relative intrasegment quantity of sales that is greater than an average of relative intrasegment quantity of sales for the set of customer store segments and relative product rate of sale that is less than an average of relative product rate of sale for each customer store segment of the set of customer store segments.

In at least one example embodiment, the purchase recommendation is a favorable purchase recommendation.

In at least one example embodiment, the favorable purchase recommendation is a purchase recommendation that neutrally recommends purchase of the product candidate for the customer store segment.

In at least one example embodiment, the quadrant is quadrant three, and the purchase recommendation is based, at least in part, on the quadrant being quadrant three.

In at least one example embodiment, quadrant three is characterized by relative intrasegment quantity of sales that is less than an average of relative intrasegment quantity of sales for the set of customer store segments and relative product rate of sale that is less than an average of relative product rate of sale for each customer store segment of the set of customer store segments.

In at least one example embodiment, the purchase recommendation is an unfavorable purchase recommendation.

In at least one example embodiment, the unfavorable purchase recommendation is a purchase recommendation that recommends avoidance of purchase of the product candidate for the customer store segment.

In at least one example embodiment, the quadrant is quadrant four, and the purchase recommendation is based, at least in part, on the quadrant being quadrant four.

In at least one example embodiment, quadrant four is characterized by relative intrasegment quantity of sales that is less than an average of relative intrasegment quantity of sales for the set of customer store segments and relative product rate of sale that is greater than an average of relative product rate of sale for each customer store segment of the set of customer store segments.

In at least one example embodiment, the purchase recommendation is a favorable purchase recommendation.

In at least one example embodiment, the favorable purchase recommendation is a purchase recommendation that mildly recommends purchase of the product candidate for the customer store segment.

In at least one example embodiment, the set of quadrant representations is comprised by at least one of a table representation, a chart representation, a graph representation, or a Cartesian representation.

One or more example embodiments further perform derivation of at least one inference based, at least in part, on the quadrant representation, wherein the determination of the purchase recommendation for the customer store segment is based, at least in part, on the inference.

In at least one example embodiment, the receipt of information indicative of the product candidate comprises receipt of information indicative of the product candidate from at least one of a memory, a repository, a database, or a separate apparatus.

One or more example embodiments further perform receipt of information indicative of the customer store segment sales model.

In at least one example embodiment, the receipt of information indicative of the customer store segment sales model comprises receipt of information indicative of the customer store segment sales model from at least one of a memory, a repository, a database, or a separate apparatus.

One or more example embodiments further perform receipt of information indicative of a product candidate attribute, wherein the plurality of product candidate attributes comprises the product candidate attribute.

In at least one example embodiment, the receipt of information indicative of the product candidate attribute comprises receipt of information indicative of a product candidate attribute selection input that identifies the product candidate attribute.

One or more embodiments may provide an apparatus, a computer readable medium, a non-transitory computer readable medium, a computer program product, and a method for receiving information indicative of a product candidate that comprises a plurality of product candidate attributes, the product candidate attributes corresponding with product attributes that are comprised by a customer store segment sales model, the customer store segment sales model comprising a set of customer store segments, determining a relative intersegment quantity of sales for each customer store segment of the set of customer store segments, determining a relative product rate of sale for each customer store segment of the set of customer store segments, generating a set of quadrant representations such that each quadrant representation of the set of quadrant representations represents a customer store segment of the set of customer store segments, and the quadrant representation orthogonally correlates the relative intersegment quantity of sales for the customer store segment and the relative product rate of sale for the customer store segment, and determining a purchase recommendation for a customer store segment based, at least in part, on a quadrant representation that represents the customer store segment.

One or more embodiments may provide an apparatus, a computer readable medium, a computer program product, and a non-transitory computer readable medium having means for receiving information indicative of a product candidate that comprises a plurality of product candidate attributes, the product candidate attributes corresponding with product attributes that are comprised by a customer store segment sales model, the customer store segment sales model comprising a set of customer store segments, means for determining a relative intersegment quantity of sales for each customer store segment of the set of customer store segments, means for determining a relative product rate of sale for each customer store segment of the set of customer store segments, means for generating a set of quadrant representations such that each quadrant representation of the set of quadrant representations represents a customer store segment of the set of customer store segments, and the quadrant representation orthogonally correlates the relative intersegment quantity of sales for the customer store segment and the relative product rate of sale for the customer store segment, and means for determining a purchase recommendation for a customer store segment based, at least in part, on a quadrant representation that represents the customer store segment.

In at least one example embodiment, the determination of the relative intersegment quantity of sales for each customer store segment of the set of customer store segments comprises identification, by way of the customer store segment sales model, of a quantity of sales for the customer store segment that represents a quantity of sales that corresponds with the product candidate attributes, identification, by way of the customer store segment sales model, of a quantity of sales for the set of customer store segments that represents a quantity of sales that correspond with the product candidate attributes, and determination of the relative intersegment quantity of sales for the customer store segment to be the quotient of the quantity of sales for the customer store segment and the quantity of sales for the set of customer store segments.

In at least one example embodiment, the identification of the quantity of sales for the customer store segment comprises receipt of information indicative of the quantity of sales for the customer store segment from at least one of a memory, a repository, a database, or a separate apparatus.

In at least one example embodiment, the identification of the quantity of sales for the set of customer store segments comprises receipt of information indicative of the quantity of sales for the set of customer store segments from at least one of a memory, a repository, a database, or a separate apparatus.

In at least one example embodiment, the identification of the quantity of sales for the set of customer store segments comprises receipt of information indicative of the quantity of sales for each customer store segment of the set of customer store segments from at least one of a memory, a repository, a database, or a separate apparatus, and determination of the quantity of sales for the set of customer store segments to be a summation of the quantity of sales for each customer store segment of the set of customer store segment.

In at least one example embodiment, the determination of the relative product rate of sale for each customer store segment of the set of customer store segments comprises identification, by way of the customer store segment sales model, of a quantity of sales for the customer store segment that represents a quantity of sales that corresponds with the product candidate attributes, identification, by way of the customer store segment sales model, of a quantity of products for the customer store segment that represents a quantity of products that correspond with the product candidate attributes, and determination of the relative product rate of sale for the customer store segment to be the quotient of the quantity of sales for the customer store segment and the quantity of products for the customer store segment.

In at least one example embodiment, the identification of the quantity of sales for the customer store segment comprises receipt of information indicative of the quantity of sales for the customer store segment from at least one of a memory, a repository, a database, or a separate apparatus.

In at least one example embodiment, the identification of the quantity of products for the customer store segment comprises receipt of information indicative of the quantity of products for the customer store segment from at least one of a memory, a repository, a database, or a separate apparatus.

In at least one example embodiment, the determination of the purchase recommendation for the customer store segment comprises determination of a quadrant of the customer store segment based, at least in part, on the quadrant representation for the customer store segment, wherein the determination of the purchase recommendation is based, at least in part, on the quadrant.

In at least one example embodiment, the quadrant is quadrant one, and the purchase recommendation is based, at least in part, on the quadrant being quadrant one.

In at least one example embodiment, quadrant one is characterized by relative intersegment quantity of sales that is greater than an average of relative intersegment quantity of sales for the set of customer store segments and relative product rate of sale that is greater than an average of relative product rate of sale for each customer store segment of the set of customer store segments.

In at least one example embodiment, the purchase recommendation is a favorable purchase recommendation.

In at least one example embodiment, the favorable purchase recommendation is a purchase recommendation that strongly recommends purchase of the product candidate for the customer store segment.

In at least one example embodiment, the quadrant is quadrant two, and the purchase recommendation is based, at least in part, on the quadrant being quadrant two.

In at least one example embodiment, quadrant two is characterized by relative intersegment quantity of sales that is greater than an average of relative intersegment quantity of sales for the set of customer store segments and relative product rate of sale that is less than an average of relative product rate of sale for each customer store segment of the set of customer store segments.

In at least one example embodiment, the purchase recommendation is a favorable purchase recommendation.

In at least one example embodiment, the favorable purchase recommendation is a purchase recommendation that mandates purchase of the product candidate for the customer store segment.

In at least one example embodiment, the quadrant is quadrant three, and the purchase recommendation is based, at least in part, on the quadrant being quadrant three.

In at least one example embodiment, quadrant three is characterized by relative intersegment quantity of sales that is less than an average of relative intersegment quantity of sales for the set of customer store segments and relative product rate of sale that is less than an average of relative product rate of sale for each customer store segment of the set of customer store segments.

In at least one example embodiment, the purchase recommendation is an unfavorable purchase recommendation.

In at least one example embodiment, the unfavorable purchase recommendation is a purchase recommendation that recommends avoidance of purchase of the product candidate for the customer store segment.

In at least one example embodiment, the quadrant is quadrant four, and the purchase recommendation is based, at least in part, on the quadrant being quadrant four.

In at least one example embodiment, quadrant four is characterized by relative intersegment quantity of sales that is less than an average of relative intersegment quantity of sales for the set of customer store segments and relative product rate of sale that is greater than an average of relative product rate of sale for each customer store segment of the set of customer store segments.

In at least one example embodiment, the purchase recommendation is a conditional purchase recommendation.

In at least one example embodiment, the conditional purchase recommendation is a favorable purchase recommendation subject to a non-sales criteria.

In at least one example embodiment, the non-sales criteria is at least one of availability of inventory space, historical inventory data, product assortment strategy, or sales duration data.

In at least one example embodiment, the conditional purchase recommendation is a purchase recommendation that conditionally recommends purchase of the product candidate for the customer store segment based, at least in part, on availability of inventory space.

One or more example embodiments further perform receipt of information indicative of the availability of inventory space.

In at least one example embodiment, the receipt of information indicative of the availability of inventory space comprises receipt of information indicative of the availability of inventory space from at least one of a memory, a repository, a database, or a separate apparatus.

In at least one example embodiment, the purchase recommendation is a favorable purchase recommendation based, at least in part, on the information indicative of the availability of inventory space.

In at least one example embodiment, the set of quadrant representations is comprised by at least one of a table representation, a chart representation, a graph representation, or a Cartesian representation.

One or more example embodiments further perform derivation of at least one inference based, at least in part, on the quadrant representation, wherein the determination of the purchase recommendation for the customer store segment is based, at least in part, on the inference.

In at least one example embodiment, the receipt of information indicative of the product candidate comprises receipt of information indicative of the product candidate from at least one of a memory, a repository, a database, or a separate apparatus.

One or more example embodiments further perform receipt of information indicative of the customer store segment sales model.

In at least one example embodiment, the receipt of information indicative of the customer store segment sales model comprises receipt of information indicative of the customer store segment sales model from at least one of a memory, a repository, a database, or a separate apparatus.

One or more example embodiments further perform receipt of information indicative of a product candidate attribute, wherein the plurality of product candidate attributes comprises the product candidate attribute.

In at least one example embodiment, the receipt of information indicative of the product candidate attribute comprises receipt of information indicative of a product candidate attribute selection input that identifies the product candidate attribute.

One or more embodiments may provide an apparatus, a computer readable medium, a non-transitory computer readable medium, a computer program product, and a method for identifying a set of stores, the set of stores comprising information indicative of a plurality of stores, and each store of the set of stores comprising a set of store attributes, identifying a first set of customer attributes, segmenting the set of stores into a first set of customer store segments based, at least in part, on correlation between each set of store attributes for each store of the set of stores and customer historical data that corresponds with the first set of customer attributes, such that each the customer store segment of the first set of customer store segments consists of stores that have at least one homogenous customer attribute, identifying a first set of product attributes, generating a first set of product attribute sales summaries that comprises a product attribute sales summary for each customer store segment of the first set of customer store segments, such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sale summaries, determining a first distinctiveness rating for the product attribute sales summary for each customer store segment of the first set of customer store segments, and determining a customer store segment sales model based, at least in part, on the first set of customer store segments, the first set of product attribute sales summaries, and the first distinctiveness rating.

One or more embodiments may provide an apparatus, a computer readable medium, a computer program product, and a non-transitory computer readable medium having means for identifying a set of stores, the set of stores comprising information indicative of a plurality of stores, and each store of the set of stores comprising a set of store attributes, means for identifying a first set of customer attributes, means for segmenting the set of stores into a first set of customer store segments based, at least in part, on correlation between each set of store attributes for each store of the set of stores and customer historical data that corresponds with the first set of customer attributes, such that each the customer store segment of the first set of customer store segments consists of stores that have at least one homogenous customer attribute, means for identifying a first set of product attributes, means for generating a first set of product attribute sales summaries that comprises a product attribute sales summary for each customer store segment of the first set of customer store segments, such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries, means for determining a first distinctiveness rating for the product attribute sales summary for each customer store segment of the first set of customer store segments, and means for determining a customer store segment sales model based, at least in part, on the first set of customer store segments, the first set of product attribute sales summaries, and the first distinctiveness rating.

In at least one example embodiment, a store attribute indicates at least one characteristic of a store associated with the store attribute.

In at least one example embodiment, the store attribute indicates at least one of a location of the associated store, a market region associated with the store, a size of the associated store, a revenue of the associated store, or an average transaction amount associated with the store.

In at least one example embodiment, a plurality of stores of the set of stores have a similar value for a particular store attribute.

In at least one example embodiment, the segmentation of the set of stores into a first set of customer store segments further comprises further segmentation such that each customer store segment of the first set of customer store segments consists of stores that have at least one homogenous customer attribute and at least one homogenous store attribute.

In at least one example embodiment, a product attribute is an attribute of a product that classifies the product within a merchandise category.

In at least one example embodiment, the identification of the quantity of sales associated with each product attribute of the first set of product attributes comprises grouping of products into a set of products that are associated with the product attribute, and determination of the quantity of sales associated with the set of products.

In at least one example embodiment, a customer attribute indicates a characteristic of a customer.

In at least one example embodiment, each customer attribute of the first set of customer attributes indicates an independent characteristic of a customer.

In at least one example embodiment, each customer attribute comprised by the first set of customer attributes is attributable to a variety of customers.

In at least one example embodiment, a plurality of customers represented by the customer historical data have a similar value for a particular customer attribute.

In at least one example embodiment, the customer historical data comprises information that indicates one or more values associated with one or more customer attributes associated with one or more customers.

In at least one example embodiment, the customer historical data comprises at least one of customer loyalty program data, syndicated market data, syndicated shopper data, demographic data, or lifestyle data.

One or more example embodiments further perform identification of sales information comprised by the customer historical data that corresponds with one or more customer attributes of the first set of customer attributes, wherein the correlation between each set of store attributes for each store of the set of stores and customer historical data that corresponds with the first set of customer attributes is based, at least in part, on the sales information.

In at least one example embodiment, the sales information may be indicative of at least one of specific customer transactions, anonymous customer transactions, or customer group transactions.

In at least one example embodiment, a customer group is a collective of members of a community that is presumed to shop at a store of the set of stores.

In at least one example embodiment, the customer historical data comprises a least one statistically accurate representation of a model customer.

In at least one example embodiment, each customer attribute comprised by the first set of customer attributes corresponds with personal data that is represented in customer historical data.

In at least one example embodiment, each customer attribute comprised by the first set of customer attributes is at least one of, a customer income range, a customer ethnicity, a customer age, a customer age range, a customer marital status, a customer dependent status, a customer gender, a customer interest, a customer religion status, or a customer housing status.

In at least one example embodiment, a store is at least one of a selling location or a fulfillment location.

In at least one example embodiment, the store is at least one of a selling location or a fulfillment location that exists in a retail channel.

In at least one example embodiment, a selling location is at least one of a physical store, a mail-order store, a telephone-order store, or an internet store.

In at least one example embodiment, a fulfillment location is at least one of a distribution location, an order fulfillment center, a warehouse location, a sales kiosk, or an order pick-up location.

In at least one example embodiment, a customer store segment identifies a collection of stores that are characterized by a predominant set of customer attributes.

In at least one example embodiment, the segmentation of the set of stores into the first set of customer store segments comprises determination of an average value for each customer attribute of the first set of customer attributes for each store of the set of stores based, at least in part, on the customer historical data, representation of each store of the set of stores as a data point to form a plurality of data points such that each customer attribute of the first set of customer attributes is an independent dimension of the data point, identification of a plurality of clusters of the plurality of data points, and determination that the first set of customer store segments comprises customer store segments that correspond with the plurality of clusters.

In at least one example embodiment, the customer historical data is associated with sales information of each store of the set of stores, and the determination of the average value for each customer attribute of the first set of customer attributes comprises identification of each customer attribute associated with the sales information.

In at least one example embodiment, the determination of the average value for each customer attribute of the first set of customer attributes comprises determination that a customer attribute of the first set of customer attributes is unrepresented by sales information of each store of the set of stores, identification of a secondary attribute that is represented by the sales information, identification of the customer historical data to be a set of data that represents the customer attribute in relation to the secondary attribute, and determination of the average value based, at least in part, on correlation between the secondary attribute and the customer attribute in the set of data.

In at least one example embodiment, the secondary attribute is location information associated with each store of the set of stores, and the set of data comprises census information.

In at least one example embodiment, identification of the plurality of clusters is based, at least in part, on at least one of k-means clustering, centroid-based clustering, hierarchical clustering, linkage clustering, E-M clustering, or distribution-based clustering.

In at least one example embodiment, each customer store segment of the first set of customer store segments is labeled to indicate one or more homogenous customer attribute of each store of the customer store segment.

In at least one example embodiment, the generation of the first set of product attribute sales summaries comprises identification of products that have a product attribute that corresponds with at least one of the product attributes of the first set of product attributes.

In at least one example embodiment, the distinctiveness rating indicates a variation of sales performance across each product attribute sales summary.

In at least one example embodiment, the determination of the first distinctiveness rating is based, at least in part, on an information gain for the product attributes of the first set of product attributes.

One or more example embodiments further perform identification of a second set of customer attributes, segmentation of the set of stores into a second set of customer store segments based, at least in part, on correlation between each store of the set of stores and customer historical data that corresponds with the second set of customer attributes, such that each the customer store segment of the second set of customer store segments consists of stores that have at least one homogenous customer attribute, generation of a second set of product attribute sales summaries that comprises a product attribute sales summary for each customer store segment of the second set of customer store segments, such that each product attribute sales summary of the second set of product attribute sales summaries identifies a quantity of sales associated with each product attribute of the first set of product attributes from each store within a customer store segment of the second set of customer store segments that is associated with the product attribute sales summary of the second set of product attribute sales summaries, and determination of a second distinctiveness rating for the product attribute sales summary for each customer store segment of the second set of customer store segments, wherein the determination of a customer store segment sales model is based, at least in part, on the second distinctiveness rating.

In at least one example embodiment, the determination of the customer store segment sales model comprises determination that the first distinctiveness rating is greater than the second distinctiveness rating, and determination of the customer store segment sales model to comprise the first set of customer store segments based, at least in part, on the determination that the first distinctiveness rating is greater than the second distinctiveness rating.

One or more example embodiments further perform identification of a second set of product attributes, generation of a second set of product attribute sales summaries that comprises a product attribute sales summary for each customer store segment of the first set of customer store segments, such that each product attribute sales summary of the second set of product attribute sales summaries identifies a quantity of sales associated with each product attribute of the second set of product attributes from each store within a customer store segment of the first set of customer store segments that is associated with the product attribute sales summary, and determination of a second distinctiveness rating for the product attribute sales summary for each customer store segment of the first set of customer store segments, wherein the determination of a customer store segment sales model is based, at least in part, on the second distinctiveness rating.

One or more example embodiments further perform identification of a second set of customer attributes, segmentation of the set of stores into a second set of customer store segments based, at least in part, on correlation between each store of the set of stores and customer historical data that corresponds with the second set of customer attributes, such that each the customer store segment of the second set of customer store segments consists of stores that have at least one homogenous customer attribute, identification of a second set of product attributes, generation of a second set of product attribute sales summaries that comprises a product attribute sales summary for each customer store segment of the second set of customer store segments, such that each product attribute sales summary of the second set of product attribute sales summaries identifies a quantity of sales associated with each product attribute of the second set of product attributes from each store within a customer store segment of the second set of customer store segments that is associated with the product attribute sales summary, and determination of a second distinctiveness rating for the product attribute sales summary for each customer store segment of the second set of customer store segments, wherein the determination of a customer store segment sales model is based, at least in part, on the second distinctiveness rating.

In at least one example embodiment, the generation of the first set of product attribute sales summaries excludes information indicative of discount priced sales.

In at least one example embodiment, the customer store segment sales model comprises product rate of sale information and product sales volume information.

In at least one example embodiment, each product attribute sales summary of the first set of product attribute sales summaries comprises rate of sale information and sales volume information.

In at least one example embodiment, the determination of the customer store segment sales model comprises normalization of product attribute sales summary sales volume information to generate the product sales volume information of the customer store segment sales model.

In at least one example embodiment, the normalization of the product attribute sales summary sales volume comprises normalization of the product attribute sales summary sales volume with respect to an aggregate sales volume associated with the customer store segment that is associated with the product sales attribute summary.

In at least one example embodiment, the rate of sale information identifies a number of sales associated with the first set of product attributes in relation to a predetermined period of time.

In at least one example embodiment, the customer store segment sales model is a data structure that correlates data between dimensions of the data structure.

In at least one example embodiment, the customer store segment sales model correlates each customer store segment of the first set of customer store segments with the product rate of sale information and the product sales volume information.

One or more embodiments may provide an apparatus, a computer readable medium, a non-transitory computer readable medium, a computer program product, and a method for receiving information indicative of a product candidate attribute selection input that identifies a product candidate attribute comprised by a product candidate, the product candidate attribute corresponding with a product attribute that is comprised by a customer store segment sales model, and the customer store segment sales model comprising a set of customer store segments, causing display of a quadrant image that depicts a set of quadrant representations such that each quadrant representation of the set of quadrant representations represents a customer store segment of the set of customer store segments, and the quadrant representation orthogonally correlates a relative intersegment quantity of sales for the customer store segment and a relative intrasegment quantity of sales for the customer store segment, causing display of a store count indicator that indicates a store count in response to the product candidate attribute selection input, the display of the store count indicator being concurrent with the display of the quadrant image, and causing display of a projected buy quantity indicator that indicates a projected buy quantity in response to the product candidate attribute selection input, the display of the projected buy quantity indicator being concurrent with the display of the quadrant image.

One or more embodiments may provide an apparatus, a computer readable medium, a computer program product, and a non-transitory computer readable medium having means for receiving information indicative of a product candidate attribute selection input that identifies a product candidate attribute comprised by a product candidate, the product candidate attribute corresponding with a product attribute that is comprised by a customer store segment sales model, and the customer store segment sales model comprising a set of customer store segments, means for causing display of a quadrant image that depicts a set of quadrant representations such that each quadrant representation of the set of quadrant representations represents a customer store segment of the set of customer store segments, and the quadrant representation orthogonally correlates a relative intersegment quantity of sales for the customer store segment and a relative intrasegment quantity of sales for the customer store segment, means for causing display of a store count indicator that indicates a store count in response to the product candidate attribute selection input, the display of the store count indicator being concurrent with the display of the quadrant image, and means for causing display of a projected buy quantity indicator that indicates a projected buy quantity in response to the product candidate attribute selection input, the display of the projected buy quantity indicator being concurrent with the display of the quadrant image.

One or more example embodiments further perform determination of the quadrant image based, at least in part, on the customer store segment sales model, wherein the causation of display of the quadrant image is based, at least in part, on the determination of the quadrant image.

One or more example embodiments further perform determination of the quadrant image based, at least in part, on the customer store segment sales model, wherein the causation of display of the quadrant image is in response to the determination of the quadrant image.

One or more example embodiments further perform receipt of the quadrant image from at least one of a memory, a repository, or a separate apparatus, wherein the causation of display of the quadrant image is based, at least in part, on the receipt of the quadrant image.

In at least one example embodiment, the store count is an aggregate count of stores comprised by the customer store segment sales model.

One or more example embodiments further perform determination of the store count to be a summation of a number of stores comprised by each set of stores for each customer store segment of the set of customer store segments.

In at least one example embodiment, the display of the store count indicator is based, at least in part, on the determination of the store count.

In at least one example embodiment, the display of the store count indicator is in response to the determination of the store count.

In at least one example embodiment, the projected buy quantity is a recommended purchase order for the product candidate.

One or more example embodiments further perform determination of the projected buy quantity to be a product of a rate of sale, a sales duration, and the store count.

In at least one example embodiment, the display of the projected buy quantity indicator is in response to the determination of the projected buy quantity.

In at least one example embodiment, the display of the projected buy quantity indicator is based, at least in part, on the determination of the projected buy quantity.

In at least one example embodiment, the display of the projected buy quantity indicator is performed such that the projected buy quantity indicator is proximate to the store count indicator.

In at least one example embodiment, the projected buy quantity indicator being proximate to the store count indicator is associated with the projected buy quantity indicator and the store count indicator being displayed within a predefined display region.

In at least one example embodiment, the projected buy quantity indicator being proximate to the store count indicator is associated with the projected buy quantity indicator being displayed at a position that is adjacent to a position of the store count indicator.

In at least one example embodiment, the display of the store count indicator is performed such that the store count indicator is proximate to the projected buy quantity indicator.

One or more example embodiments further perform causation of display of an aggregate rate of sale indicator that indicates an aggregate rate of sale in response to the product candidate attribute selection input, such that the display of the aggregate rate of sale indicator is concurrent with the display of the quadrant image.

One or more example embodiments further perform determination of the aggregate rate of sale to be an average of a rate of sale attributable to the product candidate for each store comprised by each customer store segment of the set of customer store segments.

In at least one example embodiment, the set of customer store segments includes a first customer store segment and a second customer store segment, and the projected buy quantity is based, at least in part, on the first customer store segment and the second customer store segment.

One or more example embodiments further perform receipt of information indicative of a customer store segment exclusion input that indicates exclusion of the second customer store segment.

One or more example embodiments further perform determination of a changed projected buy quantity in response to the customer store segment exclusion input that indicates exclusion of the second customer store segment.

In at least one example embodiment, the changed projected buy quantity is based, at least in part, on the first customer store segment.

In at least one example embodiment, the changed projected buy quantity is independent of the second customer store segment based, at least in part, on the customer store segment exclusion input that indicates exclusion of the second customer store segment.

One or more example embodiments further perform causation of display of a changed projected buy quantity indicator that indicates the changed projected buy quantity in response to the customer store segment exclusion input, the display of the changed projected buy quantity indicator being concurrent with the display of the quadrant image.

One or more example embodiments further perform causation of termination of display of the projected buy quantity indicator.

In at least one example embodiment, the causation of termination of display of the projected buy quantity indicator is in response to the customer store segment exclusion input that indicates exclusion of the second customer store segment.

One or more example embodiments further perform receipt of information indicative of a customer store segment inclusion input that indicates inclusion of the second customer store segment.

One or more example embodiments further perform determination of a changed projected buy quantity in response to the customer store segment inclusion input that indicates inclusion of the second customer store segment.

In at least one example embodiment, the changed projected buy quantity is based, at least in part, on the first customer store segment and the second customer store segment.

In at least one example embodiment, the changed projected buy quantity is determined to be the projected buy quantity.

One or more example embodiments further perform causation of display of a customer store segment store count indicator that indicates a store count for each customer store segment of the set of customer store segments, the display of the customer store segment store count indicator being concurrent with the display of the quadrant image.

In at least one example embodiment, the customer store segment store count indicator is a customer store segment store count table that correlates each customer store segment of the set of customer store segments to a store count.

In at least one example embodiment, the customer store segment store count indicator corresponds with the customer store segment sales model.

One or more example embodiments further perform causation of display of a seasonal profile indicator that indicates a seasonal profile for each customer store segment of the set of customer store segments, the display of the seasonal profile indicator being concurrent with the display of the quadrant image.

In at least one example embodiment, the seasonal profile indicator is a seasonal profile graph that indicates a seasonal profile for each customer store segment of the set of customer store segments.

One or more example embodiments further perform receipt of information indicative of the seasonal profile from at least one of a memory, a repository, or a separate apparatus.

In at least one example embodiment, the seasonal profile is comprised by the customer store segment sales model.

One or more example embodiments further perform determination of the seasonal profile indicator based, at least in part, on the seasonal profile for each customer store segment of the set of customer store segments.

In at least one example embodiment, the seasonal profile indicator indicates a sales duration for each customer store segment of the set of customer store segments.

In at least one example embodiment, the sales duration comprises information indicative of an interval associated with the product candidate being offered for sale.

In at least one example embodiment, the sales duration is indicative of at least one of a sales start date or a sales end date.

In at least one example embodiment, the product candidate attribute selection input is an input that indicates selection of the product candidate attribute from a predetermined set of product candidate attributes.

In at least one example embodiment, the predetermined set of product candidate attributes is represented by a drop-down menu, and the product candidate attribute selection input is an input that selects the product candidate attribute from the drop-down menu.

In at least one example embodiment, the product candidate attribute selection input is an input that indicates selection of the product candidate attribute by way of a product candidate attribute icon that represents the product candidate attribute.

In at least one example embodiment, the product candidate attribute icon is at least one of a graphical icon, a textual icon, a selection button, a radial button, or a check box.

One or more example embodiments further perform causation of display of a product candidate attribute indicator that indicates the product candidate attribute.

In at least one example embodiment, the display of the product candidate attribute indicator is in response to the product candidate attribute selection input.

In at least one example embodiment, the display of the product candidate attribute indicator is concurrent with the display of the quadrant image.

One or more example embodiments further perform causation of display of a product candidate attribute type indicator that indicates a product candidate attribute type of the product candidate attribute.

In at least one example embodiment, the display of the product candidate attribute type indicator is concurrent with the display of the quadrant image.

In at least one example embodiment, the product candidate attribute type is indicative of at least one characteristic associated with the product candidate attribute.

In at least one example embodiment, the product candidate attribute type is descriptive of a classification of the product candidate attribute.

In at least one example embodiment, the causation of display of the store count indicator is performed absent an intervening input.

In at least one example embodiment, an intervening input is an input that is received intermediate to the receipt of the product candidate attribute selection input and the causation of display of the store count indicator.

In at least one example embodiment, the causation of display of the projected buy quantity indicator is performed absent an intervening input.

In at least one example embodiment, an intervening input is an input that is received intermediate to the receipt of the product candidate attribute selection input and the causation of display of the projected buy quantity indicator.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIGS. 2A-2B are diagrams illustrating a set of customer store segments according to at least one example embodiment;

FIGS. 3A-3E are diagrams illustrating a set of product attribute sales summaries and information associated with the set of product attribute sales summaries according to at least one example embodiment;

FIGS. 4A-4C are diagrams illustrating a set of product attribute sales summaries and information associated with the set of product attribute sales summaries according to at least one example embodiment;

FIGS. 5A-5E are diagrams illustrating a set of product attribute sales summaries and information associated with the set of product attribute sales summaries according to at least one example embodiment;

FIG. 6 is a flow diagram illustrating activities associated with determination of a customer store segment sales model according to at least one example embodiment;

FIG. 7 is a flow diagram illustrating activities associated with identification of a plurality of clusters according to at least one example embodiment;

FIG. 8 is a flow diagram illustrating activities associated with identification of a plurality of clusters according to at least one example embodiment;

FIG. 9 is a flow diagram illustrating activities associated with determination of a customer store segment sales model according to at least one example embodiment;

FIG. 10 is a flow diagram illustrating activities associated with determination of a customer store segment sales model according to at least one example embodiment;

FIG. 11 is a flow diagram illustrating activities associated with determination of a customer store segment sales model according to at least one example embodiment;

FIG. 12 is a flow diagram illustrating activities associated with determination of a customer store segment sales model according to at least one example embodiment;

FIGS. 13A-13B are diagrams illustrating quadrant representations according to at least one example embodiment;

FIG. 14 is a flow diagram illustrating activities associated with determination of a purchase recommendation for a customer store segment according to at least one example embodiment;

FIG. 15 is a flow diagram illustrating activities associated with determination of a purchase recommendation for a customer store segment according to at least one example embodiment;

FIGS. 16A-16B are diagrams illustrating quadrant representations according to at least one example embodiment;

FIG. 17 is a flow diagram illustrating activities associated with determination of a purchase recommendation for a customer store segment according to at least one example embodiment;

FIG. 18 is a flow diagram illustrating activities associated with determination of a purchase recommendation for a customer store segment according to at least one example embodiment;

FIGS. 19A-19B are diagrams illustrating quadrant representations according to at least one example embodiment;

FIG. 20 is a flow diagram illustrating activities associated with determination of a purchase recommendation for a customer store segment according to at least one example embodiment;

FIG. 21 is a flow diagram illustrating activities associated with determination of a purchase recommendation for a customer store segment according to at least one example embodiment;

FIGS. 22A-22B are diagrams illustrating a plurality of product candidate attribute indicators in relation to a quadrant image, a store count indicator, and a projected buy quantity indicator according to at least one example embodiment;

FIGS. 23A-23B are diagrams illustrating a plurality of product candidate attribute indicators in relation to a quadrant image, a store count indicator, and a projected buy quantity indicator according to at least one example embodiment;

FIG. 24 is a diagram illustrating a plurality of product candidate attribute indicators in relation to a quadrant image, a store count indicator, and a projected buy quantity indicator according to at least one example embodiment;

FIG. 25 is a flow diagram illustrating activities associated with causation of display of a projected buy quantity indicator that indicates a projected buy quantity according to at least one example embodiment;

FIG. 26 is a flow diagram illustrating activities associated with causation of display of a projected buy quantity indicator that indicates a projected buy quantity according to at least one example embodiment;

FIG. 27 is a flow diagram illustrating activities associated with causation of display of a projected buy quantity indicator that indicates a projected buy quantity according to at least one example embodiment;

FIG. 28 is a flow diagram illustrating activities associated with causation of display of a projected buy quantity indicator that indicates a projected buy quantity according to at least one example embodiment; and

FIG. 29 is a flow diagram illustrating activities associated with causation of display of a projected buy quantity indicator that indicates a projected buy quantity according to at least one example embodiment.

### DETAILED DESCRIPTION OF THE DRAWINGS

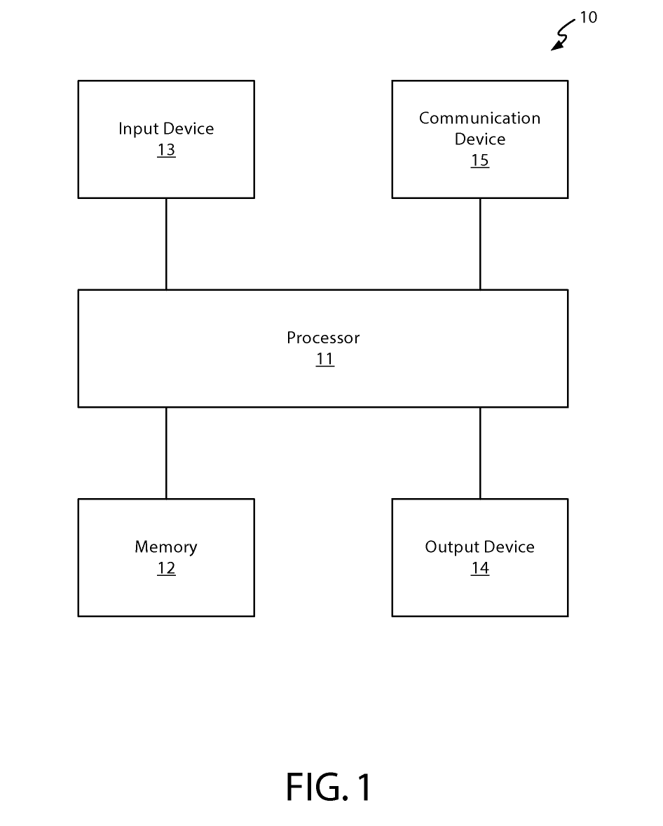

An embodiment of the invention and its potential advantages are understood by referring to FIGS. 1 through 29 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a laptop computer, a tablet computer, a mobile phone, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with third-generation (3G) wireless communication protocols, fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

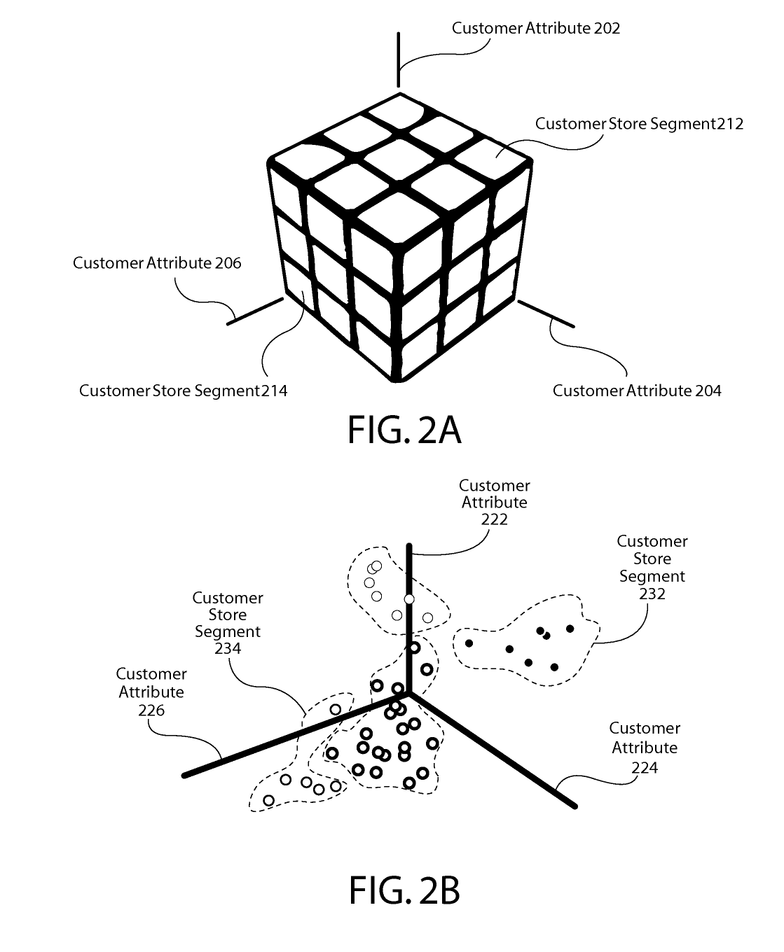

FIGS. 2A-2B are diagrams illustrating a set of customer store segments according to at least one example embodiment. The examples of FIGS. 2A-2B are merely examples and do not limit the scope of the claims. For example, axis count may vary, customer store segment count may vary, clusters may vary, and/or the like.

In many circumstances, merchants, purchasers, and/or similar individuals or entities may desire to buy merchandise, stock inventory, purchase goods, and/or the like. In such circumstances, the merchants may desire to utilize actionable information such that the actions of the merchant reflect potential consumer demand, are based on historical information, are justifiable in terms of business forecasts, and/or the like. As such, it may be desirable to improve merchants' and/or purchasers' access to actionable information. Such actionable information may be derived from synthesized customer and market data, historical sales and other transaction data, future planning objectives, and/or the like, such that the process of buying is well aligned with localized customer preferences, financial objectives, merchandise assortment goals, and/or the like. In this manner, such access to actionable information during the buying process may facilitate improvement in customer satisfaction, customer experiences, etc., and may result in improved business outcomes, increased revenue generation, decreased overstocked inventory, and/or the like.

In many circumstances, a merchant may consider one or more factors when evaluating a potential purchase of a product, of merchandise, and/or the like. For example, the merchant may desire to be informed regarding which stores or channels the product is most likely to sell. In another example, the merchant may wish to know how well the product will likely sell in each segment of the merchant's business. In this manner, the merchant may desire to know whether projected sales of the product justify a working capital investment into inventory, distribution, marketing, and/or the like. Additionally, the merchant may desire to know which stores, channels, etc. should be considered when purchasing the product.

For example, in many circumstances, a merchant may base many purchase decisions on total unit sales volume, sale volume by category, and/or the like. In such an example, category unit sales volume may be used to estimate potential sales performance of a particular product of a particular category. For example, if a store has historically sold twice as many products as an average store over a predetermined duration of time, such as a quarter, a year, a season, etc., that store may be likely to continue selling twice as many products as the average store in the future. In such an example, this store-specific sales trend may not vary by price point, material, brand, and/or the like. Such approximations that are based, at least in part, on category sales may be refined by way of utilizing historical sales of one or more specific products sold by a store or a group of stores over a predetermined duration of time. The historical sales of the specific product may be utilized as a basis for forecasting the sales of a new product, a similar product, and/or the like. In this manner, the approximation may be based, at least in part, on the availability of historical sales data associated with similar products, the skill and/or judgment of the merchant making the selection, and/or the like. As such, it may be desirable to provide a merchant with an easy and intuitive manner in which to forecast future sales, direct purchasing decisions, and/or the like.

In many circumstances, a merchant may desire to purchase products for a particular store, a grouping of stores, a particular retail channel, and/or the like. In such circumstances, the merchant may desire to target such stores, may desire to purchase particular products for a particular grouping of stores and different products for a different grouping of stores, and/or the like. As such, a particular purchasing decision may be based, at least in part, on identification of a particular set of stores. In at least one example embodiment, a set of stores is identified. The set of stores may comprise information indicative of a plurality of stores. The store may be a selling location, a fulfillment location, etc. that may exist in a particular retail channel, a plurality of retail channels, and/or the like. For example, the store may be a selling location that is associated with a physical store, a mail-order store, a telephone-order store, an internet store, and/or the like. In another example, the store may be a fulfillment location that is associated with a distribution location, an order fulfillment center, a warehouse location, a sales kiosk, an order pick-up location, and/or the like. In at least one example embodiment, the identification of the set of stores comprises receipt of information indicative of the set of stores from at least one of user input, a memory, a database, or a separate apparatus. For example, the set of stores may be configured by a user of the apparatus, manually inputted, selected from a list of available stores, and/or the like. In another example, the set of stores may be selected from a database by way of a directive that governs selection of the set of stores from the database.

In such circumstances, the merchant may desire to characterize a particular store in order to facilitate customization of purchasing decisions on a store by store basis, based on a group by group basis, and/or the like. For example, circumstances associated with a store and a different store may be such that the store and the different store warrant individualized considerations regarding purchasing decisions, inventory management, and/or the like. In at least one example embodiment, each store of a set of stores comprises a set of store attributes. In such an example embodiment, the store attribute may indicate at least one characteristic of a store associated with the store attribute. For example, the store attribute may indicate a location of the associated store, a market region associated with the store, a size of the associated store, a revenue of the associated store, an average transaction amount associated with the store, and/or the like. In such an example, a set of stores may be identified by way of selection of the set of stores from a database that comprises information indicative of a plurality of stores. In such an example, the set of stores may be selected by way of a directive that identifies stores associated with one or more predetermined store attributes, user configurable store attributes, user definable store attributes, and/or the like. In at least one example embodiment, a plurality of stores of a set of stores have a similar value for a particular store attribute. For example, a certain value store attribute may be equal or similar across a number of stores.

In many circumstances, a merchant may desire to cater to a particular group of customers, may desire to base purchasing decisions on customers of the merchant, and/or the like. As such, the merchant may desire to utilize information that characterizes customers of the merchant. In this manner, it may be desirable to describe a set of customers by way of demographic and/or lifestyle-related attributes that are easy and intuitive to understand for the merchant, a purchaser, a buyer, and/or the like. In at least one example embodiment, a set of customer attributes is identified. A customer attribute may indicate a characteristic of a customer, a property of a customer, and/or the like. Each customer attribute of the set of customer attributes may indicate an independent characteristic of a customer, a different characteristic of the customer, and/or the like. For example, a customer attribute comprised by the set of customer attributes may be indicative of a customer income range, a customer ethnicity, a customer age, a customer age range, a customer marital status, a customer dependent status, a customer gender, a customer interest, a customer religion status, a customer housing status, and/or the like. In at least one example embodiment, the identification of the set of customer attributes comprises receipt of information indicative of the set of customer attributes from a user input, a memory, a database, a separate apparatus, and/or the like. For example, the set of customer attributes may be configured by a user of the apparatus, manually inputted, selected from a list of available customer attributes, and/or the like. In another example, the set of customer attributes may be selected from a database by way of a directive that governs selection of the set of customer attributes from the database. In at least one example embodiment, each customer attribute comprised by a set of customer attributes corresponds with personal data that is represented in customer historical data, a compilation of customer data, and/or the like. In this manner, identification of the set of customer attributes may comprise identification of one or more customer attributes from customer historical data.

In some circumstances, the set of customer attributes may identify a representative set of customer attributes, customer profiles, etc. that are associated with customers who make purchases at a particular store, at each store of a set of stores, and/or the like. In at least one example embodiment, each customer attribute comprised by the first set of customer attributes is attributable to a variety of customers. For example, each customer attribute may be attributable to a plurality of customers, a group of customers, and/or the like.

In many circumstances, it may be desirable to cluster two or more stores together. For example, two or more stores may share common store attributes. In another example, it may be desirable to limit resources utilized in analysis of a particular purchasing decision by way of grouping similar stores together into clusters. As such, stores that share one or more common store attributes, are associated with customers that share one or more common customer attributes, etc. may be clustered together for convenience, problem tractability, and/or the like. In at least one example embodiment, a set of stores is segmented into a set of customer store segments. In such an example embodiment, the segmentation may be based, at least in part, on correlation between each set of store attributes for each store of a set of stores and customer historical data that corresponds with a set of customer attributes. In such an example embodiment, the set of stores may be segmented into a set of customer store segments such that each customer store segment of the set of customer store segments consists of stores that have at least one homogenous customer attribute. For example, a set of stores may be segmented into a set of customer-centric store segments, wherein each customer-centric store segment comprises stores that are associated with similar customer profiles, customers with similar customer attributes, and/or the like. A customer store segment may identify a collection of stores that are characterized by a predominant set of customer attributes. For example, each customer-centric store segment may be labeled to indicate a set of customer attributes associated with a typical customer of the store. For example, each customer store segment of a set of customer store segments may be labeled to indicate one or more homogenous customer attribute of each store of the customer store segment.

In at least one example embodiment, customer historical data comprises information that indicates one or more values associated with one or more customer attributes associated with one or more customers. For example, the customer historical data may comprise customer loyalty program data, syndicated market data, syndicated shopper data, demographic data, lifestyle data, and/or the like. In some circumstances, a plurality of customers represented by the customer historical data may have a similar value for a particular customer attribute. As such, it may be desirable to group a number of customers into groups of similar customers based, at least in part, on similar and/or corresponding customer attributes. In this manner, the customer historical data may comprise one or more statistically accurate representation of a model customer. For example, one or more customers may be characterized by one or more representations of typical customer of a store, a frequent shopper of a set of stores, and/or the like. In many circumstances, customer historical data may be associated with historical sales information. For example, the customer historical data may comprise information indicative of prior purchases, customer purchase history, and/or the like. In at least one example embodiment, sales information that is comprised by the customer historical data that corresponds with one or more customer attributes of the set of customer attributes is identified. In such an example embodiment, the correlation between each set of store attributes for each store of the set of stores and customer historical data that corresponds with the set of customer attributes may be based, at least in part, on the sales information. The sales information may be indicative of specific customer transactions, anonymous customer transactions, customer group transactions, and/or the like. In such an example, a customer group may be a collective of members of a community that is presumed to shop at a store of the set of stores. For example, customers may be identified individually using sales transactions or other records maintained through a customer loyalty program. In another example, customers may remain anonymous, but identified collectively as members of communities that are known or assumed to shop in the vicinity of a given store location.

In some circumstances, segmentation of a set of stores into a set of customer store segments may be based, at least in part, on recognition of one or more clusters within a plurality of data points. For example, the segmentation of a set of stores into a set of customer store segments may comprise determination of an average value for each customer attribute of a set of customer attributes for each store of the set of stores based, at least in part, on customer historical data. The customer historical data may be associated with sales information of each store of the set of stores, and the determination of the average value for each customer attribute of the set of customer attributes may comprise identification of each customer attribute associated with the sales information.

In some circumstances, sales information may be incomplete, partial, generally applicable, and/or the like. For example, the sales information may fail to represent a particular customer attribute of a set of customer attributes. In such an example, it may be desirable to identify one or more additional attributes that may be associated with the particular customer attribute, indicative of the particular customer attribute, and/or the like. In at least one example embodiment, the determination of the average value for each customer attribute of the set of customer attributes comprises determination that a customer attribute of the set of customer attributes is unrepresented by sales information of each store of a set of stores, and identification of a secondary attribute that is represented by the sales information. In such an example embodiment, customer historical data may be identified to be a set of data that represents the customer attribute in relation to the secondary attribute, and the average value may be determined based, at least in part, on correlation between the secondary attribute and the customer attribute in the set of data. For example, a merchant may desire to reference a particular customer attribute, such as customer income, customer ethnicity, and/or the like, that fails to be represented by sales data, customer historical data, and/or the like. In such an example, the sales information may represent a customer attribute that is indicative of a location of a customer. In such an example, the secondary attribute may be location information associated with each store of the set of stores, and the set of data may comprise census information. Such census information may be indicative of the desired store attributes and/or customer attributes, and may comprise information indicative of regional ethnicity proportions, average incomes, and/or the like. In this manner, the average value may be determined based, at least in part, on correlation between the location-related secondary attribute and the customer attribute in the census information.

In some circumstances, it may be desirable to represent each store of a set of stores as an independent data point such that one or more customer store segments may be identifies by way of statistical analysis, visual analysis, mathematical grouping, and/or the like. In at least one example embodiment, each store of a set of stores is represented as a data point to form a plurality of data points such that each customer attribute of a set of customer attributes is an independent dimension of the data point. In such an example embodiment, a plurality of clusters of the plurality of data points may be identified. The identification of the plurality of clusters may be based, at least in part, on k-means clustering, centroid-based clustering, hierarchical clustering, linkage clustering, E-M clustering, distribution-based clustering, and/or the like. There are many existing manners in which to identify clusters within a plurality of data points, and many more manners are likely to be developed in the future. As such, the manner in which the clusters are identified does not necessarily limit the scope of the claims. In such an example embodiment, the set of customer store segments may be determined to comprise customer store segments that correspond with the plurality of clusters.

In some circumstances, it may be desirable to further segment a set of stores based, at least in part, on a common customer attribute and a common store attribute. In other words, it may be desirable to further segment each customer-centric store segment into sub-segments that consist of stores with similar store attribute profiles, similar customers, and/or the like. In at least one example embodiment, segmentation of a set of stores into a set of customer store segments comprises further segmentation such that each customer store segment of the set of customer store segments consists of stores that have at least one homogenous customer attribute and at least one homogenous store attribute.

FIG. 2A is a diagram illustrating a set of customer store segments according to at least one example embodiment. The example of FIG. 2A illustrates representation of a plurality of data points, and segmentation of a set of stores into a set of customer store segments based, at least in part, on clustering of the plurality of data points. As can be seen in the example of FIG. 2A, a three-dimensional segmented cube is illustrated in reference to three axis that indicate three customer attributes, customer attribute 202, 204, and 206. For example, the y-axis may be associated with customer attribute 202 that may indicate a customer age, the x-axis may be associated with customer attribute 204 that may indicate a household income, and the z-axis may be associated with customer attribute 206 that may indicate a percent Hispanic. As such, the set of customer attributes may be utilized to segment a set of stores into a set of customer store segments such that each customer store segment comprises one or more stores of the set of stores. Such a segmentation may be based, at least in part, on clustering of various combinations of the three customer attributes. For example, based, at least in part, on the position of customer store segment 212 with respect to the three axis, customer store segment 212 may be characterized by older, affluent, and low-percentage Hispanic customers. Similarly, customer store segment 214 may be characterized by younger, less-affluent, and higher-percentage Hispanic customers.

Although the example of FIG. 2A represents three customer attributes, and depicts a three by three grid of customer store segments, the number of customer attributes that may be analyzed may vary, and the resulting customer store segments are not necessarily bound by three dimensional space.

FIG. 2B is a diagram illustrating a set of customer store segments according to at least one example embodiment. The example of FIG. 2B illustrates representation of a plurality of data points, and segmentation of a set of stores into a set of customer store segments based, at least in part, on clustering of the plurality of data points. As can be seen in the example of FIG. 2B, a plurality of data point are plotted with respect to the three illustrated axis. For example, the y-axis may be associated with customer attribute 202 that may indicate a customer age, the x-axis may be associated with customer attribute 204 that may indicate a household income, and the z-axis may be associated with customer attribute 206 that may indicate a percent Hispanic. As such, the set of customer attributes may be utilized to segment a set of stores into a set of customer store segments that each comprise one or more stores of the set of stores. Such a segmentation may be based, at least in part, on clustering of various data points that represent combinations of the three customer attributes. For example, based, at least in part, on the position of customer store segment 232 with respect to the three axis, customer store segment 232 may be characterized by older, affluent, and low-percentage Hispanic customers. Similarly, customer store segment 234 may be characterized by younger, less-affluent, and higher-percentage Hispanic customers.

Although the example of FIG. 2B represents three customer attributes, and depicts the representation of the plurality of data points associated with the three customer attributes in relation to a three dimensional plot, the number of customer attributes that may be analyzed may vary, and the resulting customer store segments are not necessarily bound by three dimensional space.

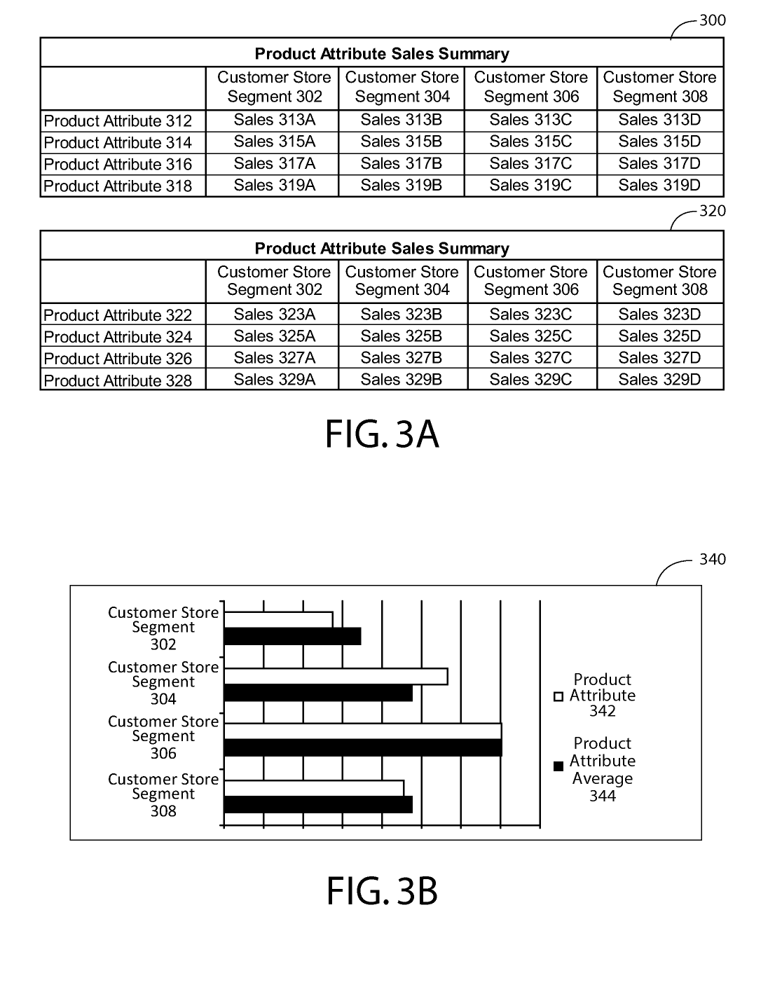

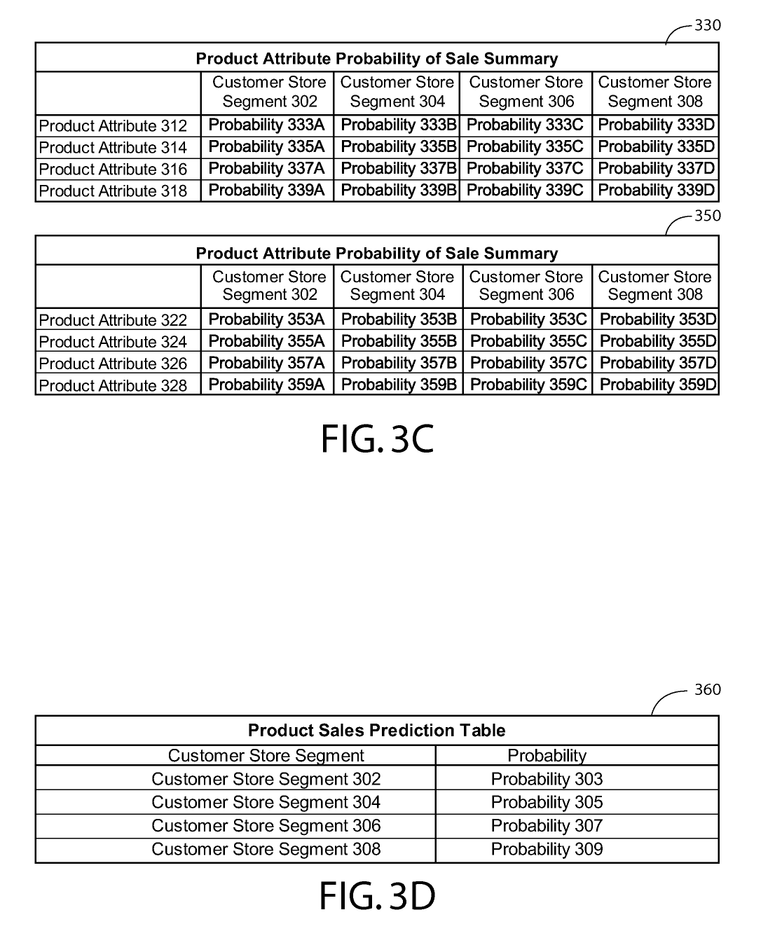

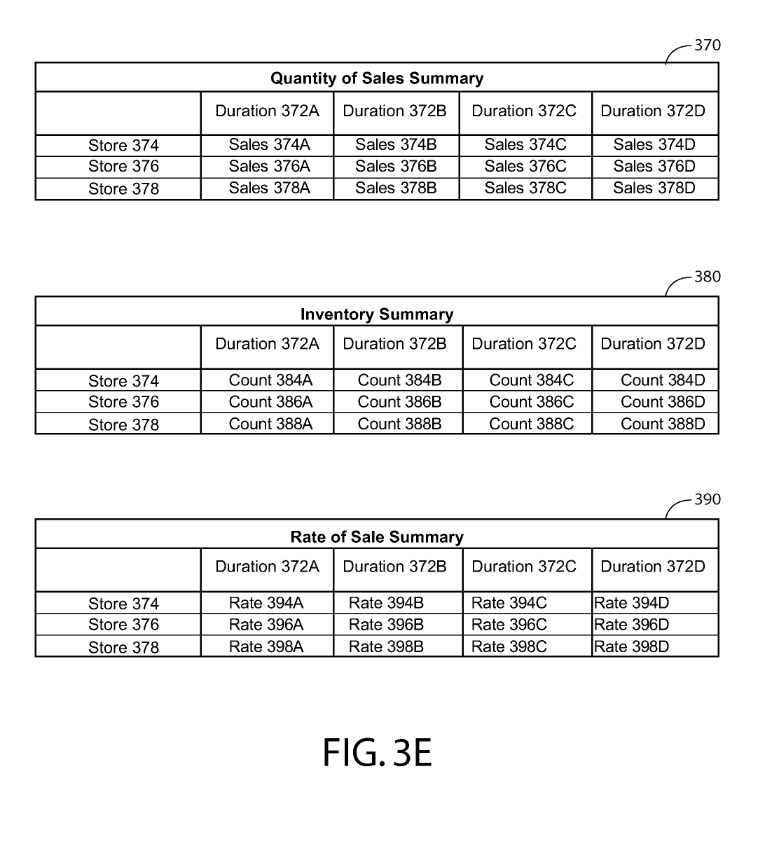

FIGS. 3A-3E are diagrams illustrating a set of product attribute sales summaries and information associated with the set of product attribute sales summaries according to at least one example embodiment. The examples of FIGS. 3A-3E are merely examples and do not limit the scope of the claims. For example, product attribute sales summary configuration and/or content may vary, customer store segment count may vary, product attribute count may vary, chart configuration and/or content may vary, product sales prediction table configuration and/or content may vary, and/or the like.

As described previously, in many circumstances, it may be desirable to facilitate a merchant in making informed business decisions, purchasing and assortment selections, and/or the like. As such, it may be desirable to facilitate selection of particular products by way of characteristics of the product, attributes of the product, and/or the like. In at least one example embodiment, a set of product attributes are identified. A product attribute may be an attribute of a product that classifies the product within a merchandise category. The product attribute may be an attribute that is descriptive of differences in styles of a products, descriptive of features of a product, indicative of a product characteristic that may influence the buying behavior of a customer, and/or the like.

In such circumstances, it may be desirable to reference sales data associated with a particular product attribute, a range of product attributes, a set of product attributes, and/or the like. For example, it may be desirable to base a future purchase decision on data that indicates historical sales performance of similar products, of products that are associated with similar product attributes, and/or the like. In at least one example embodiment, a set of product attribute sales summaries are generated. The set of product attribute sales summaries may comprise a product attribute sales summary for each customer store segment of a set of customer store segments, such that each product attribute sales summary of the set of product attribute sales summaries identifies a quantity of sales associated with each product attribute of the set of product attributes from each store within a customer store segment of the set of customer store segments. In such an example embodiment, the generation of the set of product attribute sales summaries may comprise identification of products that have a product attribute that corresponds with at least one of the product attributes of the set of product attributes. For example, the identification of the products may comprise receipt of information indicative of the products from a user input, a memory, a database, a separate apparatus, and/or the like. For example, the products may be selected by a user of the apparatus, manually inputted, selected from a list of available products, and/or the like. In another example, the products may be selected from a database by way of a directive that governs selection of the products from the database. For example, the products may be identified within the database based, at least in part, on at least one product attribute.

Each product attribute sales summary of the set of product attribute sales summaries may comprise rate of sale information, sales volume information, and/or the like. In such an example, identification of a quantity of sales associated with each product attribute of the set of product attributes may comprise grouping of products into a set of products that are associated with the product attribute, and determination of the quantity of sales associated with the set of products. For example, a set of products within a particular category of products may be grouped into a set of similar product types, each of which is identified by specific product attributes, a set of product attributes, and/or the like. In this manner, a list of sales transactions may be compiled for each product type, organized by customer-centric store segment, customer store segment, and/or the like. In some circumstances, it may be desirable to include non-discounted sales of products, and exclude discounted sales of products. For example, a full priced sale of a product may be indicative of a greater consumer desire for the product, and a discounted sell of the product may be indicative of a lesser consumer desire for the product. In at least one example embodiment, the generation of the set of product attribute sales summaries includes information indicative of non-discount priced sales. In at least one example embodiment, the generation of the set of product attribute sales summaries excludes information indicative of discount priced sales.

FIG. 3A is a diagram illustrating a set of product attribute sales summaries according to at least one example embodiment. The example of FIG. 3A depicts a set of product attribute sales summaries. In the example of FIG. 3A, the set of product attribute sales summaries comprises product attribute sales summary 300 and product attribute sales summary 320. As can be seen in product attribute sales summary 300, the quantity of sales data is attributable to the customer store segment that corresponds with the column of the quantity of sales data, and attributable to the set of product attributes that corresponds with the row of the quantity of sales data. As such, product attribute sales summary 300 correlates information indicative of quantity of sales data 313A-313D, 315A-315D, 317A-317D, and 319A-319D to sets of product attributes 312, 314, 316, and 318, respectively. Similarly, product attribute sales summary 300 correlates information indicative of quantity of sales data 313A-319A, 313B-319B, 313C-319C, and 313D-319D to customer store segments 302, 304, 306, and 308, respectively. In this manner, quantity of sales data 313A may indicate a quantity of sales of products associated with set of product attributes 312 within customer store segment 302. Similarly, quantity of sales data 317D may indicate a quantity of sales of products associated with set of product attributes 316 within customer store segment 308. In the example of FIG. 3A, customer store segments 302, 304, 306, and 308 may correspond with one or more of the customer store segments depicted in the example of FIG. 2A and/or FIG. 2B. As such, customer store segments 302, 304, 306, and 308 may have been identified based, at least in part, on clustering of data points that represent various combinations of customer attributes.

In many circumstances, it may be desirable to quantify the merit of a particular selection of customer store segments, customer attributes, product attributes, and/or the like. For example, a particular selection of and correlation of customer attributes and product attributes, groups on a customer store segment basis, may indicate a particularly interesting purchasing trend, may fail to indicate a particular purchasing bias, and/or the like. In this manner, it may be desirable to quantify the usefulness of the resulting product attribute sales summaries in order to determine whether additional analysis is warranted, whether additional refinement may be beneficial, and/or the like. In at least one example embodiment, a distinctiveness rating is determined for a product attribute sales summary for each customer store segment of a set of customer store segments. The distinctiveness rating may indicate a variation of sales performance across each product attribute sales summary. The determination of the distinctiveness rating may be based, at least in part, on an information gain for the product attributes of the set of product attributes. For example, a product attribute sales summary that provides for a high level of information gain may be more distinctive than another product attribute sales summary that allows for a low level of information gain. As such, the distinctiveness rating may be based on the information gain associated with the selected product attributes in inferring sales performance of product types on a per customer store segment basis.

FIG. 3B is a diagram illustrating a chart associated with a set of product attribute sales summaries according to at least one example embodiment. The example of FIG. 3B depicts chart 340. In the example of FIG. 3B, chart 340 represents one or more product attribute sales summaries. For example, chart 340 may represent product attribute sales summary 300, product attribute sales summary 320, and/or the like. As can be seen, chart 340 represents sales information associated with a particular set of product attributes for each customer store segment. In the example of FIG. 3B, chart 340 represents quantity of sales data that is attributable to set of product attributes 342. As can be seen, the quality of sales data is charted as white bars along the horizontal axis of chart 340, such that a longer bar indicates a higher quantity of sales, and a shorter bar indicates a lower quantity of sales. In order to facilitate determination of a distinctiveness rating associated with a particular set of product attribute sales summaries, it may be desirable to provide baseline information with which to compare the quantity of sales data to. As such, in the example of FIG. 3B, chart 340 represents average quantity of sales data by way of black horizontal bars, as indicated by product attribute average 344. Such average quantity of sales data may be associated with an average quantity of sales across all stores within a set of stores, within all customer store segments of a set of customer store segments, attributable to purchases made by all customers, and/or the like. In this manner, a distinctiveness rating may be determined by way of a comparison between the product attribute sales summary quantity of sales data and the average quantity of sales data.

In some circumstances, it may be desirable to iteratively refine various facets of the analysis in order to facilitate exploration of a variety of choices and combinations of customer attributes, product attributes, and/or the like. Such iterative refinement may help yield useful insights into selling patterns, customer purchase predictions, and/or the like. As such, it may be desirable to identify another set of customer attributes, another set of product attributes, and/or the like.

For example, a first set of customer attributes may be identified, a set of stores may be segmented into a first set of customer store segments, a first set of product attribute sales summaries may be generated, and a first distinctiveness rating determined. In such an example, it may be desirable to analyze another combination of customer attributes, product attributes, customer store segments, and/or the like. As such, a second set of customer attributes may be identified. In such an example, the set of stores may be segmented into a second set of customer store segments based, at least in part, on correlation between each store of the set of stores and customer historical data that corresponds with the second set of customer attributes. The set of stores may be segmented into the second set of customer store segments such that each customer store segment of the second set of customer store segments consists of stores that have at least one homogenous customer attribute. In such an example, a second set of product attribute sales summaries may be generated. The second set of product attribute sales summaries may comprise a product attribute sales summary for each customer store segment of the second set of customer store segments, such that each product attribute sales summary of the second set of product attribute sales summaries identifies a quantity of sales associated with each product attribute of the first set of product attributes from each store within a customer store segment of the second set of customer store segments. In order to facilitate comparison between the first set of product attribute sales summaries and the second set of product attribute sales summaries, it may be desirable to determine a distinctiveness rating for the second set of product attribute sales summaries. In such an example, a second distinctiveness rating may be determined for the product attribute sales summary for each customer store segment of the second set of customer store segments.

In another example, a first set of customer attributes may be identified, a set of stores may be segmented into a first set of customer store segments, a first set of product attribute sales summaries may be generated, and a first distinctiveness rating determined. In such an example, it may be desirable to analyze another combination of customer attributes, product attributes, customer store segments, and/or the like. As such, a second set of product attributes may be identified. In such an example, a second set of product attribute sales summaries may be generated. The second set of product attribute sales summaries may comprise a product attribute sales summary for each customer store segment of the first set of customer store segments, such that each product attribute sales summary of the second set of product attribute sales summaries identifies a quantity of sales associated with each product attribute of the second set of product attributes from each store within a customer store segment of the first set of customer store segments. In order to facilitate comparison between the first set of product attribute sales summaries and the second set of product attribute sales summaries, it may be desirable to determine a distinctiveness rating for the second set of product attribute sales summaries. In such an example, a second distinctiveness rating may be determined for the product attribute sales summary for each customer store segment of the first set of customer store segments.

As can be seen in the example of FIG. 3A, the set of product attribute sales summaries comprises product attribute sales summary 300 and product attribute sales summary 320. In the example of FIG. 3A, product attribute sales summary 300 and product attribute sales summary 320 are associated with customer stores segments 302, 304, 306, and 308. However, as can be seen, product attribute sales summary 300 is associated with sets of product attributes 312, 314, 316, and 318, and product attribute sales summary 320 is associated with sets of product attributes 322, 324, 326, and 328. As can be seen in product attribute sales summary 320, the quantity of sales data is attributable to the customer store segment that corresponds with the column of the quantity of sales data, and attributable to the set of product attributes that corresponds with the row of the quantity of sales data. As such, product attribute sales summary 320 correlates information indicative of quantity of sales data 323A-323D, 325A-325D, 327A-327D, and 329A-329D to sets of product attributes 322, 324, 326, and 328, respectively. Similarly, product attribute sales summary 320 correlates information indicative of quantity of sales data 323A, 325A, 327A, and 329A to customer store segment 302, quantity of sales data 323B, 325B, 327B, and 329B to customer store segment 304, quantity of sales data 323C, 325C, 327C, and 329C to customer store segment 306, and quantity of sales data 323D, 325D, 327D, and 329D to customer store segment 308. In this manner, quantity of sales data 323A may indicate a quantity of sales of products associated with set of product attributes 322 within customer store segment 302. Similarly, quantity of sales data 327D may indicate a quantity of sales of products associated with set of product attributes 326 within customer store segment 308.

In some circumstances, it may be desirable to identify another set of customer attributes and another set of product attributes. For example, a first set of customer attributes may be identified, a set of stores may be segmented into a first set of customer store segments, a first set of product attribute sales summaries may be generated, and a first distinctiveness rating determined. In such an example, it may be desirable to analyze another combination of customer attributes, product attributes, customer store segments, and/or the like. As such, a second set of customer attributes may be identified. In such an example, the set of stores may be segmented into a second set of customer store segments based, at least in part, on correlation between each store of the set of stores and customer historical data that corresponds with the second set of customer attributes. The set of stores may be segmented into the second set of customer store segments such that each customer store segment of the second set of customer store segments consists of stores that have at least one homogenous customer attribute. In such an example, a second set of product attributes may be identified, and a second set of product attribute sales summaries may be generated. The second set of product attribute sales summaries may comprise a product attribute sales summary for each customer store segment of the second set of customer store segments, such that each product attribute sales summary of the second set of product attribute sales summaries identifies a quantity of sales associated with each product attribute of the second set of product attributes from each store within a customer store segment of the second set of customer store segments. In order to facilitate comparison between the first set of product attribute sales summaries and the second set of product attribute sales summaries, it may be desirable to determine a distinctiveness rating for the second set of product attribute sales summaries. In such an example, a second distinctiveness rating may be determined for the product attribute sales summary for each customer store segment of the second set of customer store segments.

Subsequent to identification of useful selling patterns by way of analyzing one or more sets of product attribute sales summaries, it may be desirable to determine a sales model that may facilitate a business decision, a product purchase, an inventory allotment, and/or the like. In at least one example embodiment, a customer store segment sales model is determined. The customer store segment sales model may be based, at least in part, on a set of customer store segments, a set of product attribute sales summaries, a distinctiveness rating, and/or the like. In some circumstances, analysis may have been conducted by way of more than one set of customer attributes, more than one set of product attributes, more than one set of customer store segments, more than one set of product attribute sales summaries, more than one distinctiveness rating, and/or the like. As such, the determination of the customer store segment sales model may be based, at least in part, on a plurality of sets of customer attributes, sets of product attributes, sets of customer store segments, sets of product attribute sales summaries, distinctiveness ratings, and/or the like. In some circumstances, more than one set of product attribute sales summaries may be generated. In such circumstances, a distinctiveness rating may be determined for each set of product attribute sales summaries. In order to facilitate determination of an optimal customer store segment sales model, it may be desirable to determine the customer store segment sales model based, at least in part, on the most distinctive set of product attribute sales summaries. For example, a first set of product attribute sales summaries associated with a first distinctiveness rating and a second set of product attribute sales summaries associated with a second distinctiveness rating may be determined. In such an example, it may be desirable to compare the first distinctiveness rating and the second distinctiveness rating, and to determine the customer store segment sales model based, at least in part, on the greater of the two product attribute sales summaries. In such an example, it may be determined that the first distinctiveness rating is greater than the second distinctiveness rating. As such, in such an example, the customer store segment sales model may be determined to comprise a set of customer store segments associated with the first distinctiveness rating based, at least in part, on the determination that the first distinctiveness rating is greater than the second distinctiveness rating. In this manner, if a variation of sales performance across customer store segments shown in a set of product attribute sales summaries is determined to be sufficiently distinctive, the set of product attribute sales summaries may be utilized in order to facilitate prediction of future sales performance of products associated with the respective set of product attributes.

In some circumstances, it may be desirable to be aware of how well products that are associated with a particular product attribute sell relative to other products that are associated with the same product attribute. For example, it may be desirable to compare the sales performance of a particular type of shoe against the sales performance of a different type of shoe, against shoes in general, and/or the like. As such, it may be desirable to convert the quantity of sales data comprised by a product attribute sales summary into a probability of sale attributable to a desired combination of product attributes.

FIG. 3C is a diagram illustrating a set of product attribute probability of sale summaries according to at least one example embodiment. The example of FIG. 3C depicts a set of product attribute probability of sale summaries that correspond with the set of product attribute sales summaries of FIG. 3A. In the example of FIG. 3C, the set of product attribute probability of sale summaries comprises product attribute probability of sale summary 330 and product attribute probability of sale summary 350, which correspond with product attribute sales summary 300 and product attribute sales summary 320, respectively. As can be seen in product attribute probability of sale summary 330, the probability of sale data is attributable to the customer store segment that corresponds with the column of the probability of sale data, and attributable to the set of product attributes that corresponds with the row of the probability of sale data. As such, product attribute probability of sale summary 330 correlates information indicative of probability of sale data 333A-333D, 335A-335D, 337A-337D, and 339A-339D to sets of product attributes 312, 314, 316, and 318, respectively. Similarly, product attribute probability of sale summary 330 correlates information indicative of probability of sale data 333A, 335A, 337A, and 339A to customer store segment 302, 333B, 335B, 337B, and 339B to customer store segment 304, 333C, 335C, 337C, and 339C to customer store segment 306, and 333D, 335D, 337D, and 339D to customer store segment 308. In this manner, probability of sales data 333A may indicate a probability of sale of products associated with set of product attributes 312 within customer store segment 302. Similarly, probability of sale data 337D may indicate a quantity of sales of products associated with set of product attributes 316 within customer store segment 308.

Similarly, as can be seen in product attribute probability of sale summary 350, the probability of sale data is attributable to the customer store segment that corresponds with the column of the probability of sale data, and attributable to the set of product attributes that corresponds with the row of the probability of sale data. As such, product attribute probability of sale summary 350 correlates information indicative of probability of sale data 353A-353D, 355A-355D, 357A-357D, and 359A-359D to sets of product attributes 322, 324, 326, and 328, respectively. Similarly, product attribute probability of sale summary 350 correlates information indicative of probability of sale data 353A, 355A, 357A, and 359A to customer store segment 302, 353B, 355B, 357B, and 359B to customer store segment 304, 353C, 355C, 357C, and 359C to customer store segment 306, and 353D, 355D, 357D, and 359D to customer store segment 308. In this manner, probability of sales data 353A may indicate a probability of sale of products associated with set of product attributes 322 within customer store segment 302. Similarly, probability of sale data 357D may indicate a quantity of sales of products associated with set of product attributes 326 within customer store segment 308.

In the example of FIG. 3C, customer store segments 302, 304, 306, and 308 may correspond with one or more of the customer store segments depicted in the example of FIG. 2A and/or FIG. 2B. As such, customer store segments 302, 304, 306, and 308 may have been identified based, at least in part, on clustering of data points that represent various combinations of customer attributes.

In some circumstances, it may be desirable to predict future sales performance by way of analysis of historical sales information. In at least one example embodiment, a customer store segment sales model comprises product rate of sale information and product sales volume information. For example, the rate of sale information may identify a number of sales associated with a set of product attributes in relation to a predetermined period of time, and the product sales volume information may identify a number of sales associated with a set of product attributes within a predetermined period of time. For example, the product rate of sale information may identify a number of sales per week, and the product sales volume information may identify a total number of sales attributable to products that are associated with the set of product attributes. In at least one example embodiment, the determination of the customer store segment sales model comprises normalization of product attribute sales summary sales volume information to generate the product sales volume information of the customer store segment sales model. The normalization of the product attribute sales summary sales volume may comprise normalization of the product attribute sales summary sales volume with respect to an aggregate sales volume associated with the customer store segment that is associated with the product sales attribute summary.

For example, once the analysis has yielded useful selling patterns, various metrics may be used as predictors of future sales performance. Such metrics may be associated with relative unit sales volume, rate of sale, and/or the like. In such an example, the metrics may be attributed to products associated with a particular set of product attributes using statistical modeling techniques, such as 1R, Bayes Rule, or any other statistical modeling technique that yields an acceptable error rate. The choice of a particular statistical modeling technique may be validated and/or compared to other candidate statistical modeling techniques by using a subset of a set of product attribute sales summaries to generate a customer store segment sales model, and reservation of at least a portion of the set of product attribute sales summaries for statistical testing purposes. In at least one example embodiment, a customer store segment sales model is a data structure that correlates data between dimensions of the data structure. For example, the customer store segment sales model may correlate each customer store segment of a set of customer store segments with product rate of sale information, product sales volume information, and/or the like. In another example, the customer store segment sales model may correlate each customer store segment of a set of customer store segments with a suggested product purchase volume that indicates a suggested number of products to purchase for each store of each customer store segment of the set of customer store segments.

In many circumstances, once a customer segment sales model has been determined, it may be desirable to utilize and/or reference the customer segment sales model for purposes relating to inventory management, purchasing recommendations, and/or the like. For example, a merchant may decide to purchase a particular product, and plan to sell the product in the next quarter. In such an example, the merchant may desire to know in which of the merchant's stores the product is likely to sell well, in which of the merchant's stores like product is likely to sell poorly, and/or the like. For example, a merchant may desire to know, given the existence of a sale of a particular product, the probability that the sale of the product occurred in a store in a specific customer store segment, occurred in a customer store segment of a set of customer store segments, and/or the like.

FIG. 3D is a diagram illustrating a product sales prediction table according to at least one example embodiment. The example of FIG. 3D depicts product sales prediction table 360. Product sales prediction table 360 may be based, at least in part, on a set of product attribute sales summaries, a customer store segment sales model, and/or the like. In the example of FIG. 3D, product sales prediction table 360 depicts a set of probabilities of sales associated with a particular set of customer store segments. As can be seen, customer store segment 302 is associated with probability of sale 303, customer store segment 304 is associated with probability of sale 305, customer store segment 306 is associated with probability of sale 307, and customer store segment 308 is associated with probability of sale 309. As such, given a sale of a product that is associated with the set of product attributes that is associated with product sales prediction table 360, product sales prediction table 360 indicates a probability that the specific sale took place at each of customer store segments 302, 304, 306, and 308.

As discussed previously, it may be desirable to predict future sales performance by way of analysis of historical sales information. Such historical sales information may comprise quantity of sales over a predetermined duration, inventory status of a particular product type, rate of sale information over a predetermined duration, and/or the like. As such, trends in the historical sales information may be identified by way of analysis and/or correlation of such information.

FIG. 3E is a diagram illustrating a quantity of sales summary, an inventory summary, and a rate of sale summary according to at least one example embodiment. The example of FIG. 3E depicts a set of historical sales information summaries. In the example of FIG. 3E, the set of historical sales information summaries comprises quantity of sales summary 370, inventory summary 380, and rate of sale summary 390. As can be seen in quantity of sales summary 370, the quantity of sales data is a quantity of sales attributable to a specific store, a specific customer store segment, and/or the like, over a predetermined duration. As such, quantity of sales summary 370 correlates information indicative of quantity of sales data 374A-374D, 376A-376D, and 378A-378D for a particular product type to stores 374, 376, and 378, respectively. In this manner, quantity of sales summary 370 indicates a quantity of sales attributable to the specific store, the specific customer store segment, and/or the like, over a number of successive durations. For example, durations 372A-372D may each be a week duration, such that quantity of sales data for four successive weeks is comprised by quantity of sales summary 370.

In some circumstances, quantity of sales data may be affected by factors other than a consumer's willingness to purchase a particular produce type. For example, a specific store may have stocked an insufficient number of the product type, the store may have failed to reorder such inventory, the store may have run out of stock on the particular product type, and/or the like. As such, it may be desirable to consider inventory information specific to inventory status of products of the particular product type. In this manner, a low quantity of sales over a specific duration at a particular store may correspond with a low or out of stock inventory over the same duration and at the same store.

As can be seen in inventory summary 380, the inventory data is a count of inventory that is attributable to a specific store, a specific customer store segment, and/or the like, over a predetermined duration. As such, inventory summary 380 correlates information indicative of inventory data 384A-384D, 386A-386D, and 388A-388D for a particular product type to stores 374, 376, and 378, respectively. In this manner, inventory summary 380 indicates a quantity of sales attributable to the specific store, the specific customer store segment, and/or the like, over a number of successive durations. For example, durations 372A-372D may each be a week duration, such that inventory data for four successive weeks is comprised by inventory summary 380.

As discussed previously, in some circumstances, it may be desirable to consider rate of sales data in conjunction with quantity of sales data. For example, two stores and/or customer store segments may produce a similar quantity of sales, but one of the stores and/or customer store segments may have produced the quantity of sales over a much shorter duration, sporadically as inventory was replenished, and/or the like. Such a comparison allows for inferences regarding the popularity and future sales potential of a particular product type, and may aid in future purchasing decisions, stock management, and/or the like.

As can be seen in rate of sale summary 390, the rate of sale data is a rate of sale that is attributable to a specific store, a specific customer store segment, and/or the like, over a predetermined duration. As such, rate of sale summary 390 correlates information indicative of rate of sale data 394A-394D, 396A-396D, and 398A-398D for a particular product type to stores 374, 376, and 378, respectively. In this manner, rate of sale summary 390 indicates a rate of sale attributable to the specific store, the specific customer store segment, and/or the like, over a number of successive durations. For example, durations 372A-372D may each be a week duration, such that rate of sale data for four successive weeks is comprised by rate of sale summary 390.

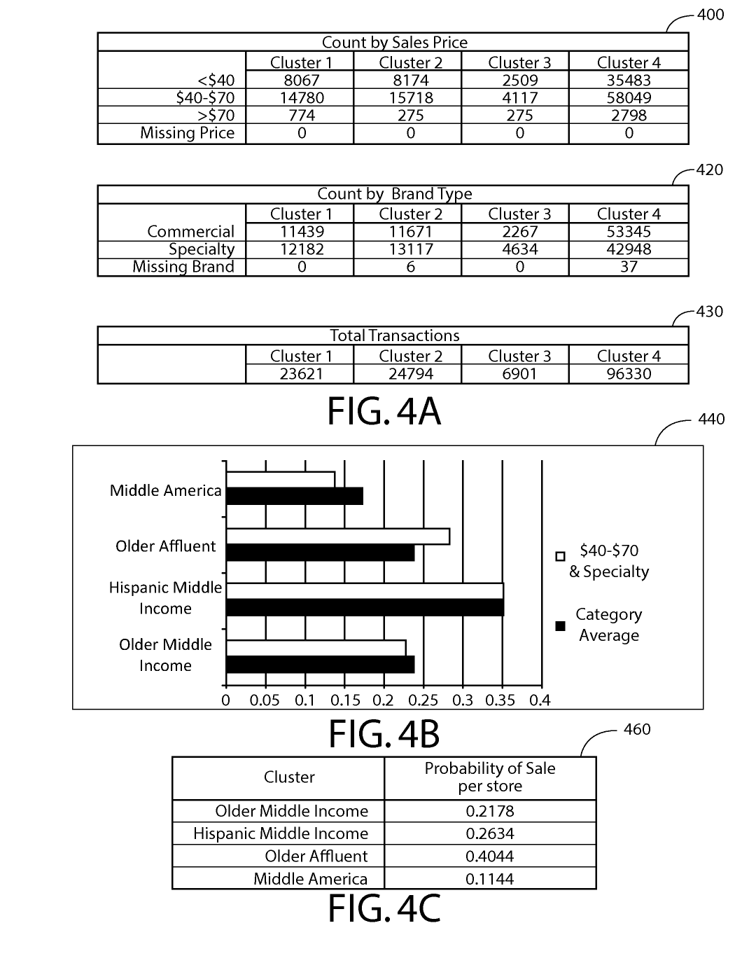

FIGS. 4A-4C are diagrams illustrating a set of product attribute sales summaries and information associated with the set of product attribute sales summaries according to at least one example embodiment. The examples of FIGS. 4A-4C are merely examples and do not limit the scope of the claims. For example, product attribute sales summary configuration and/or content may vary, customer store segment count may vary, product attribute count may vary, graph configuration and/or content may vary, product sales prediction table configuration and/or content may vary, and/or the like.

For example, a merchant may sell various products by way of a chain of physical store locations. In such an example, the merchant desire to sell men's athletic shoes. In such an example, a set of three customer attributes may characterize male customers: annual household income, percentage Hispanic, and age. In such an example, the merchant may maintain loyalty account information that provides a household income, an age bracket, and a residential zip code for each customer that is enrolled in the loyalty account program. As such, two of the three customer attributes may be directly identified by way of the loyalty account information. The third customer attribute, the percentage Hispanic, may be determined based, at least in part, on the residential zip code. For example, census data that indicates an average demographic for a particular zip code may be identified by way of the residential zip code that is indicated in the loyalty account information. As such, in such an example, the set of customer attributes may comprise an annual household income, a percentage Hispanic, and an age. The annual household income may indicate a household income of less than $50,000, $50,000-$80,000, or greater than $80,000. The percentage Hispanic may indicate a percentage that is less than 5%, 5%-15%, or greater than 15%. The age may indicate age ranges of 18-39, 30-50, and over 50. In such an example, a set of product attributes associated with such men's athletic shoes may be identified. For example, the set of product attributes may comprise a price point and a band type. The price point may indicate that a pair of men's athletic shoes are priced under $40, $40-$70, or greater than $70. The brand type may indicate that the pair of men's athletic shoes are of the commercial type or the specialty type. As such, four customer store segments may be identified—cluster 1, which is characterized by “Older Middle Income” and comprises 41 stores, cluster 2, which is characterized by “Hispanic Middle Income” and comprises 29 stores, cluster 3, which is characterized by “Older Affluent” and comprises 12 stores, and cluster 4, which is characterized by “Middle America” and comprises 230 stores.

FIG. 4A is a diagram illustrating a set of product attribute sales summaries according to at least one example embodiment. As can be seen, FIG. 4A depicts product attribute sales summary 400 and product attribute sales summary 420. Each of product attribute sales summary 400 and product attribute sales summary 420 correlate clusters 1, 2, 3, and 4, which are customer store segments, and various product attributes, to the indicated quantity of sales data. For example, product attribute sales summary 400 indicates that 15718 men's athletic shoes in the $40-$70 price range were sold in cluster 2, and that 774 men's athletic shoes in the greater than $70 price range were sold in cluster 1. In another example, product attribute sales summary 420 indicates that 11439 men's athletic shoes of the commercial type were sold in cluster 1, and that 4634 men's athletic shoes of the specialty type were sold in cluster 3. As can be seen, the example of FIG. 4A also depicts table 430, which indicates a total quantity of sales of men's athletic shoes across all product attributes and purchased by all customers within an indicated customer store segment. For example, table 430 indicates that 23621 pairs of men's athletic shoes were sold in cluster 1, and 96330 men's athletic shoes were sold in cluster 4.

FIG. 4B is a diagram illustrating a chart associated with a set of product attribute sales summaries according to at least one example embodiment. The example of FIG. 4B corresponds with the product attribute sales summaries depicted in the example of FIG. 4A. As can be seen, chart 440 depicts sales of men's athletic shoes that are in the $40-$70 price range and of the specialty type with respect to a “Middle America” customer store segment, an “Older Affluent” customer store segment, a “Hispanic Middle Income” customer store segment, and an “Older Middle Income” customer store segment. The usefulness of the results may be evaluated visually by charting the results for specific combinations of product attributes with respect to the respective customer store segment, as shown in chart 440. As can be seen, chart 440 depicts the probabilities of sale for each customer store segment for men's athletic shoes that are associated with the indicated product attributes. As can be seen, the resulting probabilities are similar to the probabilities indicated by the category average. As such, a distinctiveness rating associated with the product attribute sales summary associated with chart 440 may be lower than another product attribute sales summary that yields more interesting and/or useful results.

Analysis of chart 440 supports the forming of various inferences. For example, quantity of sales for the indicated men's athletic shoes do not deviate significantly from the category average quantity of sales in the middle income customer store segments, “Hispanic Middle Income” and “Older Middle Income”. Additionally, although the quantity of sales per store for all men's athletic shoes on average is roughly equal for stores in the “Older Affluent” and “Older Middle Income” customer store segments, men's athletic shoes of the specific type indicated, specialty brands in the $40-$70 price bracket, sell significantly better in the “Older Affluent” customer store segment. As such, it may be desirable to allot additional inventory of men's athletic shoes associated with the indicated product attributes to stores within the “Older Affluent” customer store segment. Additionally, chart 440 indicates that the sales of the specific men's athletic shoe type at stores in the “Middle America” customer store segment are fewer than the average category performance might indicate. As such, it may be desirable to apportion fewer less inventory of men's athletic shoes associated with the indicated product attributes to stores within the “Middle America” customer store segment than may be indicated by average men's athletic shoe performance might indicate.

FIG. 4C is a diagram illustrating a product sales prediction table according to at least one example embodiment. The example of FIG. 4C depicts product sales prediction table 460. Product sales prediction table 460 may be based, at least in part, on a set of product attribute sales summaries, a customer store segment sales model, and/or the like. In the example of FIG. 4C, product sales prediction table 360 depicts a set of probabilities of sales associated with a particular set of customer store segments. As can be seen, the “Older Middle Income” customer store segment is associated with a 0.2178 probability of sale, the “Hispanic Middle Income” customer store segment is associated with a 0.2634 probability of sale, the “Older Affluent” customer store segment is associated with a 0.4044 probability of sale, and the “Middle America” customer store segment is associated with a 0.1144 probability of sale. As such, given a sale of a pair of men's athletic shoes, product sales prediction table 360 indicates a probability that the specific sale took place at each of the indicated customer store segments. In this manner, a merchant may utilize such information in determining how to allot the merchant's inventory of men's athletic shoes among the merchant's stores, between the various customer stores segments, and/or the like.

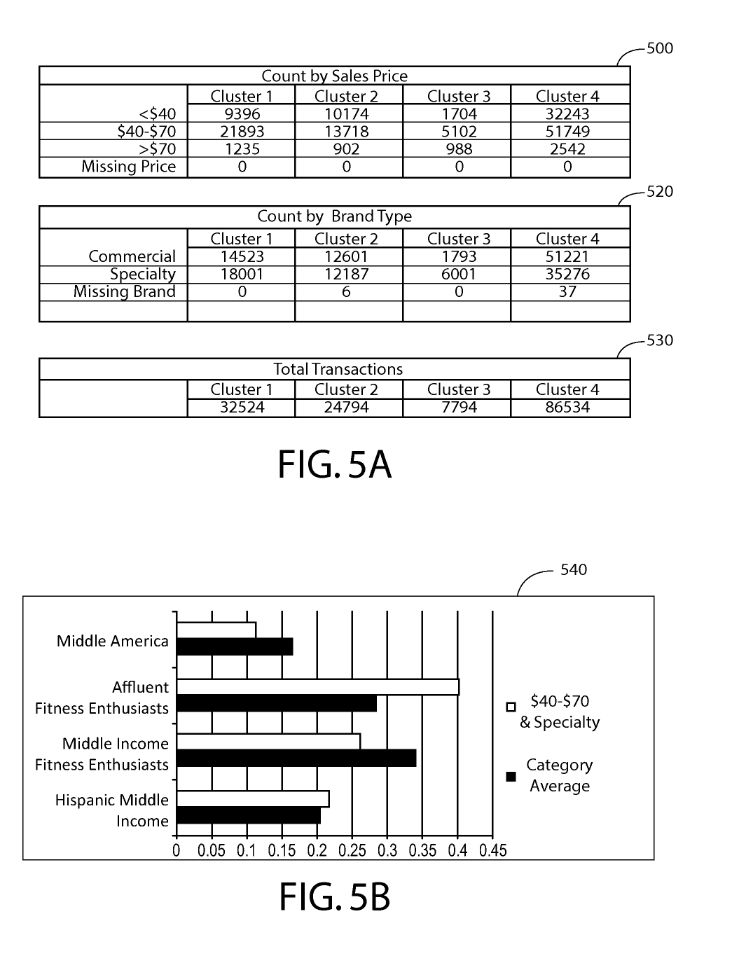

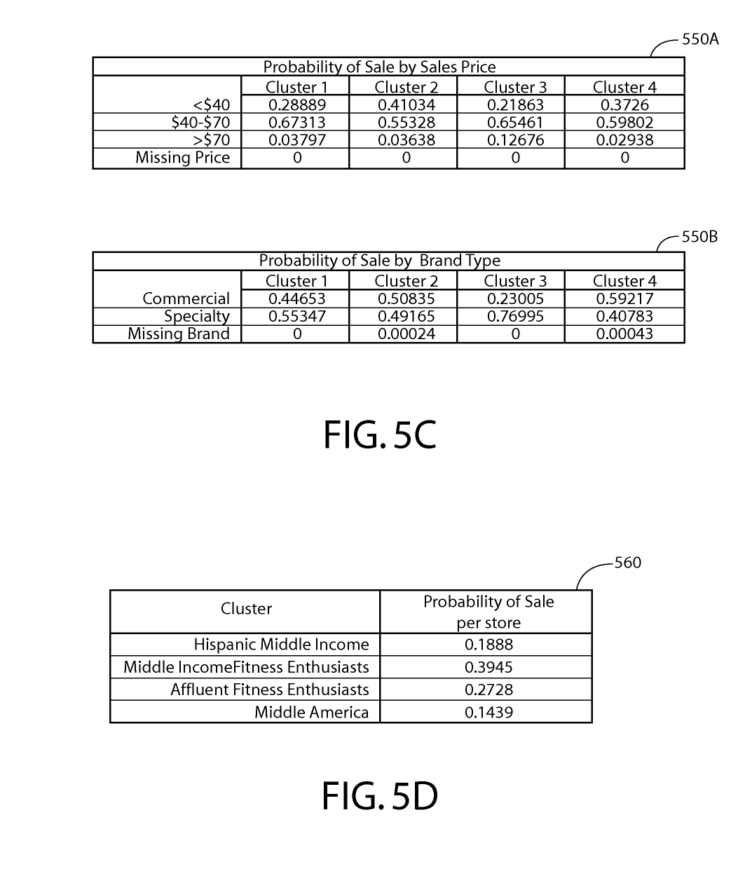

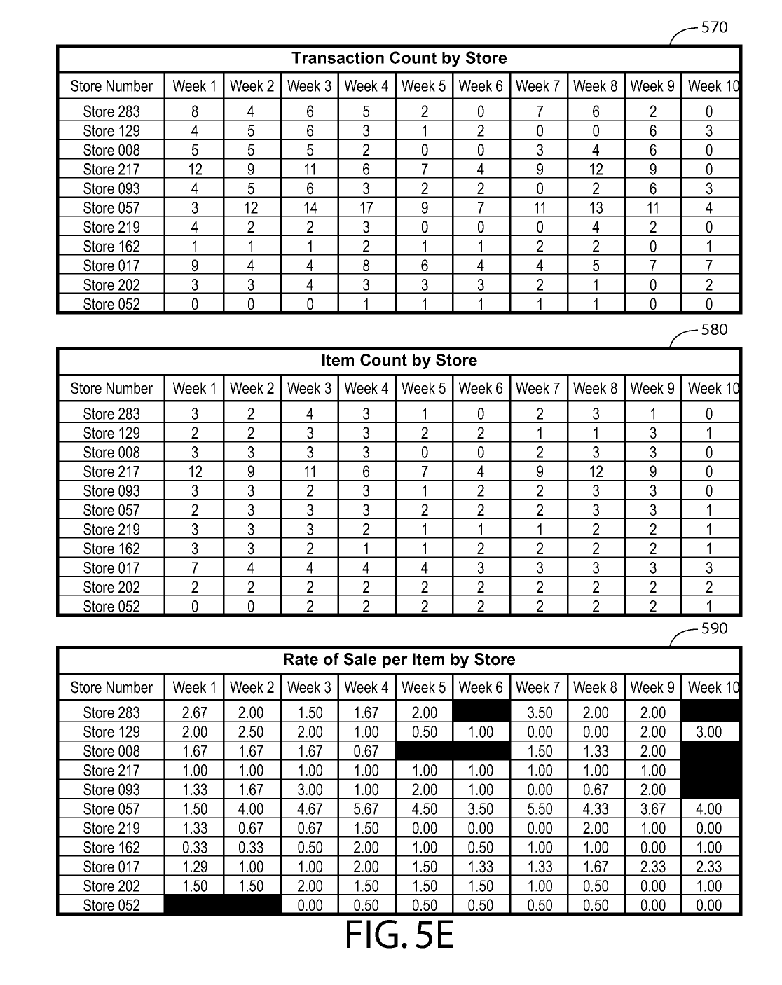

FIGS. 5A-5E are diagrams illustrating a set of product attribute sales summaries and information associated with the set of product attribute sales summaries according to at least one example embodiment. The examples of FIGS. 5A-5E are merely examples and do not limit the scope of the claims. For example, product attribute sales summary configuration and/or content may vary, customer store segment count may vary, product attribute count may vary, graph configuration and/or content may vary, product sales prediction table configuration and/or content may vary, and/or the like.

As discussed regarding FIGS. 4A-4C, a merchant may desire to sell men's athletic shoes. The set of three customer attributes discussed regarding FIGS. 4A-4C, annual household income, percentage Hispanic, and age, may fail to provide a sufficient basis for a customer store segment sales model due to a lack of distinctiveness, a low level of information gain resulting from analysis of chart 440 of FIG. 4B, and/or the like. As such, it may be desirable to analyze one or more additional sets of customer attributes in relation to the sale of men's athletic shoes. For example, as discussed in the previous example, a set of three customer attributes may be used to characterize male customers of men's athletic shoes: annual household income, percentage Hispanic, and age. In some circumstances, it may be desirable to pursue analysis of various combinations of customer attributes, product attributes, and/or the like. For example, replacing the age-related customer attribute with a lifestyle-related customer attribute may yield interesting and useful results in relation to sales of men's athletic shoes. The lifestyle-related customer attribute may be a customer attribute that indicates a measure of community fitness. For example, survey data that indicates an average level of health and fitness for a specific zip code may be referenced by way of the residential zip code that is indicated in loyalty account information.

In such an example, the set of customer attributes may comprise an annual household income, a percentage Hispanic, and a community fitness rank. The annual household income may indicate a household income of less than $50,000, $50,000-$80,000, or greater than $80,000. The percentage Hispanic may indicate a percentage that is less than 5%, 5%-15%, or greater than 15%. The community fitness rank may indicate value ranges of 1-15, 16-30, and greater than 30. In such an example, the set of product attributes may comprise a price point and a band type. The price point may indicate that a pair of men's athletic shoes are priced under $40, $40-$70, or greater than $70. The brand type may indicate that the pair of men's athletic shoes are of the commercial type or the specialty type. As such, four customer store segments may be identified—cluster 1, which is characterized by “Hispanic Middle Income” and comprises 29 stores, cluster 2, which is characterized by “Middle Income Fitness Enthusiasts” and comprises 63 stores, cluster 3, which is characterized by “Affluent Fitness Enthusiasts” and comprises 11 stores, and cluster 4, which is characterized by “Middle America” and comprises 209 stores.

FIG. 5A is a diagram illustrating a set of product attribute sales summaries according to at least one example embodiment. As can be seen, FIG. 5A depicts product attribute sales summary 500 and product attribute sales summary 520. Each of product attribute sales summary 500 and product attribute sales summary 520 correlate clusters 1, 2, 3, and 4, which are customer store segments, and various product attributes, to the indicated quantity of sales data. For example, product attribute sales summary 500 indicates that 13718 men's athletic shoes in the $40-$70 price range were sold in cluster 2, and that 1235 men's athletic shoes in the greater than $70 price range were sold in cluster 1. In another example, product attribute sales summary 520 indicates that 14523 men's athletic shoes of the commercial type were sold in cluster 1, and that 6001 men's athletic shoes of the specialty type were sold in cluster 3. As can be seen, the example of FIG. 5A also depicts table 530, which indicates a total quantity of sales of men's athletic shoes across all product attributes and purchased by all customers within an indicated customer store segment. For example, table 530 indicates that 32524 pairs of men's athletic shoes were sold in cluster 1, and 86534 men's athletic shoes were sold in cluster 4.

FIG. 5B is a diagram illustrating a chart associated with a set of product attribute sales summaries according to at least one example embodiment. The example of FIG. 5B corresponds with the product attribute sales summaries depicted in the example of FIG. 5A. As can be seen, chart 540 depicts sales of men's athletic shoes that are in the $40-$70 price range and of the specialty type with respect to a “Middle America” customer store segment, an “Affluent Fitness Enthusiasts” customer store segment, a “Middle Income Fitness Enthusiasts” customer store segment, and a “Hispanic Middle Income” customer store segment. The usefulness of the results may be evaluated visually by charting the results for specific combinations of product attributes with respect to the respective customer store segment, as shown in chart 540. As can be seen, chart 540 depicts the probabilities of sale for each customer store segment for men's athletic shoes that are associated with the indicated product attributes. As can be seen, the resulting probabilities significant different from the probabilities indicated by the category average in at least two of the customer store segments. As such, a distinctiveness rating associated with the product attribute sales summary associated with chart 540 may be higher than another product attribute sales summary that fails to yield interesting and/or useful results.

Analysis of chart 540 supports the forming of various inferences. For example, it can be seen that, on average, stores in the “Affluent Fitness Enthusiasts” customer store segment will likely sell the particular type of men's athletic shoe—specialty shoes in the $40-$70 price range—better than all other stores in the set of stores and all other customer store segments, and specifically, that sales will likely exceed the sales performance of stores in the “Middle Income Fitness Enthusiasts” customer store segment, despite the “Middle Income Fitness Enthusiasts” customer store segment having greater total sales for the men's athletic shoe category as a whole. As can be seen, a distinctiveness rating associated with the set of product attribute sales summaries represented by chart 540 of FIG. 5B would likely be higher than a distinctiveness rating associated with the set of product attribute sales summaries represented by chart 440 of FIG. 4B. As such, it may be more desirable to determine a customer store segment sales model based, at least in part, on the set of product attribute sales summaries represented by chart 540 of FIG. 5B.

FIG. 5C is a diagram illustrating a set of product attribute probability of sale summaries according to at least one example embodiment. As can be seen, FIG. 5C depicts product attribute probability of sale summary 550A and product attribute probability of sale summary 550B, which correspond to product attribute sales summary 500 and product attribute sales summary 520 of FIG. 5A, respectively. Each of product attribute probability of sale summary 550A and product attribute probability of sale summary 550B correlate clusters 1, 2, 3, and 4, which are customer store segments, and various product attributes, to the indicated probability of sale data. For example, product attribute probability of sale summary 550A indicates a probability of sale of 0.28889 for products that are associated with a sales price of under $40 within cluster 1. In another example, product attribute probability of sale summary 550A indicates a probability of sale of 0.49165 for products that are of the specialty brand type in cluster 2.

FIG. 5D is a diagram illustrating a product sales prediction table according to at least one example embodiment. The example of FIG. 5D depicts product sales prediction table 560. Product sales prediction table 560 may be based, at least in part, on a set of product attribute sales summaries, a customer store segment sales model, and/or the like. In the example of FIG. 5D, product sales prediction table 560 depicts a set of probabilities of sales associated with a particular set of customer store segments. As can be seen, the “Hispanic Middle Income” customer store segment is associated with a 0.188 probability of sale, the “Middle Income Fitness Enthusiasts” customer store segment is associated with a 0.3945 probability of sale, the “Affluent Fitness Enthusiasts” customer store segment is associated with a 0.2728 probability of sale, and the “Middle America” customer store segment is associated with a 0.1439 probability of sale. As such, given a sale of a pair of men's athletic shoes, product sales prediction table 460 indicates a probability that the specific sale took place at each of the indicated customer store segments. In this manner, a merchant may utilize such information in determining how to allot the merchant's inventory of men's athletic shoes among the merchant's stores, between the various customer stores segments, and/or the like.

FIG. 5E is a diagram illustrating a quantity of sales summary, an inventory summary, and a rate of sale summary according to at least one example embodiment. The example of FIG. 5E depicts a set of historical sales information summaries. In the example of FIG. 5E, the set of historical sales information summaries comprises quantity of sales summary 570, inventory summary 580, and rate of sale summary 590. As can be seen in quantity of sales summary 570, the quantity of sales data is a quantity of sales attributable to a specific store, a specific customer store segment, and/or the like, over a predetermined duration. For example, quantity of sales summary 570 indicates a quantity of sale of 11 is attributable to store 217 over week 3. Quantity of sales summary 570 further indicates that 6 transactions took place at store 217 the following week, week 4.

As can be seen in inventory summary 580, the inventory data is a count of inventory that is attributable to a specific store, a specific customer store segment, and/or the like, over a predetermined duration. For example, inventory summary 580 indicates that store 217 had 9 items associated with the particular product attribute(s) in stock during week 9. Inventory summary 580 further indicates that store 217 ran out of stock the following week, week 10.

As can be seen in rate of sale summary 590, the rate of sale data is a rate of sale that is attributable to a specific store, a specific customer store segment, and/or the like, over a predetermined duration. For example, rate of sale summary 590 indicates that store 057 had a rate of sale of 1.50 during week 1, but increased to a rate of sale of 5.67 by week 4.

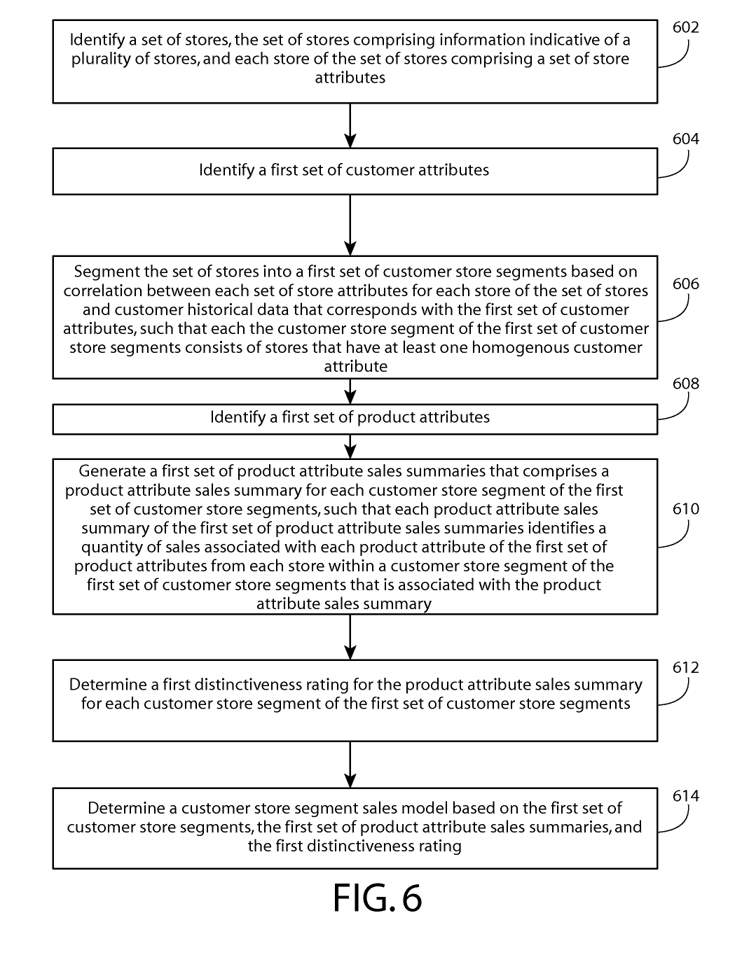

FIG. 6 is a flow diagram illustrating activities associated with determination of a customer store segment sales model according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

At block 602, the apparatus identifies a set of stores. In at least one example embodiment, the set of stores comprises information indicative of a plurality of stores, and each store of the set of stores comprises a set of store attributes. The identification, the set of stores, the plurality of stores, and the set of store attributes may be similar as described regarding FIGS. 2A-2B, FIGS. 3A-3E, FIGS. 4A-4C, and FIGS. 5A-5E.

At block 604, the apparatus identifies a first set of customer attributes. The identification and the first set of customer attributes may be similar as described regarding FIGS. 2A-2B, FIGS. 3A-3E, FIGS. 4A-4C, and FIGS. 5A-5E.

At block 606, the apparatus segments the set of stores into a first set of customer store segments based, at least in part, on correlation between each set of store attributes for each store of the set of stores and customer historical data that corresponds with the first set of customer attributes. In at least one example embodiment, the apparatus segments the set of stores into the first set of customer store segments such that each the customer store segment of the first set of customer store segments consists of stores that have at least one homogenous customer attribute. The segmentation, the first set of customer store segments, the customer historical data, and the homogenous customer attribute may be similar as described regarding FIGS. 2A-2B, FIGS. 3A-3E, FIGS. 4A-4C, and FIGS. 5A-5E.

At block 608, the apparatus identifies a first set of product attributes. The identification and the first set of product attributes may be similar as described regarding FIGS. 3A-3E, FIGS. 4A-4C, and FIGS. 5A-5E.

At block 610, the apparatus generates a first set of product attribute sales summaries that comprises a product attribute sales summary for each customer store segment of the first set of customer store segments. In at least one example embodiment, the apparatus generates the first set of product attribute sales summaries such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries. The generation, the first set of product attribute sales summaries, the product attribute sales summary, and the quantity of sales may be similar as described regarding FIGS. 3A-3E, FIGS. 4A-4C, and FIGS. 5A-5E.

At block 612, the apparatus determines a first distinctiveness rating for the product attribute sales summary for each customer store segment of the first set of customer store segments. The determination and the first distinctiveness rating may be similar as described regarding FIGS. 3A-3E, FIGS. 4A-4C, and FIGS. 5A-5E.

At block 614, the apparatus determines a customer store segment sales model based, at least in part, on the first set of customer store segments, the first set of product attribute sales summaries, and the first distinctiveness rating. The determination and the customer store segment sales model may be similar as described regarding FIGS. 3A-3E, FIGS. 4A-4C, and FIGS. 5A-5E.

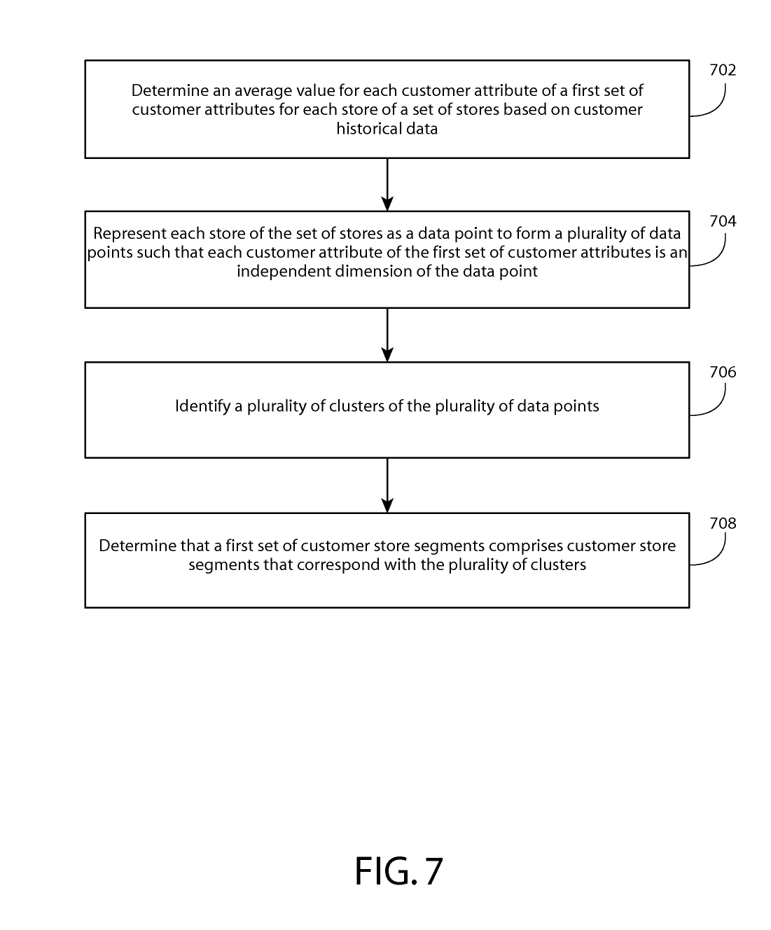

FIG. 7 is a flow diagram illustrating activities associated with identification of a plurality of clusters according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

In some circumstances, it may be desirable to segment a set of stores into a set of customer store segments based, at least in part, on a set of customer attributes. As such, the activities illustrated in the example of FIG. 7 may be performed in relation to the activities illustrated in the example of FIG. 6. For example, the activities illustrated in the example of FIG. 7 may be performed prior to the activity illustrated in block 606 of FIG. 6, subsequent to the activity illustrated in block 606 of FIG. 6, in lieu of the activity illustrated in block 606 of FIG. 6, and/or the like.

At block 702, the apparatus determines an average value for each customer attribute of a first set of customer attributes for each store of a set of stores based, at least in part, on customer historical data. The determination, the average value for each customer attribute, the first set of customer attributes, the store, and the set of stores may be similar as described regarding FIGS. 2A-2B, FIGS. 3A-3E, FIGS. 4A-4C, and FIGS. 5A-5E.

At block 704, the apparatus represents each store of the set of stores as a data point to form a plurality of data points such that each customer attribute of the first set of customer attributes is an independent dimension of the data point. The representation, the data point, the plurality of data points, and the independent dimension of the data point may be similar as described regarding FIGS. 2A-2B, FIGS. 3A-3E, FIGS. 4A-4C, and FIGS. 5A-5E.

At block 706, the apparatus identifies a plurality of clusters of the plurality of data points. The identification and the plurality of clusters may be similar as described regarding FIGS. 2A-2B, FIGS. 3A-3E, FIGS. 4A-4C, and FIGS. 5A-5E.

At block 708, the apparatus determines that a first set of customer store segments comprises customer store segments that correspond with the plurality of clusters. The determination and the first set of customer store segments may be similar as described regarding FIGS. 2A-2B, FIGS. 3A-3E, FIGS. 4A-4C, and FIGS. 5A-5E.

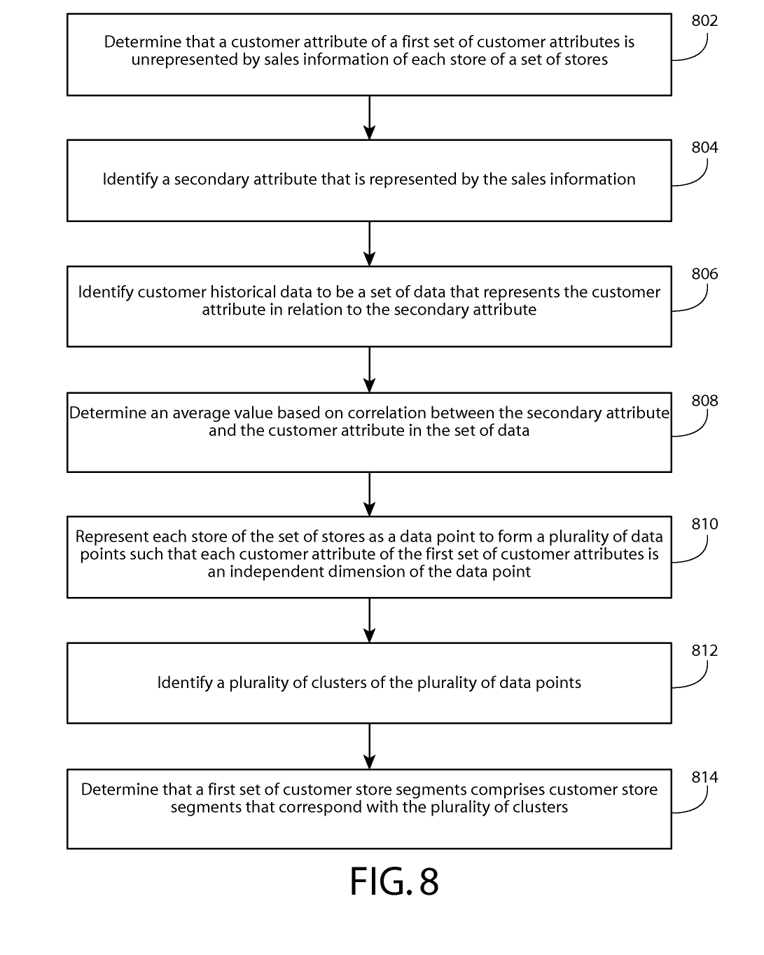

FIG. 8 is a flow diagram illustrating activities associated with identification of a plurality of clusters according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

In some circumstances, it may be desirable to determine an average value for each customer attribute of a set of customer attributes based, at least in part, on customer historical data. As such, the activities illustrated in the example of FIG. 8 may be performed in relation to the activities illustrated in the example of FIG. 7. For example, the activities illustrated in the example of FIG. 8 may be performed prior to the activity illustrated in block 702 of FIG. 7, subsequent to the activity illustrated in block 702 of FIG. 7, in lieu of the activity illustrated in block 702 of FIG. 7, and/or the like.

At block 802, the apparatus determines that a customer attribute of a first set of customer attributes is unrepresented by sales information of each store of a set of stores. The determination, the customer attribute, the first set of customer attributes, the sales information of each store, and the set of stores may be similar as described regarding FIGS. 2A-2B, FIGS. 3A-3E, FIGS. 4A-4C, and FIGS. 5A-5E.

At block 804, the apparatus identifies a secondary attribute that is represented by the sales information. The identification and the secondary attribute may be similar as described regarding FIGS. 2A-2B, FIGS. 3A-3E, FIGS. 4A-4C, and FIGS. 5A-5E.

At block 806, the apparatus identifies customer historical data to be a set of data that represents the customer attribute in relation to the secondary attribute. The identification, the customer historical data, and the set of data may be similar as described regarding FIGS. 2A-2B, FIGS. 3A-3E, FIGS. 4A-4C, and FIGS. 5A-5E.

At block 808, the apparatus determines an average value based, at least in part, on correlation between the secondary attribute and the customer attribute in the set of data. The determination and the average value may be similar as described regarding FIGS. 2A-2B, FIGS. 3A-3E, FIGS. 4A-4C, and FIGS. 5A-5E.

At block 810, the apparatus represents each store of the set of stores as a data point to form a plurality of data points such that each customer attribute of the first set of customer attributes is an independent dimension of the data point. The representation, the data point, the plurality of data points, and the independent dimension of the data point may be similar as described regarding FIGS. 2A-2B, FIGS. 3A-3E, FIGS. 4A-4C, and FIGS. 5A-5E.

At block 812, the apparatus identifies a plurality of clusters of the plurality of data points. The identification and the plurality of clusters may be similar as described regarding FIGS. 2A-2B, FIGS. 3A-3E, FIGS. 4A-4C, and FIGS. 5A-5E.

At block 814, the apparatus determines that a first set of customer store segments comprises customer store segments that correspond with the plurality of clusters. The determination and the first set of customer store segments may be similar as described regarding FIGS. 2A-2B, FIGS. 3A-3E, FIGS. 4A-4C, and FIGS. 5A-5E.

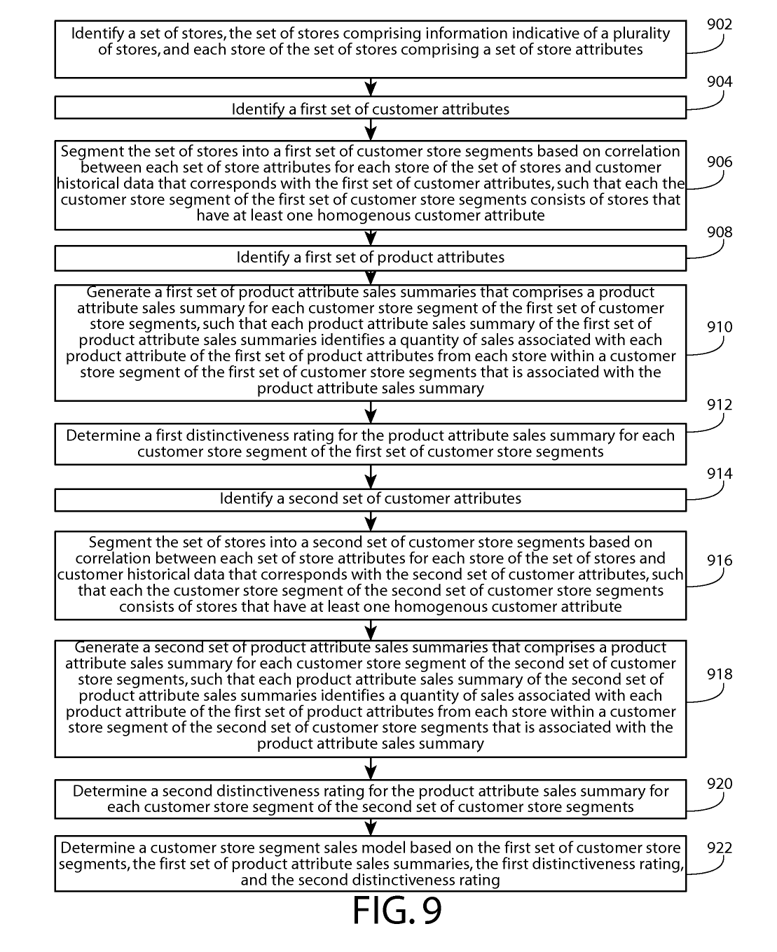

FIG. 9 is a flow diagram illustrating activities associated with determination of a customer store segment sales model according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

As previously discussed, in some circumstances, it may be desirable to determine a customer store segment sales model based, at least in part, on a first set of product attribute sales summaries and an associated first distinctiveness rating, and a second set of product attribute sales summaries and an associated second distinctiveness rating.

At block 902, the apparatus identifies a set of stores. In at least one example embodiment, the set of stores comprises information indicative of a plurality of stores, and each store of the set of stores comprises a set of store attributes. The identification, the set of stores, the plurality of stores, and the set of store attributes may be similar as described regarding FIGS. 2A-2B, FIGS. 3A-3E, FIGS. 4A-4C, and FIGS. 5A-5E.

At block 904, the apparatus identifies a first set of customer attributes. The identification and the first set of customer attributes may be similar as described regarding FIGS. 2A-2B, FIGS. 3A-3E, FIGS. 4A-4C, and FIGS. 5A-5E.

At block 906, the apparatus segments the set of stores into a first set of customer store segments based, at least in part, on correlation between each set of store attributes for each store of the set of stores and customer historical data that corresponds with the first set of customer attributes. In at least one example embodiment, the apparatus segments the set of stores into the first set of customer store segments such that each the customer store segment of the first set of customer store segments consists of stores that have at least one homogenous customer attribute. The segmentation, the first set of customer store segments, the customer historical data, and the homogenous customer attribute may be similar as described regarding FIGS. 2A-2B, FIGS. 3A-3E, FIGS. 4A-4C, and FIGS. 5A-5E.

At block 908, the apparatus identifies a first set of product attributes. The identification and the first set of product attributes may be similar as described regarding FIGS. 3A-3E, FIGS. 4A-4C, and FIGS. 5A-5E.

At block 910, the apparatus generates a first set of product attribute sales summaries that comprises a product attribute sales summary for each customer store segment of the first set of customer store segments. In at least one example embodiment, the apparatus generates the first set of product attribute sales summaries such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries. The generation, the first set of product attribute sales summaries, the product attribute sales summary, and the quantity of sales may be similar as described regarding FIGS. 3A-3E, FIGS. 4A-4C, and FIGS. 5A-5E.

At block 912, the apparatus determines a first distinctiveness rating for the product attribute sales summary for each customer store segment of the first set of customer store segments. The determination and the first distinctiveness rating may be similar as described regarding FIGS. 3A-3E, FIGS. 4A-4C, and FIGS. 5A-5E.

At block 914, the apparatus identifies a second set of customer attributes. The identification and the second set of customer attributes may be similar as described regarding FIGS. 2A-2B, FIGS. 3A-3E, FIGS. 4A-4C, and FIGS. 5A-5E.

At block 916, the apparatus segments the set of stores into a second set of customer store segments based, at least in part, on correlation between each set of store attributes for each store of the set of stores and customer historical data that corresponds with the second set of customer attributes. In at least one example embodiment, the apparatus segments the set of stores into the first set of customer store segments such that each the customer store segment of the second set of customer store segments consists of stores that have at least one homogenous customer attribute. The segmentation, the second set of customer store segments, the customer historical data, and the homogenous customer attribute may be similar as described regarding FIGS. 2A-2B, FIGS. 3A-3E, FIGS. 4A-4C, and FIGS. 5A-5E.

At block 918, the apparatus generates a second set of product attribute sales summaries that comprises a product attribute sales summary for each customer store segment of the second set of customer store segments. In at least one example embodiment, the apparatus generates the second set of product attribute sales summaries such that each product attribute sales summary of the second set of product attribute sales summaries identifies a quantity of sales associated with each product attribute of the first set of product attributes from each store within a customer store segment of the second set of customer store segments that is associated with the product attribute sales summary of the second set of product attribute sales summaries. The generation, the second set of product attribute sales summaries, the product attribute sales summary, and the quantity of sales may be similar as described regarding FIGS. 3A-3E, FIGS. 4A-4C, and FIGS. 5A-5E.

At block 920, the apparatus determines a second distinctiveness rating for the product attribute sales summary for each customer store segment of the second set of customer store segments. The determination and the second distinctiveness rating may be similar as described regarding FIGS. 3A-3E, FIGS. 4A-4C, and FIGS. 5A-5E.

At block 922, the apparatus determines a customer store segment sales model based, at least in part, on the first set of customer store segments, the first set of product attribute sales summaries, the first distinctiveness rating, and the second distinctiveness rating. The determination and the customer store segment sales model may be similar as described regarding FIGS. 3A-3E, FIGS. 4A-4C, and FIGS. 5A-5E.

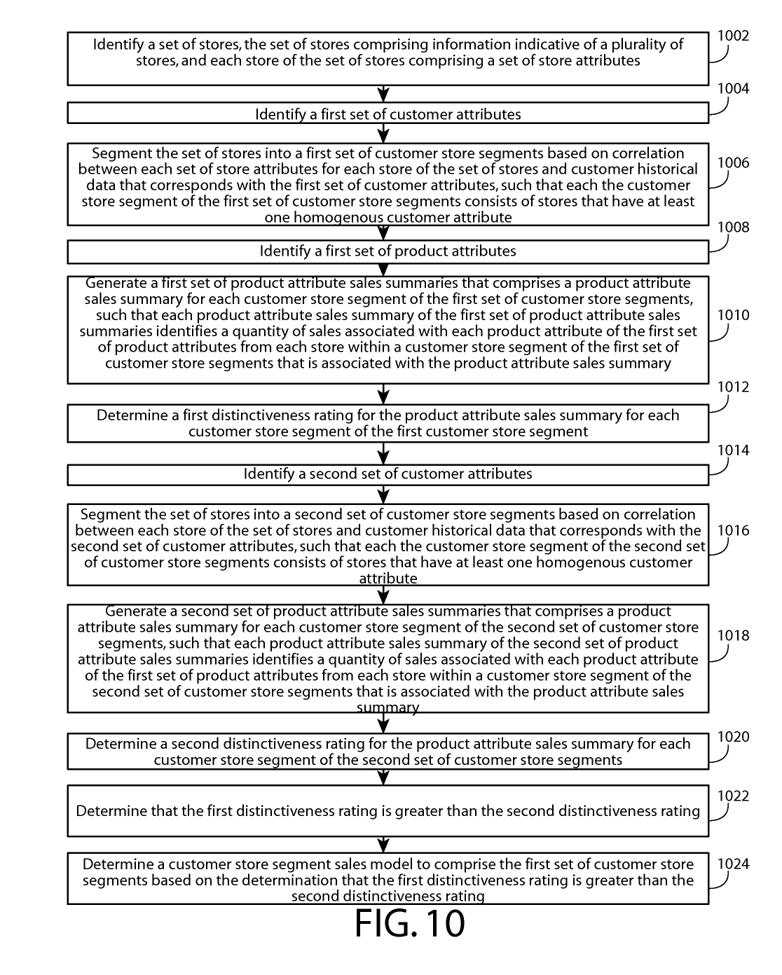

FIG. 10 is a flow diagram illustrating activities associated with determination of a customer store segment sales model according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

As previously discussed, in some circumstances, it may be desirable to determine a first distinctiveness rating that is associated with a first set of customer store segments, and a second distinctiveness rating that is associated with a second set of customer store segments. In such an example, it may be desirable to determine a customer store segment sales model to comprise the set of customer store segments that is associated with the greater distinctiveness rating.

At block 1002, the apparatus identifies a set of stores. In at least one example embodiment, the set of stores comprises information indicative of a plurality of stores, and each store of the set of stores comprises a set of store attributes. The identification, the set of stores, the plurality of stores, and the set of store attributes may be similar as described regarding FIGS. 2A-2B, FIGS. 3A-3E, FIGS. 4A-4C, and FIGS. 5A-5E.

At block 1004, the apparatus identifies a first set of customer attributes. The identification and the first set of customer attributes may be similar as described regarding FIGS. 2A-2B, FIGS. 3A-3E, FIGS. 4A-4C, and FIGS. 5A-5E.

At block 1006, the apparatus segments the set of stores into a first set of customer store segments based, at least in part, on correlation between each set of store attributes for each store of the set of stores and customer historical data that corresponds with the first set of customer attributes. In at least one example embodiment, the apparatus segments the set of stores into the first set of customer store segments such that each the customer store segment of the first set of customer store segments consists of stores that have at least one homogenous customer attribute. The segmentation, the first set of customer store segments, the customer historical data, and the homogenous customer attribute may be similar as described regarding FIGS. 2A-2B, FIGS. 3A-3E, FIGS. 4A-4C, and FIGS. 5A-5E.

At block 1008, the apparatus identifies a first set of product attributes. The identification and the first set of product attributes may be similar as described regarding FIGS. 3A-3E, FIGS. 4A-4C, and FIGS. 5A-5E.

At block 1010, the apparatus generates a first set of product attribute sales summaries that comprises a product attribute sales summary for each customer store segment of the first set of customer store segments. In at least one example embodiment, the apparatus generates the first set of product attribute sales summaries such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries. The generation, the first set of product attribute sales summaries, the product attribute sales summary, and the quantity of sales may be similar as described regarding FIGS. 3A-3E, FIGS. 4A-4C, and FIGS. 5A-5E.

At block 1012, the apparatus determines a first distinctiveness rating for the product attribute sales summary for each customer store segment of the first set of customer store segments. The determination and the first distinctiveness rating may be similar as described regarding FIGS. 3A-3E, FIGS. 4A-4C, and FIGS. 5A-5E.

At block 1014, the apparatus identifies a second set of customer attributes. The identification and the second set of customer attributes may be similar as described regarding FIGS. 2A-2B, FIGS. 3A-3E, FIGS. 4A-4C, and FIGS. 5A-5E.

At block 1016, the apparatus segments the set of stores into a second set of customer store segments based, at least in part, on correlation between each set of store attributes for each store of the set of stores and customer historical data that corresponds with the second set of customer attributes. In at least one example embodiment, the apparatus segments the set of stores into the first set of customer store segments such that each the customer store segment of the second set of customer store segments consists of stores that have at least one homogenous customer attribute. The segmentation, the second set of customer store segments, the customer historical data, and the homogenous customer attribute may be similar as described regarding FIGS. 2A-2B, FIGS. 3A-3E, FIGS. 4A-4C, and FIGS. 5A-5E.

At block 1018, the apparatus generates a second set of product attribute sales summaries that comprises a product attribute sales summary for each customer store segment of the second set of customer store segments. In at least one example embodiment, the apparatus generates the second set of product attribute sales summaries such that each product attribute sales summary of the second set of product attribute sales summaries identifies a quantity of sales associated with each product attribute of the first set of product attributes from each store within a customer store segment of the second set of customer store segments that is associated with the product attribute sales summary of the second set of product attribute sales summaries. The generation, the second set of product attribute sales summaries, the product attribute sales summary, and the quantity of sales may be similar as described regarding FIGS. 3A-3E, FIGS. 4A-4C, and FIGS. 5A-5E.

At block 1020, the apparatus determines a second distinctiveness rating for the product attribute sales summary for each customer store segment of the second set of customer store segments. The determination and the second distinctiveness rating may be similar as described regarding FIGS. 3A-3E, FIGS. 4A-4C, and FIGS. 5A-5E.

At block 1022, the apparatus determines that the first distinctiveness rating is greater than the second distinctiveness rating. The determination may be similar as described regarding FIGS. 3A-3E, FIGS. 4A-4C, and FIGS. 5A-5E.

At block 1024, the apparatus determines a customer store segment sales model to comprise the first set of customer store segments based, at least in part, on the determination that the first distinctiveness rating is greater than the second distinctiveness rating. The determination and the customer store segment sales model may be similar as described regarding FIGS. 3A-3E, FIGS. 4A-4C, and FIGS. 5A-5E.

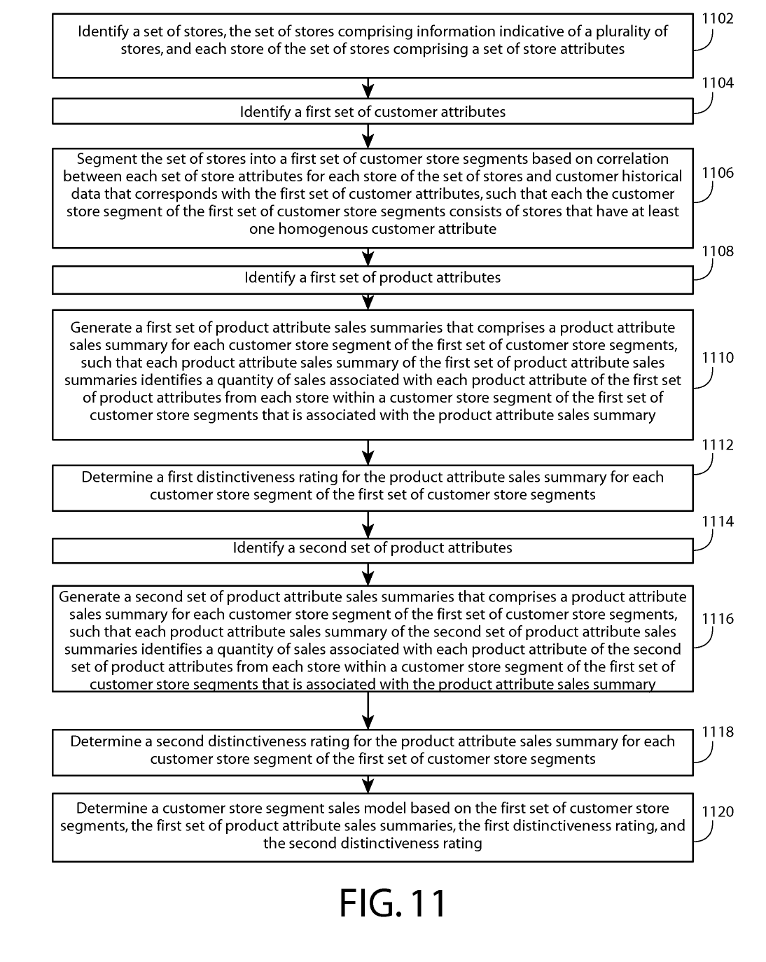

FIG. 11 is a flow diagram illustrating activities associated with determination of a customer store segment sales model according to at least one example embodiment. In at least one example embodiment, there is a set of operations that corresponds with the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

As previously discussed, in some circumstances, it may be desirable to determine a first distinctiveness rating that is associated with a first set of product attribute sales summaries, and a second distinctiveness rating that is associated with a second set of product attribute sales summaries. In such an example, it may be desirable to determine a customer store segment sales model based, at least in part, on the first distinctiveness rating and the second distinctiveness rating.

At block 1102, the apparatus identifies a set of stores. In at least one example embodiment, the set of stores comprises information indicative of a plurality of stores, and each store of the set of stores comprises a set of store attributes. The identification, the set of stores, the plurality of stores, and the set of store attributes may be similar as described regarding FIGS. 2A-2B, FIGS. 3A-3E, FIGS. 4A-4C, and FIGS. 5A-5E.

At block 1104, the apparatus identifies a first set of customer attributes. The identification and the first set of customer attributes may be similar as described regarding FIGS. 2A-2B, FIGS. 3A-3E, FIGS. 4A-4C, and FIGS. 5A-5E.

At block 1106, the apparatus segments the set of stores into a first set of customer store segments based, at least in part, on correlation between each set of store attributes for each store of the set of stores and customer historical data that corresponds with the first set of customer attributes. In at least one example embodiment, the apparatus segments the set of stores into the first set of customer store segments such that each the customer store segment of the first set of customer store segments consists of stores that have at least one homogenous customer attribute. The segmentation, the first set of customer store segments, the customer historical data, and the homogenous customer attribute may be similar as described regarding FIGS. 2A-2B, FIGS. 3A-3E, FIGS. 4A-4C, and FIGS. 5A-5E.

At block 1108, the apparatus identifies a first set of product attributes. The identification and the first set of product attributes may be similar as described regarding FIGS. 3A-3E, FIGS. 4A-4C, and FIGS. 5A-5E.

At block 1110, the apparatus generates a first set of product attribute sales summaries that comprises a product attribute sales summary for each customer store segment of the first set of customer store segments. In at least one example embodiment, the apparatus generates the first set of product attribute sales summaries such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries. The generation, the first set of product attribute sales summaries, the product attribute sales summary, and the quantity of sales may be similar as described regarding FIGS. 3A-3E, FIGS. 4A-4C, and FIGS. 5A-5E.

At block 1112, the apparatus determines a first distinctiveness rating for the product attribute sales summary for each customer store segment of the first set of customer store segments. The determination and the first distinctiveness rating may be similar as described regarding FIGS. 3A-3E, FIGS. 4A-4C, and FIGS. 5A-5E.

At block 1114, the apparatus identifies a second set of product attributes. The identification and the second set of product attributes may be similar as described regarding FIGS. 3A-3E, FIGS. 4A-4C, and FIGS. 5A-5E.

At block 1116, the apparatus generates a second set of product attribute sales summaries that comprises a product attribute sales summary for each customer store segment of the first set of customer store segments. In at least one example embodiment, the apparatus generates the second set of product attribute sales summaries such that each product attribute sales summary of the second set of product attribute sales summaries identifies a quantity of sales associated with each product attribute of the second set of product attributes from each store within a customer store segment of the first set of customer store segments that is associated with the product attribute sales summary of the second set of product attribute sales summaries. The generation, the second set of product attribute sales summaries, the product attribute sales summary, and the quantity of sales may be similar as described regarding FIGS. 3A-3E, FIGS. 4A-4C, and FIGS. 5A-5E.

At block 1118, the apparatus determines a second distinctiveness rating for the product attribute sales summary for each customer store segment of the first set of customer store segments. The determination and the second distinctiveness rating may be similar as described regarding FIGS. 3A-3E, FIGS. 4A-4C, and FIGS. 5A-5E.

At block 1120, the apparatus determines a customer store segment sales model based, at least in part, on the first set of customer store segments, the first set of product attribute sales summaries, the first distinctiveness rating, and the second distinctiveness rating. The determination and the customer store segment sales model may be similar as described regarding FIGS. 3A-3E, FIGS. 4A-4C, and FIGS. 5A-5E.

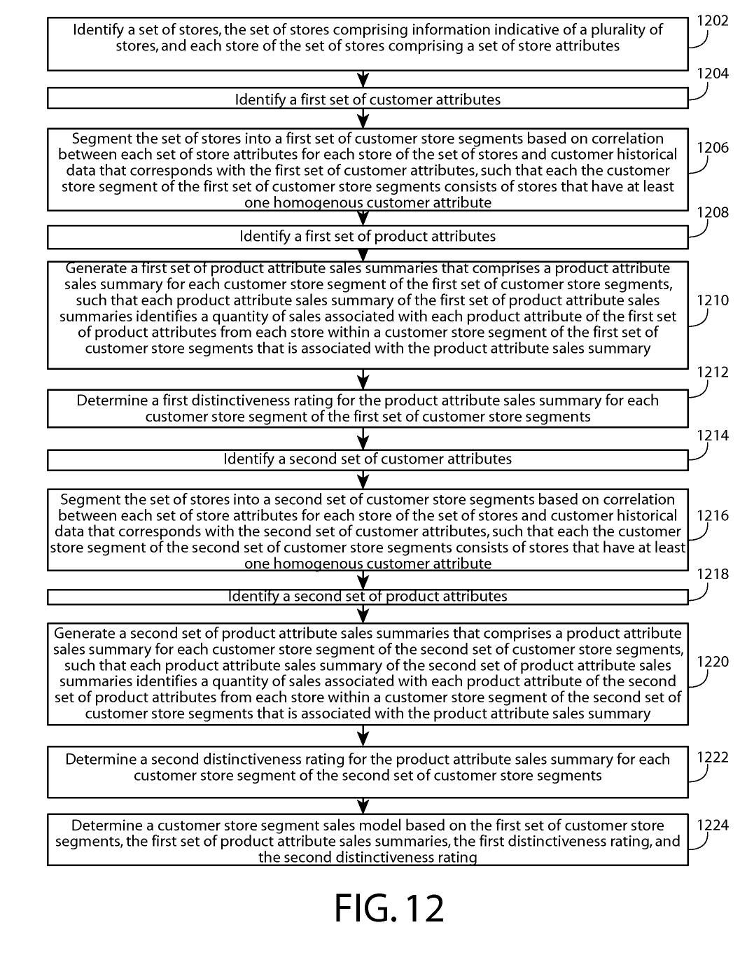

FIG. 12 is a flow diagram illustrating activities associated with determination of a customer store segment sales model according to at least one example embodiment. In at least one example embodiment, there is a set of operations that corresponds with the activities of FIG. 12. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 12.

As previously discussed, in some circumstances, it may be desirable to determine a first distinctiveness rating that is associated with a first set of customer store segments and a first set of product attribute sales summaries, and a second distinctiveness rating that is associated with a second set of customer store segments and a second set of product attribute sales summaries. In such an example, it may be desirable to determine a customer store segment sales model based, at least in part, on the first distinctiveness rating and the second distinctiveness rating.

At block 1202, the apparatus identifies a set of stores. In at least one example embodiment, the set of stores comprises information indicative of a plurality of stores, and each store of the set of stores comprises a set of store attributes. The identification, the set of stores, the plurality of stores, and the set of store attributes may be similar as described regarding FIGS. 2A-2B, FIGS. 3A-3E, FIGS. 4A-4C, and FIGS. 5A-5E.

At block 1204, the apparatus identifies a first set of customer attributes. The identification and the first set of customer attributes may be similar as described regarding FIGS. 2A-2B, FIGS. 3A-3E, FIGS. 4A-4C, and FIGS. 5A-5E.

At block 1206, the apparatus segments the set of stores into a first set of customer store segments based, at least in part, on correlation between each set of store attributes for each store of the set of stores and customer historical data that corresponds with the first set of customer attributes. In at least one example embodiment, the apparatus segments the set of stores into the first set of customer store segments such that each the customer store segment of the first set of customer store segments consists of stores that have at least one homogenous customer attribute. The segmentation, the first set of customer store segments, the customer historical data, and the homogenous customer attribute may be similar as described regarding FIGS. 2A-2B, FIGS. 3A-3E, FIGS. 4A-4C, and FIGS. 5A-5E.

At block 1208, the apparatus identifies a first set of product attributes. The identification and the first set of product attributes may be similar as described regarding FIGS. 3A-3E, FIGS. 4A-4C, and FIGS. 5A-5E.

At block 1210, the apparatus generates a first set of product attribute sales summaries that comprises a product attribute sales summary for each customer store segment of the first set of customer store segments. In at least one example embodiment, the apparatus generates the first set of product attribute sales summaries such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries. The generation, the first set of product attribute sales summaries, the product attribute sales summary, and the quantity of sales may be similar as described regarding FIGS. 3A-3E, FIGS. 4A-4C, and FIGS. 5A-5E.

At block 1212, the apparatus determines a first distinctiveness rating for the product attribute sales summary for each customer store segment of the first set of customer store segments. The determination and the first distinctiveness rating may be similar as described regarding FIGS. 3A-3E, FIGS. 4A-4C, and FIGS. 5A-5E.

At block 1214, the apparatus identifies a second set of customer attributes. The identification and the second set of customer attributes may be similar as described regarding FIGS. 2A-2B, FIGS. 3A-3E, FIGS. 4A-4C, and FIGS. 5A-5E.

At block 1216, the apparatus segments the set of stores into a second set of customer store segments based, at least in part, on correlation between each set of store attributes for each store of the set of stores and customer historical data that corresponds with the second set of customer attributes. In at least one example embodiment, the apparatus segments the set of stores into the first set of customer store segments such that each the customer store segment of the second set of customer store segments consists of stores that have at least one homogenous customer attribute. The segmentation, the second set of customer store segments, the customer historical data, and the homogenous customer attribute may be similar as described regarding FIGS. 2A-2B, FIGS. 3A-3E, FIGS. 4A-4C, and FIGS. 5A-5E.

At block 1218, the apparatus identifies a second set of product attributes. The identification and the second set of product attributes may be similar as described regarding FIGS. 3A-3E, FIGS. 4A-4C, and FIGS. 5A-5E.

At block 1220, the apparatus generates a second set of product attribute sales summaries that comprises a product attribute sales summary for each customer store segment of the first set of customer store segments. In at least one example embodiment, the apparatus generates the second set of product attribute sales summaries such that each product attribute sales summary of the second set of product attribute sales summaries identifies a quantity of sales associated with each product attribute of the second set of product attributes from each store within a customer store segment of the first set of customer store segments that is associated with the product attribute sales summary of the second set of product attribute sales summaries. The generation, the second set of product attribute sales summaries, the product attribute sales summary, and the quantity of sales may be similar as described regarding FIGS. 3A-3E, FIGS. 4A-4C, and FIGS. 5A-5E.

At block 1222, the apparatus determines a second distinctiveness rating for the product attribute sales summary for each customer store segment of the second set of customer store segments. The determination and the second distinctiveness rating may be similar as described regarding FIGS. 3A-3E, FIGS. 4A-4C, and FIGS. 5A-5E.

At block 1224, the apparatus determines a customer store segment sales model based, at least in part, on the first set of customer store segments, the first set of product attribute sales summaries, the first distinctiveness rating, and the second distinctiveness rating. The determination and the customer store segment sales model may be similar as described regarding FIGS. 3A-3E, FIGS. 4A-4C, and FIGS. 5A-5E.

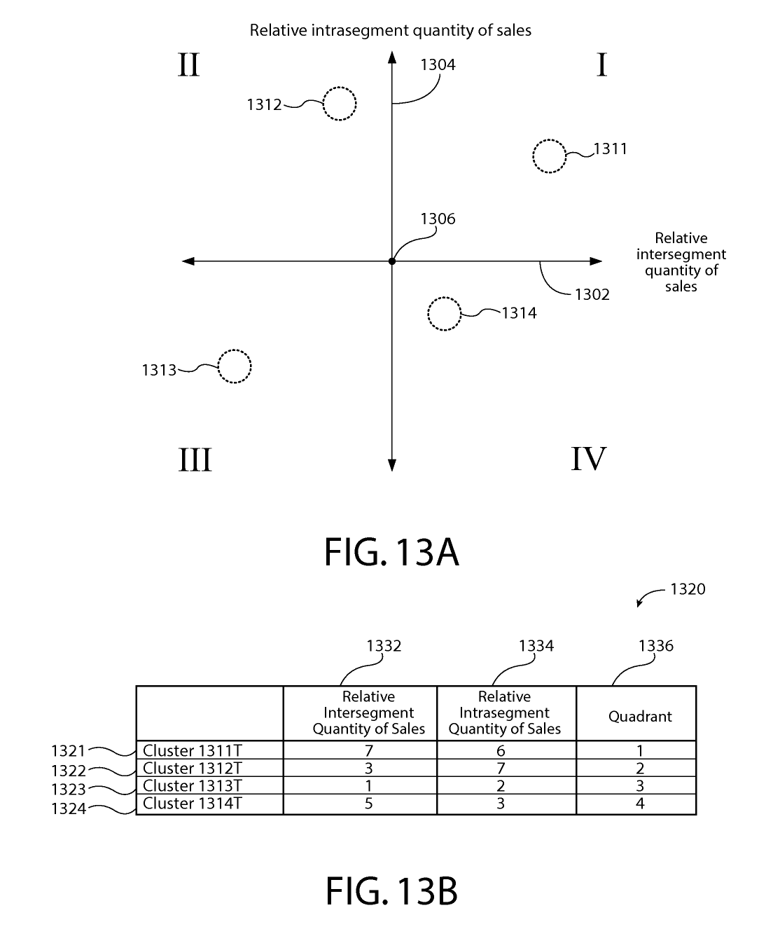

FIGS. 13A-13B are diagrams illustrating quadrant representations according to at least one example embodiment. The examples of FIGS. 13A-13B are merely examples and do not limit the scope of the claims. For example, quadrant representations may vary, axis arrangement and/or orientation may vary, origin location may vary, quadrant representation content may vary, table arrangement and/or orientation may vary, relative intrasegment quantity of sales values may vary, relative intersegment quantity of sales values may vary, and/or the like.

As described previously, in many circumstances, it may be desirable to facilitate a merchant in making informed business decisions, purchasing and assortment selections, and/or the like. As such, it may be desirable to facilitate selection of particular products by way of characteristics of the product, attributes of the product, and/or the like. For example, a merchant may desire to gain insight into possible future sales performance of a particular product, a particular type of product, and/or the like. In such an example, the merchant may desire to make a well informed decision regarding the purchase of a particular product, the distribution of products of a particular product type to specific customer store segments, and/or the like.

As such, it may be desirable to provide a merchant with an easy and intuitive manner in which to forecast future sales, direct purchasing decisions, and/or the like. For example, it may be desirable to provide the merchant with an easy and intuitive manner in which to forecast future sales, direct purchasing decisions, manage product distribution, manage assortment, and/or the like, in relation to a product candidate. A product candidate may be a product that the merchant may purchase, has purchased and intends to distribute to specific customer store segments for sale, and/or the like. In at least one example embodiment, a product candidate is a type of product. For example, the product candidate may be a specific type of shoe, such as a flat beach sandal, a platform open-toe leather dress heel, and/or the like. In at least one example embodiment, a product candidate comprises a plurality of product candidate attributes. In such an example embodiment, the product candidates attribute may be product attributes, similar as described regarding FIGS. 3A-3E, which are associated with the product candidate.

In at least one example embodiment, information indicative of a product candidate that comprises a plurality of product candidate attributes is received. In such an example embodiment, the product candidate attributes may correspond with product attributes that are comprised by a customer store segment sales model. The customer store segment sales model may comprise a set of customer store segments. For example, as discussed previously, a customer store segment sales model may be determined for a particular set of product attributes across a number of customer store segments based, at least in part, on historical sales information. In such an example, a merchant may desire to utilize the customer store segment sales model to facilitate various decision making processes relating to purchase of a particular product candidate that is associated with product candidate attributes that correspond with the set of product attributes in the customer store segment sales model.

In order to facilitate efficient utilization of such historical sales information, customer store segment sales models, and/or the like, it may be desirable to allow a merchant to quickly and easily identify a product candidate. In at least one example embodiment, the receipt of information indicative of the product candidate comprises receipt of information indicative of the product candidate from a memory, a repository, a database, a separate apparatus, and/or the like. For example, a merchant may maintain a database of product candidates, a repository of product candidate attributes, a spreadsheet of product attributes, and/or the like. In such an example, the merchant may select one or more product candidates, identify one or more product candidate attributes, pick one or more product attributes, and/or the like. In at least one example embodiment, information indicative of a product candidate attribute is received. In such an example embodiment, the plurality of product candidate attributes may comprises the product candidate attribute. For example, the receipt of information indicative of the product candidate attribute may comprise receipt of information indicative of a product candidate attribute selection input that identifies the product candidate attribute. The product candidate attribute selection input may be any input that identifies, selects, indicates, and/or the like, a product candidate attribute such that the plurality of product candidate attributes comprises the product candidate attribute.

Similarly, in at least one example embodiment, information indicative of the customer store segment sales model is received. The receipt of information indicative of the customer store segment sales model may comprise receipt of information indicative of the customer store segment sales model from a memory, a repository, a database, a separate apparatus, and/or the like. For example, a customer store segment sales model may be determined and subsequently stored in memory, uploaded to a repository, added to a database, and/or the like, such that a merchant may subsequently utilize and/or reference the customer store segment sales model for various business purposes, decision making processes, and/or the like.

As we now have a statistical framework in which to evaluate a potential future purchase of a product candidate, it may be desirable to provide a merchant with a manner in which to assign a classification to potential future sales of the product candidate. For example, the merchant may ultimately desire to receive information that indicates a purchase recommendation. The purchase recommendation may be a recommendation to purchase the product candidate, a recommendation to stock the product candidate in a customer store segment, a recommendation to avoid purchase of the product candidate, a recommendation to avoid stocking the product candidate in another customer store segment, and/or the like. Such a purchase recommendation may be a favorable purchase recommendation, a neutral purchase recommendation, a conditional purchase recommendation, an unfavorable purchase recommendation, and/or the like. In this manner, the merchant may rely upon the purchase recommendation as a recommendation that is firmly grounded in historical sales information, such that the merchant's reliance upon the recommendation constitutes valid business judgment.

In order to provide such a purchase recommendation, it may be desirable categorize and/or classify sales performance of particular customer store segments in relation to each other. For example, from a historical perspective, the merchant may desire to know whether products similar to the product candidate have performed well within one customer store segment, have performed poorly within another customer store segment, and/or the like.

In at least one example embodiment, a relative intersegment quantity of sales is determined for each customer store segment of a set of customer store segments. The relative intersegment quantity of sales may be a relative volume of sales across a set of customer store segments, or a set of clusters. For example, the relative volume of sales across a plurality of clusters may indicate the sales performance of a particular product candidate in a particular cluster in relation to the sales performance the particular product candidate relative to a different cluster, different customer store segments, and/or the like. In this manner, the relative volume of sales across customer store segments may be normalized relative to other customer store segments of the set of customer store segments. For example, a quantity of sales for the customer store segment that represents a quantity of sales that corresponds with the product candidate attributes may be identified. Such identification of the quantity of sales for the customer store segment may, for example, be by way of a customer store segment sales model. In such an example, the relative intersegment quantity of sales for the customer store segment may be determined to be the quotient of the quantity of sales for the customer store segment and the quantity of sales for the set of customer store segments. For example, as illustrated in FIG. 4A, product attribute sales summary 420 comprises quantity of sales information that is attributable to a specific product attribute for four customer store segments. Product attribute sales summary 420 may, for example, be comprised by a customer store segment sales model that is associated with the set of product attributes depicted in product attribute sales summary 420. For example, the set of product attributes depicted in product attribute sales summary 420 may correspond with product candidate attributes of a product candidate. As can be seen, the relative intersegment quantity of sales may be determined based, at least in part, on the data comprised in product attribute sales summary 420.

In some circumstances, as discussed previously, a merchant may maintain various historical sales information that pertains to historical quantity of sales, historical rates of sale, and/or the like. In such circumstances, it may be desirable to reference such historical sales information for purposes relating to determination of the relative intersegment quantity of sales for each customer store segment of the set of customer store segments. The identification of the quantity of sales for the customer store segment may comprise receipt of information indicative of the quantity of sales for the customer store segment from a memory, a repository, a database, a separate apparatus, and/or the like. In some circumstances, the historical sales information associated with the customer store segment sales model may comprise historical sales information that is attributable to individual customer store segments. Thus, it may be desirable to calculate an aggregate quantity of sales that is attributable to the set of customer store segments as a whole. In at least one example embodiment, information indicative of the quantity of sales for each customer store segment of the set of customer store segments is received from a memory, a repository, a database, a separate apparatus, and/or the like. In such an example embodiment, the quantity of sales for the set of customer store segments may be determined to be a summation of the quantity of sales for each customer store segment of the set of customer store segment. In some circumstances, the historical sales information associated with the customer store segment sales model may comprise historical sales information that is attributable to the set of customer store segments. In such circumstances, the aggregate quantity of sales information may be received directly. For example, the identification of the quantity of sales for the set of customer store segments may comprise receipt of information indicative of the quantity of sales for the set of customer store segments from a memory, a repository, a database, a separate apparatus, and/or the like.

In at least one example embodiment, a relative intrasegment quantity of sales is determined for each customer store segment of a set of customer store segments. The relative intrasegment quantity of sales may be a relative volume of sales within a particular customer store segment, cluster, and/or the like. For example, the relative volume of sales within a particular customer store segment may indicate the sales performance of a particular product candidate in relation to the sales performance of products of a similar product type within the same customer store segment. In this manner, the relative volume of sales within a particular customer store segment may be normalized relative to other customer store segments of the set of customer store segments. For example, a quantity of sales for the customer store segment that represents a quantity of sales that correspond with the product candidate attributes may be identified. Such identification of the quantity of sales for the customer store segment may, for example, be by way of a customer store segment sales model. In such an example, a quantity of sales for the set of customer store segments that represents a quantity of sales that correspond with the product candidate attributes may be identified. Similarly, such identification of the quantity of sales for the set of customer store segments may, for example, be by way of the customer store segment sales model. In such an example, the relative intrasegment quantity of sales for the customer store segment may be determined to be the quantity of sales for the customer store segment. As previously discussed, the identification of the quantity of sales for the customer store segment may comprise receipt of information indicative of the quantity of sales for the customer store segment from a memory, a repository, a database, a separate apparatus, and/or the like.

In order to facilitate a merchant in various purchase decisions, it may be desirable to classify potential future sales performance within a particular customer store segment in a manner that is easy and intuitive for the merchant. For example, the merchant may desire to view the classification of potential future sales performance of a product candidate in relation to a plurality of customer store segments in a manner that permits the merchant to quickly and intuitively make informed purchasing decisions, assortment decisions, business decisions, and/or the like. For example, such classification may be determined by way of a quadrant representation. In at least one example embodiment, a set of quadrant representations is generated such that each quadrant representation of the set of quadrant representations represents a customer store segment of the set of customer store segments. In such an example embodiment, the quadrant representation may orthogonally correlate two or more sets of data derived from historical sales information, for a customer store segment sales model, and/or the like. For example, the quadrant representation may orthogonally correlate the relative intersegment quantity of sales for the customer store segment and the relative intrasegment quantity of sales for the customer store segment. The set of quadrant representations may be comprised by a table representation, a chart representation, a graph representation, a Cartesian representation, and/or the like.

In at least one example embodiment, a purchase recommendation for a customer store segment is determined based, at least in part, on a quadrant representation that represents the customer store segment. For example, the determination of the purchase recommendation for the customer store segment may comprise determination of a quadrant of the customer store segment based, at least in part, on the quadrant representation for the customer store segment. In such an example, the determination of the purchase recommendation may be based, at least in part, on the quadrant. In order to facilitate the determination of the purchase recommendation, one or more inferences may be derived based, at least in part, on the quadrant representation. As such, the determination of the purchase recommendation for the customer store segment may be based, at least in part, on the inference. For example, two quadrant representations may indicate that the two represented customer store segments sold an equal volume of products, but that the first customer store segment sold the volume in two weeks, and the second customer store segment sold the volume in ten weeks. In such an example, various inferences may be made that allow for informed business decisions to be made regarding inventory management, purchase decisions, and/or the like. For example, the first customer store segment may have ran out of stock. In such an example, the first customer store segment may have sold a greater volume of products had the level of inventory been maintained. In another example, the first customer store segment may only sell the one product, while the second customer store segment may sell ten similar products. As such, the volume of sales attributable to the specific type of product is split amongst several similar products within the second customer store segment, but is wholly attributable to the one product within the first customer store segment. As such, a merchant may infer that the second customer store segment is over assorted, that the first customer store segment is under assorted, and/or the like.

As discussed previously, the quadrant representation may orthogonally correlate a relative intersegment quantity of sales for a customer store segment and a relative intrasegment quantity of sales for the customer store segment. In such an example, the quadrant representation may be comprised by a set of quadrant representations in a manner which allows for determination of a quadrant associated with each customer store segment by way of the quadrant representation of the customer store segment. For example, the quadrant representation of the customer store segment may indicate that the customer store segment is associated with a specific quadrant, such as quadrant one, quadrant two, quadrant three, quadrant four, and/or the like. In such an example, the quadrant may be a sector of a Cartesian coordinate system. As such, the location of a quadrant representation in a specific quadrant may indicate various characteristics associated with potential future sales performance of a product candidate, historical sales performance of products associated with a set of product attributes, and/or the like. For example, the set of quadrant representations may be comprised by a Cartesian representation. In such an example, each set of data may be associated with an axis in the Cartesian representation, and each quadrant may be associated with a region of the Cartesian representation in accordance to mathematical standards associated with quadrant placement. In such an example, an origin associated with the two axis of the Cartesian representation may be determined such that the set of quadrant representations is distributed within the Cartesian representation. For example, the two sets of data may be normalized, and the origin may indicate a zero value for both sets of data. In another example, the origin may indicate an average value for each of the two sets of data. In yet another example, the origin may be based, at least in part, on one or more threshold values determined by a merchant that is utilizing the set of quadrant representations. For example, the merchant may desire to plot the set of quadrant representations by way of a Cartesian representation in which the origin indicates a threshold relative intersegment quantity of sales, a threshold relative intrasegment quantity of sales, a threshold average rate of sale, and/or the like. As such, placement of a particular quadrant representation in a particular quadrant may indicate that the customer store segment represented by the quadrant representation satisfies the threshold, fails to satisfy the threshold, and/or the like.

As discussed previously, each quadrant representation of a set of quadrant representations may be associated with a specific quadrant. In such an example, the determination of the specific quadrant of the quadrant representation may indicate a particular purchase recommendation for the customer store segment represented by the quadrant representation. In at least one example embodiment, the quadrant is determined to be quadrant one, and the purchase recommendation is based, at least in part, on the quadrant being quadrant one. In such an example embodiment, quadrant one may be characterized by relative intersegment quantity of sales that is greater than an average of relative intersegment quantity of sales for the set of customer store segments and relative intrasegment quantity of sales that is greater than an average of relative intrasegment quantity of sales for each customer store segment of the set of customer store segments. In such an example embodiment, one or more purchase recommendations may be determined based, at least in part, on the quadrant being quadrant one. A quadrant representation that is located in quadrant one may indicate that the customer store segment represented by the quadrant representation has experienced an above average quantity of sales associated with the product candidate in relation to similar products within the customer store segment, as well as an above average quantity of sales associated with the product candidate in relation to quantity of sales attributable to other customer store segments. In this manner, the product candidate will likely sell well within the customer store segment in relation to similar products, and will likely sell well within the customer store segment in relation to sales performance of the product candidate within other customer store segments.

Quadrant one may indicate customer store segments that have the greatest potential to sell products of a particular product type, products that are associated with a particular set of product attributes, the product candidate, and/or the like. As such, in at least one example embodiment, a purchase recommendation is a favorable purchase recommendation. The determination of the favorable purchase recommendation may be based, at least in part, on the quadrant being quadrant one. The favorable purchase recommendation may be a purchase recommendation that strongly recommends purchase of the product candidate for the customer store segment.

In at least one example embodiment, the quadrant is determined to be quadrant two, and the purchase recommendation is based, at least in part, on the quadrant being quadrant two. In such an example embodiment, quadrant two may be characterized by relative intersegment quantity of sales that is less than an average of relative intersegment quantity of sales for the set of customer store segments and relative intrasegment quantity of sales that is greater than an average of relative intrasegment quantity of sales for each customer store segment of the set of customer store segments. In such an example embodiment, one or more purchase recommendations may be determined based, at least in part, on the quadrant being quadrant two. A quadrant representation that is located in quadrant two may indicate that the customer store segment represented by the quadrant representation has experienced an above average quantity of sales associated with the product candidate in relation to similar products within the customer store segment, and a below average quantity of sales associated with the product candidate in relation to quantity of sales attributable to other customer store segments. In this manner, the product candidate will likely sell well within the customer store segment in relation to similar products, but may not sell as well within the customer store segment in relation to sales performance of the product candidate within other customer store segments.

Quadrant two may indicate customer store segments within which a particular product candidate has historically accounted for a relatively large fraction of total quantity of sales of a particular product type, products that are associated with a particular set of product attributes, the product candidate, and/or the like. As such, in at least one example embodiment, a purchase recommendation is a favorable purchase recommendation. The determination of the favorable purchase recommendation may be based, at least in part, on the quadrant being quadrant two. The favorable purchase recommendation may be a purchase recommendation that mandates purchase of the product candidate for the customer store segment. For example, as the product candidate may be a top seller within the particular customer store segment, purchase of the product candidate should be mandated for the customer store segment regardless of sales performance in relation to other customer store segments.

In at least one example embodiment, the quadrant is determined to be quadrant three, and the purchase recommendation is based, at least in part, on the quadrant being quadrant three. In such an example embodiment, quadrant three may be characterized by relative intersegment quantity of sales that is less than an average of relative intersegment quantity of sales for the set of customer store segments and relative intrasegment quantity of sales that is less than an average of relative intrasegment quantity of sales for each customer store segment of the set of customer store segments. In such an example embodiment, one or more purchase recommendations may be determined based, at least in part, on the quadrant being quadrant three. A quadrant representation that is located in quadrant three may indicate that the customer store segment represented by the quadrant representation has experienced a below average quantity of sales associated with the product candidate in relation to similar products within the customer store segment, and a below average quantity of sales associated with the product candidate in relation to quantity of sales attributable to other customer store segments. In this manner, the product candidate will likely fail to sell well within the customer store segment in relation to similar products and in relation to sales performance of the product candidate within other customer store segments.

Quadrant three may indicate customer store segments within which a particular product candidate has historically accounted for a relatively small fraction of total quantity of sales of a particular product type, products that are associated with a particular set of product attributes, the product candidate, and/or the like. As such, in at least one example embodiment, a purchase recommendation is an unfavorable purchase recommendation. The determination of the unfavorable purchase recommendation may be based, at least in part, on the quadrant being quadrant three. The favorable purchase recommendation may be a purchase recommendation that recommends avoidance of purchase of the product candidate for the customer store segment. For example, as the product candidate may be a slow seller within the particular customer store segment, and purchase of the product candidate should be avoided for the customer store segment unless secondary considerations mandate purchase of the product candidate for the customer store segment. For example, if the product candidate is associated with an emerging niche market, is important to help complete cohesive presentation of a product on a shelf in a retail location, and/or the like, it may be desirable to purchase the product candidate for the customer store segment notwithstanding the unfavorable purchase recommendation.

In at least one example embodiment, the quadrant is determined to be quadrant four, and the purchase recommendation is based, at least in part, on the quadrant being quadrant four. In such an example embodiment, quadrant four may be characterized by relative intersegment quantity of sales that is greater than an average of relative intersegment quantity of sales for the set of customer store segments and relative intrasegment quantity of sales that is less than an average of relative intrasegment quantity of sales for each customer store segment of the set of customer store segments. In such an example embodiment, one or more purchase recommendations may be determined based, at least in part, on the quadrant being quadrant four. A quadrant representation that is located in quadrant four may indicate that the customer store segment represented by the quadrant representation has experienced a below average quantity of sales associated with the product candidate in relation to similar products within the customer store segment, and an above average quantity of sales associated with the product candidate in relation to quantity of sales attributable to other customer store segments. In this manner, although the product candidate may fail to sell well within the customer store segment in relation to similar products, the product candidate may nonetheless sell well within the customer store segment in relation to sales performance of the product candidate within other customer store segments. For example, the customer store segment may simply sell a very large volume of products similar to the product candidate such that even though the product candidate does not make up a large percentage of the total quantity of sales within the customer store segment, the product candidate may still sell very well compared to potential sales within other customer store segments that sell a lower volume of such products.

Quadrant four may indicate customer store segments within which a particular product candidate has historically accounted for a relatively large fraction of total quantity of sales of a particular product type, products that are associated with a particular set of product attributes, the product candidate, and/or the like, with respect to the set of customer store segments. However, in some circumstances, it may be desirable to purchase a different product candidate that will also sell well within the customer store segment. As such, in at least one example embodiment, a purchase recommendation is a conditional purchase recommendation. The determination of the conditional purchase recommendation may be based, at least in part, on the quadrant being quadrant four. The conditional purchase recommendation may be a favorable purchase recommendation subject to a non-sales criteria. The non-sales criteria may be availability of inventory space, historical inventory data, product assortment strategy, sales duration data, and/or the like. For example, in at least one example embodiment, the conditional purchase recommendation is a purchase recommendation that conditionally recommends purchase of the product candidate for the customer store segment based, at least in part, on availability of inventory space. For example, if inventory space is available within the customer store segment, it may be advisable to fill the inventory space with the product candidate since the product candidate may sell well within the customer store segment when compared to sales performance within other customer store segments of the set of customer store segments. Alternatively, if inventory space is unavailable, it may be advisable to avoid purchase of the product candidate for the customer store segment since, regardless of sales performance in relation to other customer store segments, the product candidate may fail to sell well in comparison to sales performance of similar products within the customer store segment. Thus, it may be advisable to purchase the product candidate for the other customer store segments, and to avoid purchase of the product candidate for the customer store segment.

In order to facilitate such a determination of availability of inventory space, information indicative of the availability of inventory space may be received from a memory, a repository, a database, a separate apparatus, and/or the like. For example, a customer store segment sales model may comprise information indicative of availability of inventory space, information indicative of availability of inventory space may be stored in a central inventory database, and/or the like. In such an example, such information may be received and subsequently utilized in determination of the purchase decision for the customer store segment. As such, the conditional purchase recommendation may be a favorable purchase recommendation based, at least in part, on the information indicative of the availability of inventory space.

FIG. 13A is a diagram illustrating a quadrant representations according to at least one example embodiment. As can be seen, FIG. 13A depicts a Cartesian representation of a set of quadrant representations, the set of quadrant representations comprising quadrant representations 1311, 1312, 1313, and 1314. The Cartesian representation illustrated in the example of FIG. 13A may be associated with a product candidate, the product candidate comprising a set of product candidate attributes. In such an example, a merchant may desire to utilize the Cartesian representation in order to facilitate determination of a purchase decision, an assortment decision, an inventory management decision, a business decision, and/or the like. In the example of FIG. 13A, axis 1302 indicates a relative intersegment quantity of sales, and axis 1304 indicates a relative intrasegment quantity of sales. Origin 1306 may indicate an average value of the relative intrasegment quantity of sales for the set of quadrant representations, an average value of the relative intersegment quantity of sales for the set of quadrant representations, a zero value origin for normalized relative intrasegment quantity of sales and/or normalized relative intersegment quantity of sales, and/or the like. As illustrated, quadrant representation 1311 is associated with quadrant one, quadrant representation 1312 is associated with quadrant two, quadrant representation 1313 is associated with quadrant three, and quadrant representation 1314 is associated with quadrant four.

As illustrated in the example of FIG. 13A, the customer store segment represented by quadrant representation 1311 is associated with a relative intersegment quantity of sales that is higher than a relative intersegment quantity of sales that is associated with the customer store segment representation by quadrant representation 1312, but a lower relative intrasegment quantity of sales. As such, the Cartesian representation indicates that the customer store segment represented by quadrant representation 1311 sells more products similar to the product candidate in comparison to other customer store segments, but that the customer store segment represented by quadrant representation 1312 sells more products similar to the product candidate in comparison to other sales of similar products within the same customer store segment.

In the example of FIG. 13A, the customer store segment represented by quadrant representation 1311 may be associated with a favorable purchase recommendation that strongly recommends the purchase of the product candidate for the customer store segment based, at least in part, on the location of quadrant representation 1311 in quadrant one. In the example of FIG. 13A, the customer store segment represented by quadrant representation 1312 may be associated with a favorable purchase recommendation that mandates the purchase of the product candidate for the customer store segment based, at least in part, on the location of quadrant representation 1312 in quadrant two. In the example of FIG. 13A, the customer store segment represented by quadrant representation 1313 may be associated with an unfavorable purchase recommendation that recommends avoidance of purchase of the product candidate for the customer store segment based, at least in part, on the location of quadrant representation 1313 in quadrant three. Finally, in the example of FIG. 13A, the customer store segment represented by quadrant representation 1314 may be associated with a conditional purchase recommendation that conditionally recommends the purchase of the product candidate for the customer store segment based, at least in part, on the location of quadrant representation 1314 in quadrant four.

FIG. 13B is a diagram illustrating a quadrant representations according to at least one example embodiment. As can be seen, FIG. 13B depicts table representation 1320 of a set of quadrant representations, the set of quadrant representations comprising quadrant representations 1321, 1322, 1323, and 1324. In the example of FIG. 13B, the set of quadrant representations comprised by table representation 1320 corresponds with the set of quadrant representations comprised by the Cartesian representation of FIG. 13A. For example, quadrant representation 1321 of FIG. 13B corresponds with quadrant representation 1311 of FIG. 13A, such that the values associated with quadrant representation 1321 of FIG. 13B in columns 1332, 1334, and 1336 indicate the values associated with the same in FIG. 13A. As can be seen, a quadrant associated with a particular quadrant representation may be determined absent utilization of a Cartesian representation of the set of quadrant representations that comprises the particular quadrant representation. The values comprised by table representation 1320 may fail to be normalized values. As such, the position of origin 1306 in FIG. 13A may indicate an average of the relative intersegment quantity of sales, the values of column 1332 of FIG. 13B, on the x-axis of FIG. 13A, and may indicate an average of the relative intrasegment quantity of sales, the values of column 1334 of FIG. 13B, on the y-axis of FIG. 13A.

Although the example of FIG. 13B depicts table representation 1320 as identifying quadrant representations 1321, 1322, 1323, and 1324 by way of the information comprised in columns 1332, 1334, and 1336, the actual content of table representation 1320 and the associated set of quadrant representations may vary. For example, the set of quadrant representations may be represented in a database, a data structure, a repository, a table, and/or the like, such that a quadrant may be determined for each quadrant representation and each associated customer store segment. For example, the set of quadrant representations may be a data structure that comprises the information of columns 1332 and 1334, such that a quadrant may be determined for each quadrant representation and each associated customer store segment based, at least in part, on the information of columns 1332 and 1334. In another example, the set of quadrant representations may be a data structure that comprises the information of column 1336. In such an example, the quadrant may have been predetermined, and stored in the data structure for subsequent retrieval.

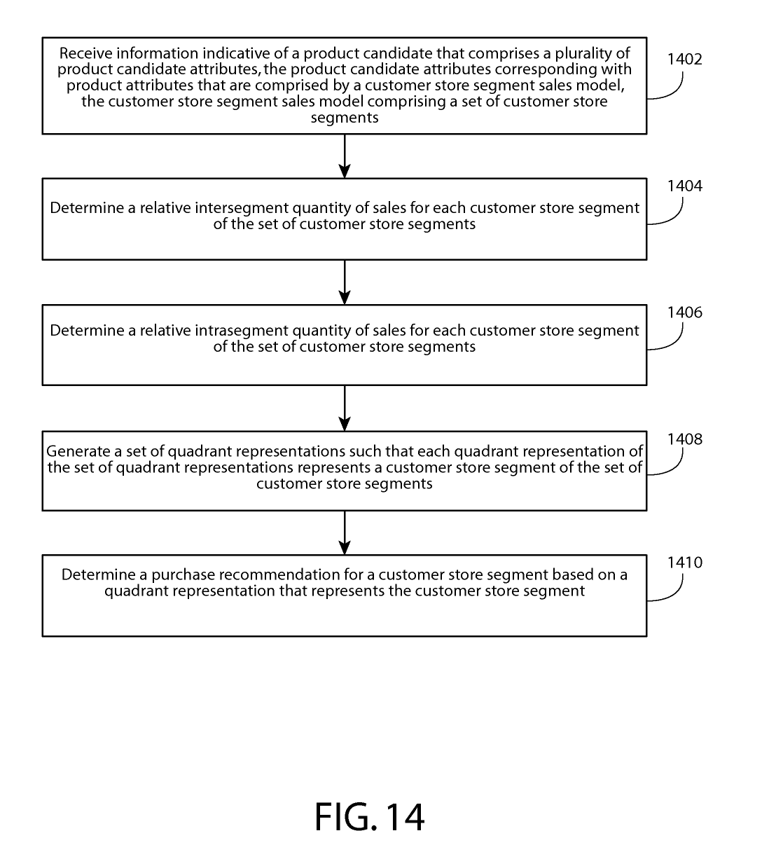

FIG. 14 is a flow diagram illustrating activities associated with identification of a plurality of clusters according to at least one example embodiment. In at least one example embodiment, there is a set of operations that corresponds with the activities of FIG. 14. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 14.

At block 1402, the apparatus receives information indicative of a product candidate that comprises a plurality of product candidate attributes. In at least one example embodiment, the product candidate attributes correspond with product attributes that are comprised by a customer store segment sales model. In at least one example embodiment, the customer store segment sales model comprises a set of customer store segments. The receipt, the product candidate, the product candidate attributes, the product attributes, the customer store segment sales model, and the set of customer store segments may be similar as described regarding FIGS. 2A-2B, FIGS. 3A-3E, FIGS. 4A-4C, FIGS. 5A-5E, FIGS. 13A-13B, FIGS. 16A-16B, and FIGS. 19A-19B.

At block 1404, the apparatus determines a relative intersegment quantity of sales for each customer store segment of the set of customer store segments. The determination and the relative intersegment quantity of sales may be similar as described regarding FIGS. 13A-13B.

At block 1406, the apparatus determines a relative intrasegment quantity of sales for each customer store segment of the set of customer store segments. The determination and the relative intrasegment quantity of sales may be similar as described regarding FIGS. 13A-13B.

At block 1408, the apparatus generates a set of quadrant representations such that each quadrant representation of the set of quadrant representations represents a customer store segment of the set of customer store segments. In at least one example embodiment, the quadrant representation orthogonally correlates the relative intersegment quantity of sales for the customer store segment and the relative intrasegment quantity of sales for the customer store segment. The generation and the set of quadrant representations may be similar as described regarding FIGS. 13A-13B, FIGS. 16A-16B, and FIGS. 19A-19B.

At block 1410, the apparatus determines a purchase recommendation for a customer store segment based, at least in part, on a quadrant representation that represents the customer store segment. The determination and the purchase recommendation may be similar as described regarding FIGS. 13A-13B.

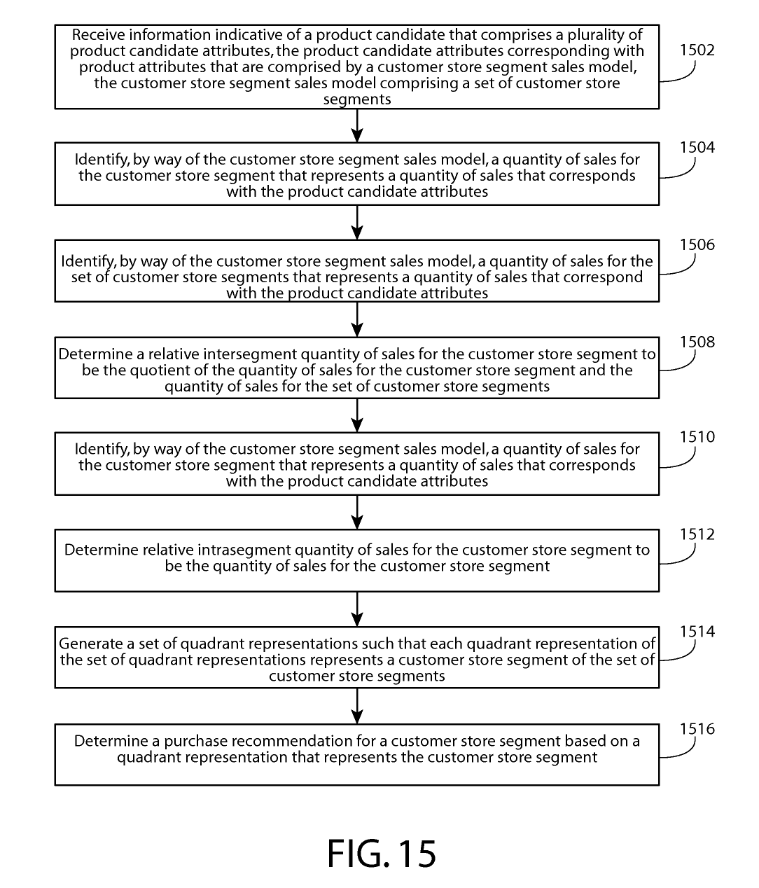

FIG. 15 is a flow diagram illustrating activities associated with identification of a plurality of clusters according to at least one example embodiment. In at least one example embodiment, there is a set of operations that corresponds with the activities of FIG. 15. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 15.

At block 1502, the apparatus receives information indicative of a product candidate that comprises a plurality of product candidate attributes. In at least one example embodiment, the product candidate attributes correspond with product attributes that are comprised by a customer store segment sales model. In at least one example embodiment, the customer store segment sales model comprises a set of customer store segments. The receipt, the product candidate, the product candidate attributes, the product attributes, the customer store segment sales model, and the set of customer store segments may be similar as described regarding FIGS. 2A-2B, FIGS. 3A-3E, FIGS. 4A-4C, FIGS. 5A-5E, FIGS. 13A-13B, FIGS. 16A-16B, and FIGS. 19A-19B.

At block 1504, the apparatus identifies, by way of the customer store segment sales model, a quantity of sales for the customer store segment that represents a quantity of sales that corresponds with the product candidate attributes. The identification, the quantity of sales for the customer store segment, and the quantity of sales that correspond with the product candidate attributes may be similar as described regarding FIGS. 3A-3E, FIGS. 4A-4C, FIGS. 5A-5E, FIGS. 13A-13B, FIGS. 16A-16B, and FIGS. 19A-19B.

At block 1506, the apparatus identifies, by way of the customer store segment sales model, a quantity of sales for the set of customer store segments that represents a quantity of sales that correspond with the product candidate attributes. The identification, the quantity of sales for the set of customer store segments, and the quantity of sales that correspond with the product candidate attributes may be similar as described regarding FIGS. 3A-3E, FIGS. 4A-4C, FIGS. 5A-5E, FIGS. 13A-13B, FIGS. 16A-16B, and FIGS. 19A-19B.

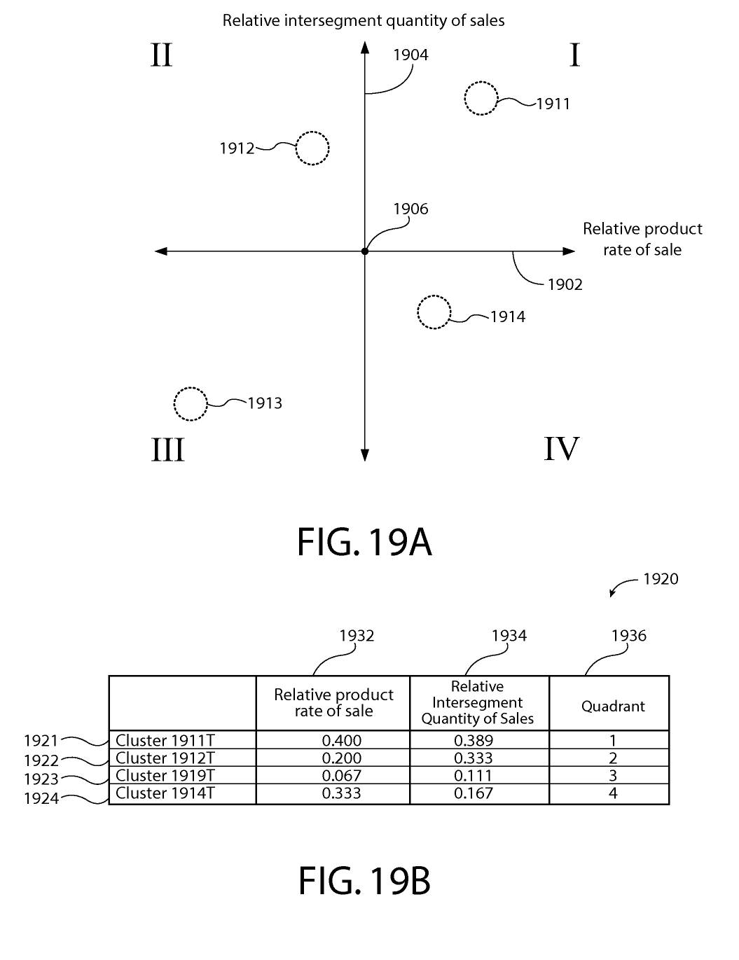

At block 1508, the apparatus determines a relative intersegment quantity of sales for the customer store segment to be the quotient of the quantity of sales for the customer store segment and the quantity of sales for the set of customer store segments. The determination and the relative intersegment quantity of sales may be similar as described regarding FIGS. 13A-13B and FIGS. 19A-19B.

At block 1510, the apparatus identifies, by way of the customer store segment sales model, a quantity of sales for the customer store segment that represents a quantity of sales that corresponds with the product candidate attributes. The identification, the quantity of sales for the set of customer store segments, and the quantity of sales that correspond with the product candidate attributes may be similar as described regarding FIGS. 3A-3E, FIGS. 4A-4C, FIGS. 5A-5E, FIGS. 13A-13B, FIGS. 16A-16B, and FIGS. 19A-19B.

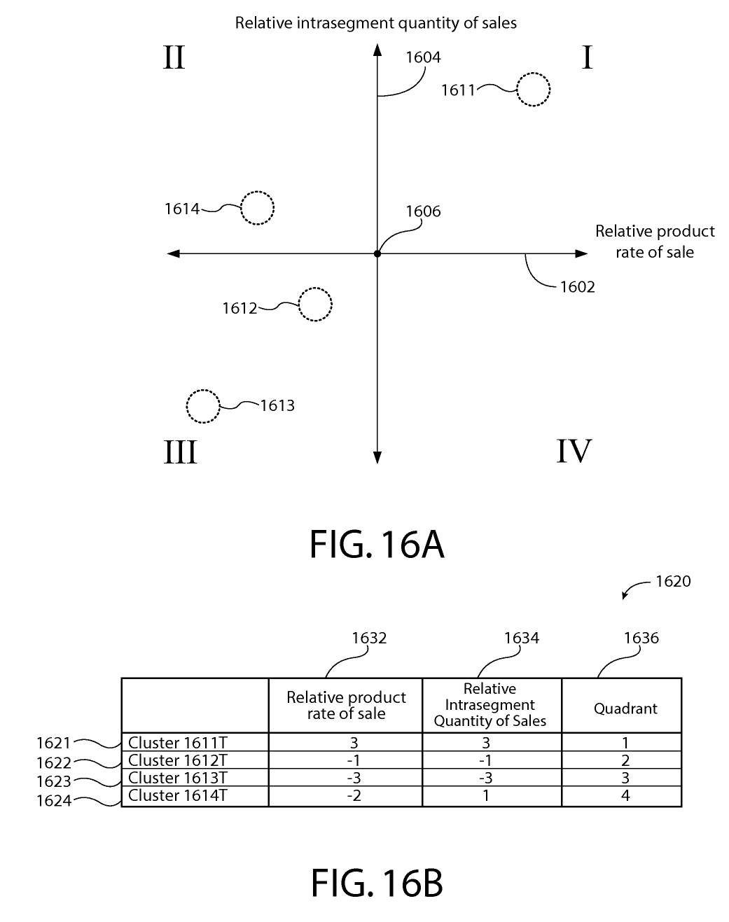

At block 1512, the apparatus determines a relative intrasegment quantity of sales for the customer store segment to be the quantity of sales for the customer store segment. The determination and the relative intrasegment quantity of sales may be similar as described regarding FIGS. 13A-13B and FIGS. 16A-16B.

At block 1514, the apparatus generates a set of quadrant representations such that each quadrant representation of the set of quadrant representations represents a customer store segment of the set of customer store segments. In at least one example embodiment, the quadrant representation orthogonally correlates the relative intersegment quantity of sales for the customer store segment and the relative intrasegment quantity of sales for the customer store segment. The generation and the set of quadrant representations may be similar as described regarding FIGS. 13A-13B, FIGS. 16A-16B, and FIGS. 19A-19B.

At block 1516, the apparatus determines a purchase recommendation for a customer store segment based, at least in part, on a quadrant representation that represents the customer store segment. The determination and the purchase recommendation may be similar as described regarding FIGS. 13A-13B.

FIGS. 16A-16B are diagrams illustrating quadrant representations according to at least one example embodiment. The examples of FIGS. 16A-16B are merely examples and do not limit the scope of the claims. For example, quadrant representations may vary, axis arrangement and/or orientation may vary, origin location may vary, quadrant representation content may vary, table arrangement and/or orientation may vary, relative product rate of sale values may vary, relative intrasegment quantity of sales values may vary, and/or the like.

As discussed previously, a quadrant representation may orthogonally correlate two or more sets of data derived from historical sales information, for a customer store segment sales model, and/or the like. In some circumstances, it may be desirable to generate a set of quadrant representations that orthogonally correlate a first set of data and a second set of data, the first set of data and a third set of data, the second set of data and the third set of data, and/or the like. In such circumstances, a set of quadrant representations may convey information regarding future sales performance of a product candidate to a merchant, and a different set of quadrant representations may convey different information regarding future sales performance of the product candidate to the merchant. Thus, in order to provide a more comprehensive outlook to the merchant, it may be desirable to generate sets of quadrant representations that correlate various types of historical sales information.

For example, it may be desirable to orthogonally correlate a relative intrasegment quantity of sales for the customer store segment and a relative product rate of sale for the customer store segment. The relative intrasegment quantity of sales for each customer store segment of the set of customer store segments may similar as may be described regarding FIGS. 13A-13B. In at least one example embodiment, the relative product rate of sale is a quantity of sales over a predetermined duration that is averaged across the assortment of products of the particular product type. In at least one example embodiment, the relative product rate of sale is a quantity of sales over a predetermined duration that is based, at least in part, on the assortment of products of the particular product type. For example, the relative product rate of sale may be a quantity of sales over a predetermined duration which is averaged across the assortment of products of the particular product type, which is calculated with respect to a number of similar products that are offered for sale an associated customer store segment, and/or the like. In such an example embodiment, the predetermined duration may be a day, a week, a month, a quarter, a season, a year, and/or the like. In some circumstances, it may be desirable to normalize a relative product rate of sale with respect to a particular customer store segment, with respect to a set of customer store segments, and/or the like. For example, the relative product rate of sale may be normalized with respect to product rate of sale information attributable to a particular customer store segment. In such an example embodiment, the relative product rate of sale may be a relative intrasegment product rate of sale. In another example, the relative product rate of sale may be normalized with respect to product rate of sale information attributable to a plurality of customer store segments that are comprised by a set of customer store segments. In such an example embodiment, the relative product rate of sale may be a relative intersegment product rate of sale. The relative intersegment product rate of sale may provide a user with quantitative information that allows for comparative analysis between rates of sale, assortment strategies, and/or the like, across the plurality of customer store segments.

In at least one example embodiment, a relative product rate of sale is determined for each customer store segment of the set of customer store segments. For example, a quantity of sales for the customer store segment that represents a quantity of sales that corresponds with the product candidate attributes may be identified. Such identification of the quantity of sales for the customer store segment may be by way of a customer store segment model, as discuss previously. The identification of the quantity of sales for the customer store segment may comprise receipt of information indicative of the quantity of sales for the customer store segment from a memory, a repository, a database, a separate apparatus, and/or the like. In such an example, a quantity of products for the customer store segment that represents a quantity of products that correspond with the product candidate attributes may be identified. Similarly, such identification of the quantity of products for the customer store segment may be by way of the customer store segment model. The identification of the quantity of products for the customer store segment may comprise receipt of information indicative of the quantity of products for the customer store segment from a memory, a repository, a database, a separate apparatus, and/or the like. In such an example, the relative product rate of sale for the customer store segment may be determined to be the quotient of the quantity of sales for the customer store segment and the quantity of products for the customer store segment. For example, a particular customer store segment may sell 100 flat beach sandals per week, and may carry an assortment of 20 flat beach sandals. In such an example, the relative product rate of sale is 5 flat beach sandals per week per product. In another example, a different customer store segment may only sell 50 flat beach sandals per week, but may only carry an assortment of 2 flat beach sandals. In such an example, the relative product rate of sale is 25 flat beach sandals per week per product.

Although the preceding examples indicate relative intrasegment product rates of sale that indicate an average rate of sale per product over a particular duration, the exact calculations utilized to determine the relative product rate of sale may vary. For example, the relative product rate of sale may be a weighted average, a median, a mode, a normalization of values, and/or the like. The relative product rate of sale may be based, at least in part, on a number of products, a subset of the assortment of products offered for sale, and/or the like.

As can be seen, it may be desirable to compare such sales data within a set of customer store segments in order to provide insight into sale performance on a per item basis in order to address any assortment concerns, to explain a lower overall quantity of sale, to justify purchase of a particular product candidate, and/or the like. As discussed previously, a set of quadrant representations may be generated such that each quadrant representation of the set of quadrant representations represents a customer store segment of the set of customer store segments. In such an example embodiment, the quadrant representation may orthogonally correlate two or more sets of data derived from historical sales information, for a customer store segment sales model, and/or the like. For example, the quadrant representation may orthogonally correlate the relative intrasegment quantity of sales for the customer store segment and the relative product rate of sale for the customer store segment. In such an example, a purchase recommendation for a customer store segment may be determined based, at least in part, on a quadrant representation that represents the customer store segment. In such an example, a quadrant of the customer store segment may be identified based, at least in part, on the quadrant representation for the customer store segment, and the determination of the purchase recommendation may be based, at least in part, on the quadrant.

The orthogonal correlation of the relative intrasegment quantity of sales for the customer store segment and the relative product rate of sale for the customer store segment may provide a merchant with additional insight into potential future sales potential of a specific product candidate. For example, such a correlation may provide insight into assortment strategies, over assortment of products similar to the product candidate, under assortment of product similar to the product candidate, inventory management issues, and/or the like. As such, the quadrant representation of the customer store segment may indicate that the customer store segment is associated with a specific quadrant, such as quadrant one, quadrant two, quadrant three, quadrant four, and/or the like. The location of a quadrant representation in a specific quadrant may indicate various characteristics associated with potential future sales performance of a product candidate, historical sales performance of products associated with a set of product attributes, and/or the like.

As discussed previously, each quadrant representation of a set of quadrant representations may be associated with a specific quadrant. In such an example, the determination of the specific quadrant of the quadrant representation may indicate a particular purchase recommendation for the customer store segment represented by the quadrant representation. In at least one example embodiment, the quadrant is determined to be quadrant one, and the purchase recommendation is based, at least in part, on the quadrant being quadrant one. In such an example embodiment, quadrant one may be characterized by relative intrasegment quantity of sales that is greater than an average of relative intrasegment quantity of sales for the set of customer store segments, and relative product rate of sale that is greater than an average of relative product rate of sale for each customer store segment of the set of customer store segments. In such an example embodiment, one or more purchase recommendations may be determined based, at least in part, on the quadrant being quadrant one. A quadrant representation that is located in quadrant one may indicate that the customer store segment represented by the quadrant representation has experienced an above average quantity of sales associated with the product candidate in relation to quantity of sales attributable to similar products within the customer store segment, as well as an above average quantity of sales on a per product basis. In this manner, the product candidate may sell well within the customer store segment in relation to similar products within the customer store segment, and may sell well on a per product basis in comparison with other customer store segments.

Quadrant one may indicate customer store segments that have the greatest potential to sell products of a particular product type, products that are associated with a particular set of product attributes, the product candidate, and/or the like. As such, in at least one example embodiment, a purchase recommendation is a favorable purchase recommendation. The determination of the favorable purchase recommendation may be based, at least in part, on the quadrant being quadrant one. The favorable purchase recommendation may be a purchase recommendation that strongly recommends purchase of the product candidate for the customer store segment.

In at least one example embodiment, the quadrant is determined to be quadrant two, and the purchase recommendation is based, at least in part, on the quadrant being quadrant two. In such an example embodiment, quadrant two may be characterized by relative intrasegment quantity of sales that is greater than an average of relative intrasegment quantity of sales for the set of customer store segments and relative product rate of sale that is less than an average of relative product rate of sale for each customer store segment of the set of customer store segments. In such an example embodiment, one or more purchase recommendations may be determined based, at least in part, on the quadrant being quadrant two. A quadrant representation that is located in quadrant two may indicate that, within the customer store segment represented by the quadrant representation, products similar to the product candidate have experienced an above average quantity of sales, and a below average quantity of sales on a per product basis. In this manner, the product candidate will likely sell well within the customer store segment in relation to other products within the customer store segment, but may fail to sell well on a per product basis.

Quadrant two may indicate customer store segments that have a good potential to sell products of a particular product type, products that are associated with a particular set of product attributes, the product candidate, and/or the like. As such, in at least one example embodiment, a purchase recommendation is a favorable purchase recommendation. The determination of the favorable purchase recommendation may be based, at least in part, on the quadrant being quadrant two. The favorable purchase recommendation may be a purchase recommendation that mandates the purchase of the product candidate for the customer store segment. For example, as the product candidate may be a top seller within the particular customer store segment, purchase of the product candidate may be mandated for the customer store segment regardless of per product sales performance in relation to other customer store segments. In such an example, quadrant two may indicate that the product candidate remains a good fit for the particular customer store segment, as the product candidate may be attributed with a large percentage of product sales within the customer store segment, notwithstanding the below average relative product rate of sale.

In at least one example embodiment, the quadrant is determined to be quadrant three, and the purchase recommendation is based, at least in part, on the quadrant being quadrant three. In such an example embodiment, quadrant three may be characterized by relative intrasegment quantity of sales that is less than an average of relative intrasegment quantity of sales for the set of customer store segments and relative product rate of sale that is less than an average of relative product rate of sale for each customer store segment of the set of customer store segments. In such an example embodiment, one or more purchase recommendations may be determined based, at least in part, on the quadrant being quadrant three. A quadrant representation that is located in quadrant three may indicate that, within the customer store segment represented by the quadrant representation, products similar to the product candidate have experienced a below average quantity of sales, and a below average quantity of sales on a per product basis. In this manner, the product candidate may fail to sell well within the customer store segment in relation to other products within the customer store segment, and may also fail to sell well on a per product basis.

Quadrant three may indicate customer store segments within which a particular product candidate has historically accounted for a relatively small fraction of total quantity of sales of a particular product type, products that are associated with a particular set of product attributes, the product candidate, and/or the like. As such, in at least one example embodiment, a purchase recommendation is an unfavorable purchase recommendation. The determination of the unfavorable purchase recommendation may be based, at least in part, on the quadrant being quadrant three. The favorable purchase recommendation may be a purchase recommendation that recommends avoidance of purchase of the product candidate for the customer store segment. For example, as the product candidate may be a slow seller in comparison with other products within the customer store segment, and purchase of the product candidate should be avoided for the customer store segment unless secondary considerations mandate purchase of the product candidate for the customer store segment. For example, if the product candidate is associated with an emerging niche market, is important to help complete cohesive presentation of a product on a shelf in a retail location, and/or the like, it may be desirable to purchase the product candidate for the customer store segment notwithstanding the unfavorable purchase recommendation.

In at least one example embodiment, the quadrant is determined to be quadrant four, and the purchase recommendation is based, at least in part, on the quadrant being quadrant four. In such an example embodiment, quadrant four may be characterized by relative intrasegment quantity of sales that is less than an average of relative intrasegment quantity of sales for the set of customer store segments and relative product rate of sale that is greater than an average of relative product rate of sale for each customer store segment of the set of customer store segments. In such an example embodiment, one or more purchase recommendations may be determined based, at least in part, on the quadrant being quadrant four. A quadrant representation that is located in quadrant four may indicate that, within the customer store segment represented by the quadrant representation, products similar to the product candidate have experienced a below average quantity of sales, but an above average quantity of sales on a per product basis. In this manner, the product candidate may fail to sell well within the customer store segment in relation to other products within the customer store segment, but may sell well on a per product basis.

Quadrant four may indicate customer store segments that have a moderate potential to sell products of a particular product type, products that are associated with a particular set of product attributes, the product candidate, and/or the like. As such, in at least one example embodiment, a purchase recommendation is a conditional purchase recommendation. The determination of the conditional purchase recommendation may be based, at least in part, on the quadrant being quadrant four. The conditional purchase recommendation may be a favorable purchase recommendation subject to a non-sales criteria. The non-sales criteria may be availability of inventory space, historical inventory data, product assortment strategy, sales duration data, and/or the like. For example, in at least one example embodiment, the conditional purchase recommendation is a purchase recommendation that conditionally recommends purchase of the product candidate for the customer store segment based, at least in part, on availability of inventory space. For example, if inventory space is available within the customer store segment, it may be advisable to fill the inventory space with the product candidate since the product candidate will sell well within the customer store segment when compared to sales performance of similar products within the same customer store segment. Alternatively, if inventory space is unavailable, it may be advisable to avoid purchase of the product candidate or the customer store segment since, regardless of sales performance within the customer store segment, the product candidate may fail to sell well in comparison to sales performance of the product candidate at other customer store segments. Thus, it may be advisable to purchase the product candidate for the other customer store segments, and to avoid purchase of the product candidate for the customer store segment.

FIG. 16A is a diagram illustrating a quadrant representations according to at least one example embodiment. As can be seen, FIG. 16A depicts a Cartesian representation of a set of quadrant representations, the set of quadrant representations comprising quadrant representations 1611, 1612, 1613, and 1614. The Cartesian representation illustrated in the example of FIG. 16A may be associated with a product candidate, the product candidate comprising a set of product candidate attributes. In such an example, a merchant may desire to utilize the Cartesian representation in order to facilitate determination of a purchase decision, an assortment decision, an inventory management decision, a business decision, and/or the like. In the example of FIG. 16A, axis 1602, the x-axis, indicates a relative product rate of sale, and axis 1604, the y-axis, indicates a relative intrasegment quantity of sales. Origin 1606 may indicate an average value of the relative product rate of sale for the set of quadrant representations, an average value of the relative intrasegment quantity of sales for the set of quadrant representations, a zero value origin for normalized relative product rate of sale and/or normalized relative intrasegment quantity of sales, and/or the like. As illustrated, quadrant representation 1611 is associated with quadrant one, quadrant representation 1612 is associated with quadrant three, quadrant representation 1613 is associated with quadrant three, and quadrant representation 1614 is associated with quadrant two.

As illustrated in the example of FIG. 16A, the customer store segment represented by quadrant representation 1614 is associated with a relative intrasegment quantity of sales that is higher than a relative intrasegment quantity of sales that is associated with the customer store segment representation by quadrant representation 1612, but a lower relative product rate of sale. As such, the Cartesian representation indicates that the product candidate may result in a larger percentage of sales of similar products within the customer store segment represented by quadrant representation 1614 in comparison the customer store segment represented by quadrant representation 1612, but that the customer store segment represented by quadrant representation 1612 sells more on a per product basis. As such, a merchant may utilize such a comparison in order to efficiently and rationally make informed purchase decisions, assortment decisions, and/or the like.

In the example of FIG. 16A, the customer store segment represented by quadrant representation 1611 may be associated with a favorable purchase recommendation that strongly recommends the purchase of the product candidate for the customer store segment based, at least in part, on the location of quadrant representation 1611 in quadrant one. In the example of FIG. 16A, the customer store segment represented by quadrant representation 1612 may be associated with an unfavorable purchase recommendation that recommends avoidance of purchase of the product candidate for the customer store segment based, at least in part, on the location of quadrant representation 1612 in quadrant three. In the example of FIG. 16A, the customer store segment represented by quadrant representation 1613 may be associated with an unfavorable purchase recommendation that recommends avoidance of purchase of the product candidate for the customer store segment based, at least in part, on the location of quadrant representation 1613 in quadrant three. Finally, in the example of FIG. 16A, the customer store segment represented by quadrant representation 1614 may be associated with a favorable purchase recommendation that mandates purchase of the product candidate for the customer store segment based, at least in part, on the location of quadrant representation 1614 in quadrant two.

FIG. 16B is a diagram illustrating a quadrant representations according to at least one example embodiment. As can be seen, FIG. 16B depicts table representation 1620 of a set of quadrant representations, the set of quadrant representations comprising quadrant representations 1621, 1622, 1623, and 1624. In the example of FIG. 16B, the set of quadrant representations comprised by table representation 1620 corresponds with the set of quadrant representations comprised by the Cartesian representation of FIG. 16A. For example, quadrant representation 1621 of FIG. 16B corresponds with quadrant representation 1611 of FIG. 16A, such that the values associated with quadrant representation 1621 of FIG. 16B in columns 1632, 1634, and 1636 indicate the values associated with the same in FIG. 16A. As can be seen, a quadrant associated with a particular quadrant representation may be determined absent utilization of a Cartesian representation of the set of quadrant representations that comprises the particular quadrant representation. The values comprised by table representation 1620 may be normalized values. As such, the position of origin 1606 in FIG. 16A may indicate a zero value, or an average of the normalized data, of the relative product rate of sale, the values of column 1632 of FIG. 16B, on the x-axis of FIG. 16A, and may indicate a zero value, or an average of the normalized data, of the relative intrasegment quantity of sales, the values of column 1634 of FIG. 16B, on the y-axis of FIG. 16A.

Although the example of FIG. 16B depicts table representation 1620 as identifying quadrant representations 1621, 1622, 1623, and 1624 by way of the information comprised in columns 1632, 1634, and 1636, the actual content of table representation 1620 and the associated set of quadrant representations may vary. For example, the set of quadrant representations may be represented in a database, a data structure, a repository, a table, and/or the like, such that a quadrant may be determined for each quadrant representation and each associated customer store segment. For example, the set of quadrant representations may be a data structure that comprises the information of columns 1632 and 1634, such that a quadrant may be determined for each quadrant representation and each associated customer store segment based, at least in part, on the information of columns 1632 and 1634. In another example, the set of quadrant representations may be a data structure that comprises the information of column 1636. In such an example, the quadrant may have been predetermined, and stored in the data structure for subsequent retrieval.

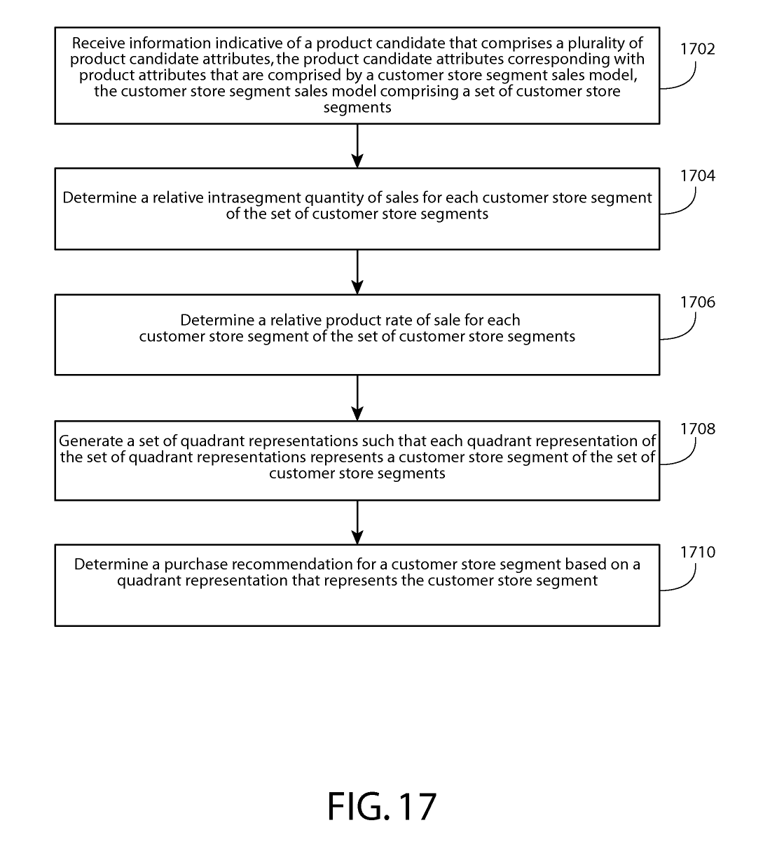

FIG. 17 is a flow diagram illustrating activities associated with identification of a plurality of clusters according to at least one example embodiment. In at least one example embodiment, there is a set of operations that corresponds with the activities of FIG. 17. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 17.

At block 1702, the apparatus receives information indicative of a product candidate that comprises a plurality of product candidate attributes. In at least one example embodiment, the product candidate attributes correspond with product attributes that are comprised by a customer store segment sales model. In at least one example embodiment, the customer store segment sales model comprises a set of customer store segments. The receipt, the product candidate, the product candidate attributes, the product attributes, the customer store segment sales model, and the set of customer store segments may be similar as described regarding FIGS. 2A-2B, FIGS. 3A-3E, FIGS. 4A-4C, FIGS. 5A-5E, FIGS. 13A-13B, FIGS. 16A-16B, and FIGS. 19A-19B.

At block 1704, the apparatus determines a relative intrasegment quantity of sales for each customer store segment of the set of customer store segments. The determination and the relative intrasegment quantity of sales may be similar as described regarding FIGS. 13A-13B and FIGS. 16A-16B.

At block 1706, the apparatus determines a relative product rate of sale for each customer store segment of the set of customer store segments. The determination and the relative intrasegment quantity of sales may be similar as described regarding FIGS. 16A-16B.

At block 1708, the apparatus generates a set of quadrant representations such that each quadrant representation of the set of quadrant representations represents a customer store segment of the set of customer store segments. In at least one example embodiment, the quadrant representation orthogonally correlates the relative intrasegment quantity of sales for the customer store segment and the relative product rate of sale for the customer store segment. The generation and the set of quadrant representations may be similar as described regarding FIGS. 13A-13B, FIGS. 16A-16B, and FIGS. 19A-19B.

At block 1710, the apparatus determines a purchase recommendation for a customer store segment based, at least in part, on a quadrant representation that represents the customer store segment. The determination and the purchase recommendation may be similar as described regarding FIGS. 16A-16B.

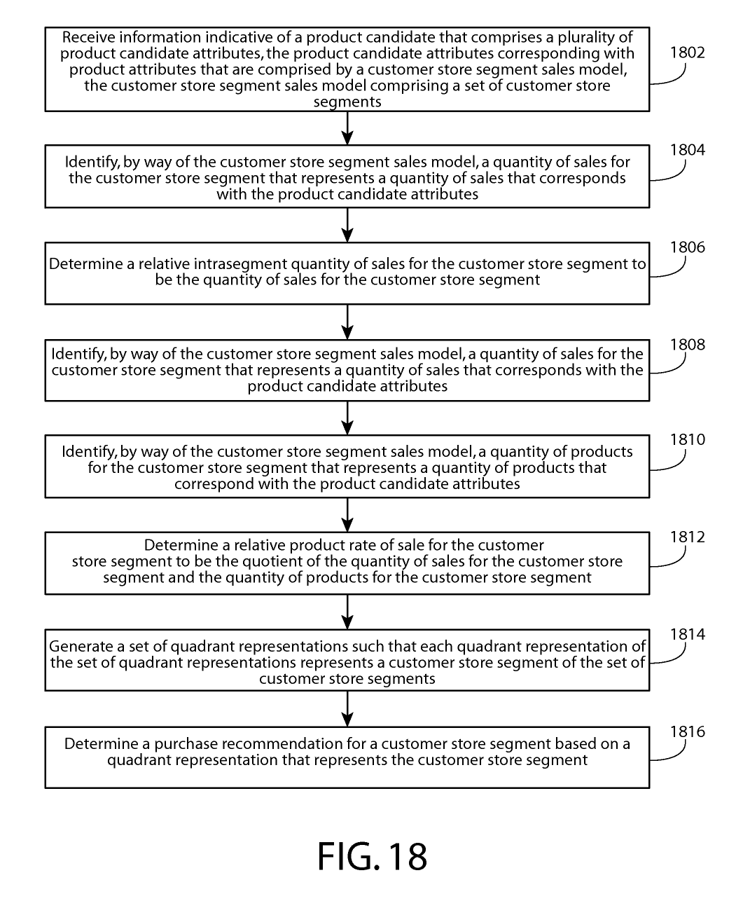

FIG. 18 is a flow diagram illustrating activities associated with identification of a plurality of clusters according to at least one example embodiment. In at least one example embodiment, there is a set of operations that corresponds with the activities of FIG. 18. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 18.

At block 1802, the apparatus receives information indicative of a product candidate that comprises a plurality of product candidate attributes. In at least one example embodiment, the product candidate attributes correspond with product attributes that are comprised by a customer store segment sales model. In at least one example embodiment, the customer store segment sales model comprises a set of customer store segments. The receipt, the product candidate, the product candidate attributes, the product attributes, the customer store segment sales model, and the set of customer store segments may be similar as described regarding FIGS. 2A-2B, FIGS. 3A-3E, FIGS. 4A-4C, FIGS. 5A-5E, FIGS. 13A-13B, FIGS. 16A-16B, and FIGS. 19A-19B.

At block 1804, the apparatus identifies, by way of the customer store segment sales model, a quantity of sales for the customer store segment that represents a quantity of sales that corresponds with the product candidate attributes. The identification, the quantity of sales for the set of customer store segments, and the quantity of sales that correspond with the product candidate attributes may be similar as described regarding FIGS. 3A-3E, FIGS. 4A-4C, FIGS. 5A-5E, FIGS. 13A-13B, FIGS. 16A-16B, and FIGS. 19A-19B.

At block 1806, the apparatus determines a relative intrasegment quantity of sales for the customer store segment to be the quantity of sales for the customer store segment. The determination and the relative intrasegment quantity of sales may be similar as described regarding FIGS. 13A-13B and FIGS. 16A-16B.

At block 1808, the apparatus identifies, by way of the customer store segment sales model, a quantity of sales for the customer store segment that represents a quantity of sales that corresponds with the product candidate attributes. The identification, the quantity of sales for the set of customer store segments, and the quantity of sales that correspond with the product candidate attributes may be similar as described regarding FIGS. 3A-3E, FIGS. 4A-4C, FIGS. 5A-5E, FIGS. 13A-13B, FIGS. 16A-16B, and FIGS. 19A-19B.

At block 1810, the apparatus identifies, by way of the customer store segment sales model, a quantity of products for the customer store segment that represents a quantity of products that correspond with the product candidate attributes. The identification, the quantity of products for the set of customer store segments, and the quantity of products that correspond with the product candidate attributes may be similar as described regarding FIGS. 3A-3E, FIGS. 4A-4C, FIGS. 5A-5E, FIGS. 13A-13B, FIGS. 16A-16B, and FIGS. 19A-19B.

At block 1812, the apparatus determines a relative product rate of sale for the customer store segment to be the quotient of the quantity of sales for the customer store segment and the quantity of products for the customer store segment. The determination and the relative product rate of sale may be similar as described regarding FIGS. 16A-16B and FIGS. 19A-19B.

At block 1814, the apparatus generates a set of quadrant representations such that each quadrant representation of the set of quadrant representations represents a customer store segment of the set of customer store segments. In at least one example embodiment, the quadrant representation orthogonally correlates the relative intrasegment quantity of sales for the customer store segment and the relative product rate of sale for the customer store segment. The generation and the set of quadrant representations may be similar as described regarding FIGS. 13A-13B, FIGS. 16A-16B, and FIGS. 19A-19B.

At block 1816, the apparatus determines a purchase recommendation for a customer store segment based, at least in part, on a quadrant representation that represents the customer store segment. The determination and the purchase recommendation may be similar as described regarding FIGS. 16A-16B.

FIGS. 19A-19B are diagrams illustrating quadrant representations according to at least one example embodiment. The examples of FIGS. 19A-19B are merely examples and do not limit the scope of the claims. For example, quadrant representations may vary, axis arrangement and/or orientation may vary, origin location may vary, quadrant representation content may vary, table arrangement and/or orientation may vary, relative product rate of sale values may vary, relative intersegment quantity of sales values may vary, and/or the like.

As discussed previously, a quadrant representation may orthogonally correlate two or more sets of data derived from historical sales information, for a customer store segment sales model, and/or the like. In some circumstances, it may be desirable to generate a set of quadrant representations that orthogonally correlate a first set of data and a second set of data, the first set of data and a third set of data, the second set of data and the third set of data, and/or the like. In such circumstances, a set of quadrant representations may convey information regarding future sales performance of a product candidate to a merchant, and a different set of quadrant representations may convey different information regarding future sales performance of the product candidate to the merchant. Thus, in order to provide a more comprehensive outlook to the merchant, it may be desirable to generate sets of quadrant representations that correlate various types of historical sales information.

For example, it may be desirable to orthogonally correlate a relative intersegment quantity of sales for the customer store segment and a relative product rate of sale for the customer store segment. The relative intersegment quantity of sales for each customer store segment of the set of customer store segments may similar as may be described regarding FIGS. 13A-13B. The relative product rate of sale for each customer store segment of the set of customer store segments may similar as may be described regarding FIGS. 16A-16B.

In some circumstances, it may be desirable to compare such sales data within a set of customer store segments in order to provide insight into sale performance on a per item basis in order to address any assortment concerns, to explain a lower overall quantity of sale, to justify purchase of a particular product candidate, and/or the like. As discussed previously, a set of quadrant representations may be generated such that each quadrant representation of the set of quadrant representations represents a customer store segment of the set of customer store segments. In such an example embodiment, the quadrant representation may orthogonally correlate two or more sets of data derived from historical sales information, for a customer store segment sales model, and/or the like. For example, the quadrant representation may orthogonally correlate the relative intersegment quantity of sales for the customer store segment and the relative product rate of sale for the customer store segment. In such an example, a purchase recommendation for a customer store segment may be determined based, at least in part, on a quadrant representation that represents the customer store segment. In such an example, a quadrant of the customer store segment may be identified based, at least in part, on the quadrant representation for the customer store segment, and the determination of the purchase recommendation may be based, at least in part, on the quadrant.

The orthogonal correlation of the relative intersegment quantity of sales for the customer store segment and the relative product rate of sale for the customer store segment may provide a merchant with additional insight into potential future sales potential of a specific product candidate. For example, such a correlation may provide insight into assortment strategies, over assortment of products similar to the product candidate, under assortment of product similar to the product candidate, inventory management issues, and/or the like. As such, the quadrant representation of the customer store segment may indicate that the customer store segment is associated with a specific quadrant, such as quadrant one, quadrant two, quadrant three, quadrant four, and/or the like. The location of a quadrant representation in a specific quadrant may indicate various characteristics associated with potential future sales performance of a product candidate, historical sales performance of products associated with a set of product attributes, and/or the like.

As discussed previously, each quadrant representation of a set of quadrant representations may be associated with a specific quadrant. In such an example, the determination of the specific quadrant of the quadrant representation may indicate a particular purchase recommendation for the customer store segment represented by the quadrant representation. In at least one example embodiment, the quadrant is determined to be quadrant one, and the purchase recommendation is based, at least in part, on the quadrant being quadrant one. In such an example embodiment, quadrant one may be characterized by relative intersegment quantity of sales that is greater than an average of relative intrasegment quantity of sales for the set of customer store segments and relative product rate of sale that is greater than an average of relative product rate of sale for each customer store segment of the set of customer store segments. In such an example embodiment, one or more purchase recommendations may be determined based, at least in part, on the quadrant being quadrant one. A quadrant representation that is located in quadrant one may indicate that the customer store segment represented by the quadrant representation has experienced an above average quantity of sales associated with the product candidate in relation to quantity of sales attributable to other customer store segments, as well as an above average quantity of sales on a per product basis. In this manner, the product candidate may sell well within the customer store segment in relation quantity of sales attributable to other customer store segments, and may sell well within the customer store segment on a per product basis in relation to per product sales performance of the product candidate within other customer store segments.

Quadrant one may indicate customer store segments that have the greatest potential to sell products of a particular product type, products that are associated with a particular set of product attributes, the product candidate, and/or the like. As such, in at least one example embodiment, a purchase recommendation is a favorable purchase recommendation. The determination of the favorable purchase recommendation may be based, at least in part, on the quadrant being quadrant one. The favorable purchase recommendation may be a purchase recommendation that strongly recommends purchase of the product candidate for the customer store segment.

In at least one example embodiment, the quadrant is determined to be quadrant two, and the purchase recommendation is based, at least in part, on the quadrant being quadrant two. In such an example embodiment, quadrant two may be characterized by relative intersegment quantity of sales that is greater than an average of relative intersegment quantity of sales for the set of customer store segments and relative product rate of sale that is less than an average of relative product rate of sale for each customer store segment of the set of customer store segments. In such an example embodiment, one or more purchase recommendations may be determined based, at least in part, on the quadrant being quadrant two. A quadrant representation that is located in quadrant two may indicate that the customer store segment represented by the quadrant representation has experienced an above average quantity of sales associated with the product candidate in relation to quantity of sales attributable to other customer store segments, and a below average quantity of sales on a per product basis. In this manner, the product candidate will likely sell well within the customer store segment in relation to other customer store segments, and may fail to sell well on a per product basis.

Quadrant two may indicate customer store segments that have a moderate potential to sell products of a particular product type, products that are associated with a particular set of product attributes, the product candidate, and/or the like. As such, in at least one example embodiment, a purchase recommendation is a favorable purchase recommendation. The determination of the favorable purchase recommendation may be based, at least in part, on the quadrant being quadrant two. The favorable purchase recommendation may be a purchase recommendation that neutrally recommends purchase of the product candidate for the customer store segment. A customer store segment that is associated with quadrant two in such an orthogonal correlation may indicate that the customer store segment is over assorted in regards to products that are similar to the product candidate. For example, a particular customer store segment may sell 100 flat beach sandals per week, and may carry an assortment of 4 flat beach sandals, resulting in a relative product rate of sale of 25 flat beach sandals per week per product. A different customer store segment may also sell 100 flat beach sandals per week, but may only carry an assortment of 10 flat beach sandals, resulting in a relative product rate of sale of 10 flat beach sandals per week per product. As can be seen, although the two customer store segments sell an identical number of flat beach sandals, the different customer store segment may be over assorted, or may carry too many products that are of the flat beach sandal variety. Since it is apparent that the flat beach sandals sell well within the customer store segment in comparison to other customer store segments, the purchase recommendation may be a neutral recommendation to purchase the product candidate. If the merchant decides to avoid purchase of the product candidate due to assortment concerns, the other products may compensate in relation to the quantity of sales for all flat beach sandals.

In at least one example embodiment, the quadrant is determined to be quadrant three, and the purchase recommendation is based, at least in part, on the quadrant being quadrant three. In such an example embodiment, quadrant three may be characterized by relative intersegment quantity of sales that is less than an average of relative intersegment quantity of sales for the set of customer store segments and relative product rate of sale that is less than an average of relative product rate of sale for each customer store segment of the set of customer store segments. In such an example embodiment, one or more purchase recommendations may be determined based, at least in part, on the quadrant being quadrant three. A quadrant representation that is located in quadrant three may indicate that the customer store segment represented by the quadrant representation has experienced a below average quantity of sales associated with the product candidate in relation to quantity of sales attributable to other customer store segments, and a below average per product quantity of sales associated with the product candidate in relation to per product quantity of sales attributable to other customer store segments. In this manner, the product candidate will likely fail to sell well within the customer store segment in relation to sales performance of the product candidate within other customer store segments.

Quadrant three may indicate customer store segments within which a particular product candidate has historically accounted for a relatively small fraction of total quantity of sales of a particular product type, products that are associated with a particular set of product attributes, the product candidate, and/or the like. As such, in at least one example embodiment, a purchase recommendation is an unfavorable purchase recommendation. The determination of the unfavorable purchase recommendation may be based, at least in part, on the quadrant being quadrant three. The favorable purchase recommendation may be a purchase recommendation that recommends avoidance of purchase of the product candidate for the customer store segment. For example, as the product candidate may be a slow seller in comparison with other customer store segments, and purchase of the product candidate should be avoided for the customer store segment unless secondary considerations mandate purchase of the product candidate for the customer store segment. For example, if the product candidate is associated with an emerging niche market, is important to help complete cohesive presentation of a product on a shelf in a retail location, and/or the like, it may be desirable to purchase the product candidate for the customer store segment notwithstanding the unfavorable purchase recommendation.

In at least one example embodiment, the quadrant is determined to be quadrant four, and the purchase recommendation is based, at least in part, on the quadrant being quadrant four. In such an example embodiment, quadrant four may be characterized by relative intersegment quantity of sales that is less than an average of relative intersegment quantity of sales for the set of customer store segments and relative product rate of sale that is greater than an average of relative product rate of sale for each customer store segment of the set of customer store segments. In such an example embodiment, one or more purchase recommendations may be determined based, at least in part, on the quadrant being quadrant four. A quadrant representation that is located in quadrant four may indicate that the customer store segment represented by the quadrant representation has experienced a below average quantity of sales associated with the product candidate in relation to quantity of sales attributable to other customer store segments, and an above average quantity of sales on a per product basis. In this manner, the product candidate may fail to sell well within the customer store segment in relation to other customer store segments, and may sell well on a per product basis in relation to other customer store segments.

Quadrant four may indicate customer store segments that have a good potential to sell products of a particular product type, products that are associated with a particular set of product attributes, the product candidate, and/or the like. As such, in at least one example embodiment, a purchase recommendation is a favorable purchase recommendation. The determination of the favorable purchase recommendation may be based, at least in part, on the quadrant being quadrant four. The favorable purchase recommendation may be a purchase recommendation that mildly recommends purchase of the product candidate for the customer store segment. A customer store segment that is associated with quadrant four in such an orthogonal correlation may indicate that the customer store segment is under assorted in regards to products that are similar to the product candidate. For example, a particular customer store segment may sell 100 flat beach sandals per week, and may carry an assortment of 4 flat beach sandals, resulting in a relative product rate of sale of 25 flat beach sandals per week per product. A different customer store segment may also sell 100 flat beach sandals per week, but may only carry an assortment of 10 flat beach sandals, resulting in a relative product rate of sale of 10 flat beach sandals per week per product. As can be seen, although the two customer store segments sell an identical number of flat beach sandals, the customer store segment may be under assorted, or may carry too few products that are of the flat beach sandal variety. Since it is apparent that the flat beach sandals sell well on a per product basis within the customer store segment in comparison to other customer store segments, the purchase recommendation may be a favorable recommendation to purchase the product candidate for the particular customer store segment.

FIG. 19A is a diagram illustrating a quadrant representations according to at least one example embodiment. As can be seen, FIG. 19A depicts a Cartesian representation of a set of quadrant representations, the set of quadrant representations comprising quadrant representations 1911, 1912, 1913, and 1914. The Cartesian representation illustrated in the example of FIG. 19A may be associated with a product candidate, the product candidate comprising a set of product candidate attributes. In such an example, a merchant may desire to utilize the Cartesian representation in order to facilitate determination of a purchase decision, an assortment decision, an inventory management decision, a business decision, and/or the like. In the example of FIG. 19A, axis 1902, the x-axis, indicates a relative product rate of sale, and axis 1904, the y-axis, indicates a relative intersegment quantity of sales. Origin 1906 may indicate an average value of the relative product rate of sale for the set of quadrant representations, an average value of the relative intersegment quantity of sales for the set of quadrant representations, a zero value origin for normalized relative product rate of sale and/or normalized relative intersegment quantity of sales, and/or the like. As illustrated, quadrant representation 1911 is associated with quadrant one, quadrant representation 1912 is associated with quadrant two, quadrant representation 1913 is associated with quadrant three, and quadrant representation 1914 is associated with quadrant four.

As illustrated in the example of FIG. 19A, the customer store segment represented by quadrant representation 1911 is associated with a relative intersegment quantity of sales that is higher than a relative intersegment quantity of sales that is associated with the customer store segment representation by quadrant representation 1912, and a relative product rate of sale that is higher than a relative product rate of sale. As such, the Cartesian representation may indicate that the product candidate may be a better fit within the customer store segment represented by quadrant representation 1911 than within the customer store segment represented by quadrant representation 1912. As such, a merchant may utilize such a comparison in order to efficiently and rationally make informed purchase decisions, assortment decisions, and/or the like.

In the example of FIG. 19A, the customer store segment represented by quadrant representation 1911 may be associated with a favorable purchase recommendation that strongly recommends the purchase of the product candidate for the customer store segment based, at least in part, on the location of quadrant representation 1911 in quadrant one. In the example of FIG. 19A, the customer store segment represented by quadrant representation 1912 may be associated with an favorable purchase recommendation that mandates purchase of the product candidate for the customer store segment based, at least in part, on the location of quadrant representation 1912 in quadrant two. In the example of FIG. 19A, the customer store segment represented by quadrant representation 1913 may be associated with an unfavorable purchase recommendation that recommends avoidance of purchase of the product candidate for the customer store segment based, at least in part, on the location of quadrant representation 1913 in quadrant three. Finally, in the example of FIG. 19A, the customer store segment represented by quadrant representation 1914 may be associated with a conditional purchase recommendation that conditionally recommends the purchase of the product candidate for the customer store segment based, at least in part, on the location of quadrant representation 1914 in quadrant four.

FIG. 19B is a diagram illustrating a quadrant representations according to at least one example embodiment. As can be seen, FIG. 19B depicts table representation 1920 of a set of quadrant representations, the set of quadrant representations comprising quadrant representations 1921, 1922, 1923, and 1924. In the example of FIG. 19B, the set of quadrant representations comprised by table representation 1920 corresponds with the set of quadrant representations comprised by the Cartesian representation of FIG. 19A. For example, quadrant representation 1921 of FIG. 19B corresponds with quadrant representation 1911 of FIG. 19A, such that the values associated with quadrant representation 1921 of FIG. 19B in columns 1932, 1934, and 1936 indicate the values associated with the same in FIG. 19A. As can be seen, a quadrant associated with a particular quadrant representation may be determined absent utilization of a Cartesian representation of the set of quadrant representations that comprises the particular quadrant representation. The values comprised by table representation 1920 may be relative values. As such, the position of origin 1906 in FIG. 19A may indicate an average of the relative values of the relative product rate of sale, the values of column 1932 of FIG. 19B, on the x-axis of FIG. 19A, and may indicate an average of the relative values of the relative intersegment quantity of sales, the values of column 1934 of FIG. 19B, on the y-axis of FIG. 19A.

Although the example of FIG. 19B depicts table representation 1920 as identifying quadrant representations 1921, 1922, 1923, and 1924 by way of the information comprised in columns 1932, 1934, and 1936, the actual content of table representation 1920 and the associated set of quadrant representations may vary. For example, the set of quadrant representations may be represented in a database, a data structure, a repository, a table, and/or the like, such that a quadrant may be determined for each quadrant representation and each associated customer store segment. For example, the set of quadrant representations may be a data structure that comprises the information of columns 1932 and 1934, such that a quadrant may be determined for each quadrant representation and each associated customer store segment based, at least in part, on the information of columns 1932 and 1934. In another example, the set of quadrant representations may be a data structure that comprises the information of column 1936. In such an example, the quadrant may have been predetermined, and stored in the data structure for subsequent retrieval.

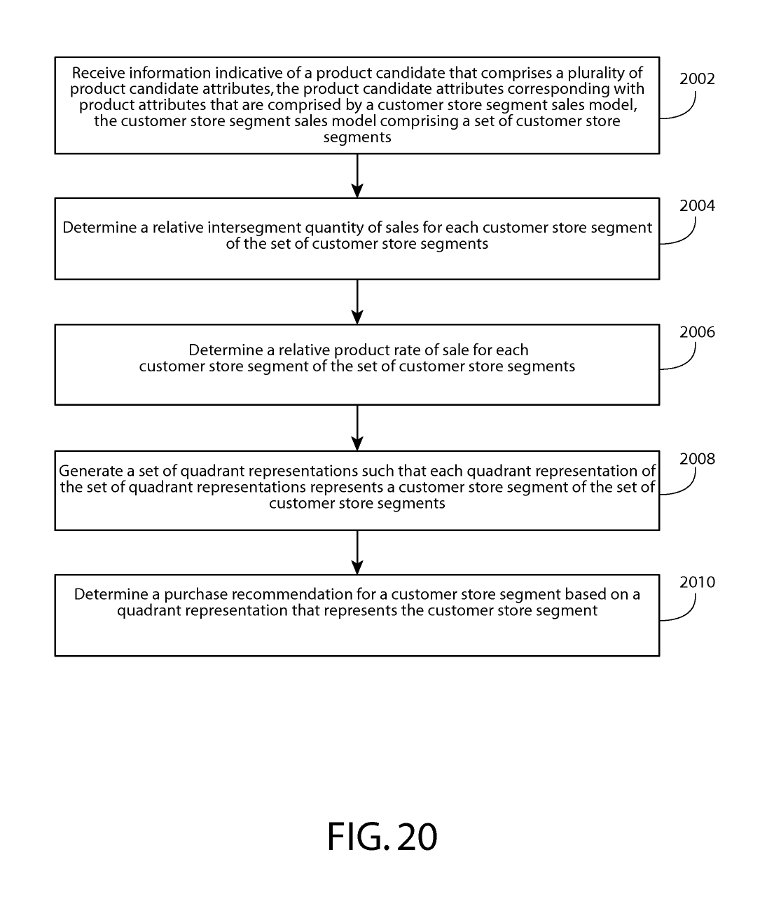

FIG. 20 is a flow diagram illustrating activities associated with identification of a plurality of clusters according to at least one example embodiment. In at least one example embodiment, there is a set of operations that corresponds with the activities of FIG. 20. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 20.

At block 2002, the apparatus receives information indicative of a product candidate that comprises a plurality of product candidate attributes. In at least one example embodiment, the product candidate attributes correspond with product attributes that are comprised by a customer store segment sales model. In at least one example embodiment, the customer store segment sales model comprises a set of customer store segments. The receipt, the product candidate, the product candidate attributes, the product attributes, the customer store segment sales model, and the set of customer store segments may be similar as described regarding FIGS. 2A-2B, FIGS. 3A-3E, FIGS. 4A-4C, FIGS. 5A-5E, FIGS. 13A-13B, FIGS. 16A-16B, and FIGS. 19A-19B.

At block 2004, the apparatus determines a relative intersegment quantity of sales for each customer store segment of the set of customer store segments. The determination and the relative intersegment quantity of sales may be similar as described regarding FIGS. 13A-13B and FIGS. 19A-19B.

At block 2006, the apparatus determines a relative product rate of sale for each customer store segment of the set of customer store segments. The determination and the relative intrasegment quantity of sales may be similar as described regarding FIGS. 16A-16B and FIGS. 19A-19B.

At block 2008, the apparatus generates a set of quadrant representations such that each quadrant representation of the set of quadrant representations represents a customer store segment of the set of customer store segments. In at least one example embodiment, the quadrant representation orthogonally correlates the relative intersegment quantity of sales for the customer store segment and the relative product rate of sale for the customer store segment. The generation and the set of quadrant representations may be similar as described regarding FIGS. 13A-13B, FIGS. 16A-16B, and FIGS. 19A-19B.

At block 2010, the apparatus determines a purchase recommendation for a customer store segment based, at least in part, on a quadrant representation that represents the customer store segment. The determination and the purchase recommendation may be similar as described regarding FIGS. 19A-19B.

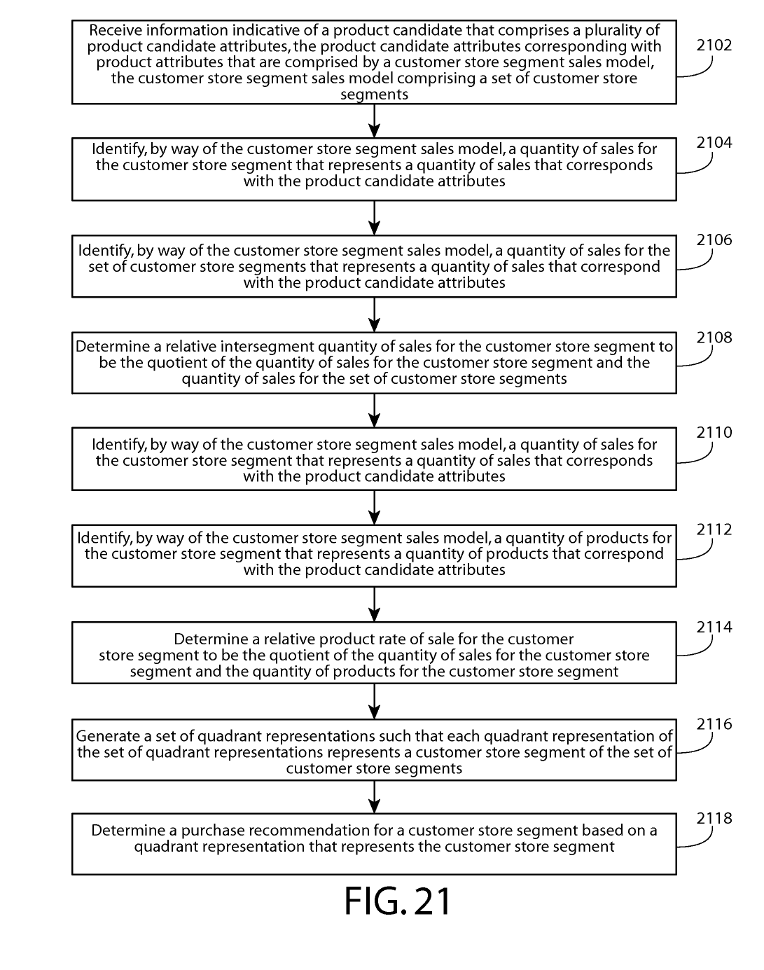

FIG. 21 is a flow diagram illustrating activities associated with identification of a plurality of clusters according to at least one example embodiment. In at least one example embodiment, there is a set of operations that corresponds with the activities of FIG. 21. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 21.

At block 2102, the apparatus receives information indicative of a product candidate that comprises a plurality of product candidate attributes. In at least one example embodiment, the product candidate attributes correspond with product attributes that are comprised by a customer store segment sales model. In at least one example embodiment, the customer store segment sales model comprises a set of customer store segments. The receipt, the product candidate, the product candidate attributes, the product attributes, the customer store segment sales model, and the set of customer store segments may be similar as described regarding FIGS. 2A-2B, FIGS. 3A-3E, FIGS. 4A-4C, FIGS. 5A-5E, FIGS. 13A-13B, FIGS. 16A-16B, and FIGS. 19A-19B.

At block 2104, the apparatus identifies, by way of the customer store segment sales model, a quantity of sales for the customer store segment that represents a quantity of sales that corresponds with the product candidate attributes. The identification, the quantity of sales for the customer store segment, and the quantity of sales that correspond with the product candidate attributes may be similar as described regarding FIGS. 3A-3E, FIGS. 4A-4C, FIGS. 5A-5E, FIGS. 13A-13B, FIGS. 16A-16B, and FIGS. 19A-19B.

At block 2106, the apparatus identifies, by way of the customer store segment sales model, a quantity of sales for the set of customer store segments that represents a quantity of sales that correspond with the product candidate attributes. The identification, the quantity of sales for the set of customer store segments, and the quantity of sales that correspond with the product candidate attributes may be similar as described regarding FIGS. 3A-3E, FIGS. 4A-4C, FIGS. 5A-5E, FIGS. 13A-13B, FIGS. 16A-16B, and FIGS. 19A-19B.

At block 2108, the apparatus determines a relative intersegment quantity of sales for the customer store segment to be the quotient of the quantity of sales for the customer store segment and the quantity of sales for the set of customer store segments. The determination and the relative intersegment quantity of sales may be similar as described regarding FIGS. 13A-13B and FIGS. 19A-19B.

At block 2110, the apparatus identifies, by way of the customer store segment sales model, a quantity of sales for the customer store segment that represents a quantity of sales that corresponds with the product candidate attributes. The identification, the quantity of sales for the set of customer store segments, and the quantity of sales that correspond with the product candidate attributes may be similar as described regarding FIGS. 3A-3E, FIGS. 4A-4C, FIGS. 5A-5E, FIGS. 13A-13B, FIGS. 16A-16B, and FIGS. 19A-19B.

At block 2112, the apparatus identifies, by way of the customer store segment sales model, a quantity of products for the customer store segment that represents a quantity of products that correspond with the product candidate attributes. The identification, the quantity of products for the set of customer store segments, and the quantity of products that correspond with the product candidate attributes may be similar as described regarding FIGS. 3A-3E, FIGS. 4A-4C, FIGS. 5A-5E, FIGS. 13A-13B, FIGS. 16A-16B, and FIGS. 19A-19B.

At block 2114, the apparatus determines a relative product rate of sale for the customer store segment to be the quotient of the quantity of sales for the customer store segment and the quantity of products for the customer store segment. The determination and the relative product rate of sale may be similar as described regarding FIGS. 16A-16B and FIGS. 19A-19B.

At block 2116, the apparatus generates a set of quadrant representations such that each quadrant representation of the set of quadrant representations represents a customer store segment of the set of customer store segments. In at least one example embodiment, the quadrant representation orthogonally correlates the relative intersegment quantity of sales for the customer store segment and the relative product rate of sale for the customer store segment. The generation and the set of quadrant representations may be similar as described regarding FIGS. 13A-13B, FIGS. 16A-16B, and FIGS. 19A-19B.

At block 2118, the apparatus determines a purchase recommendation for a customer store segment based, at least in part, on a quadrant representation that represents the customer store segment. The determination and the purchase recommendation may be similar as described regarding FIGS. 19A-19B.

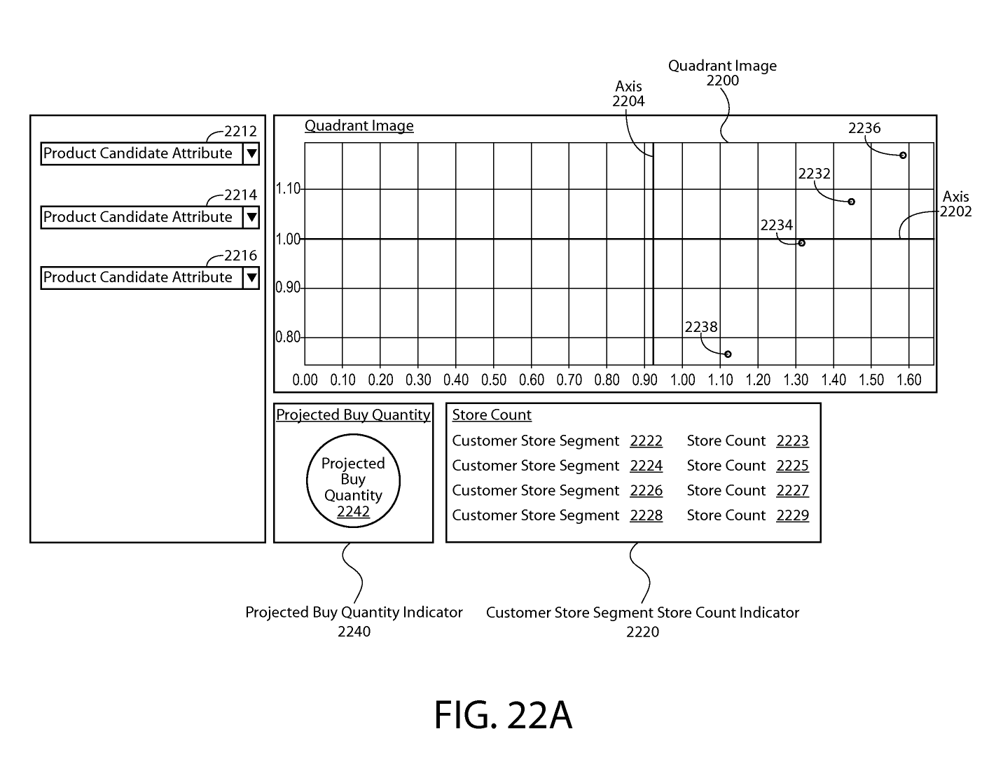

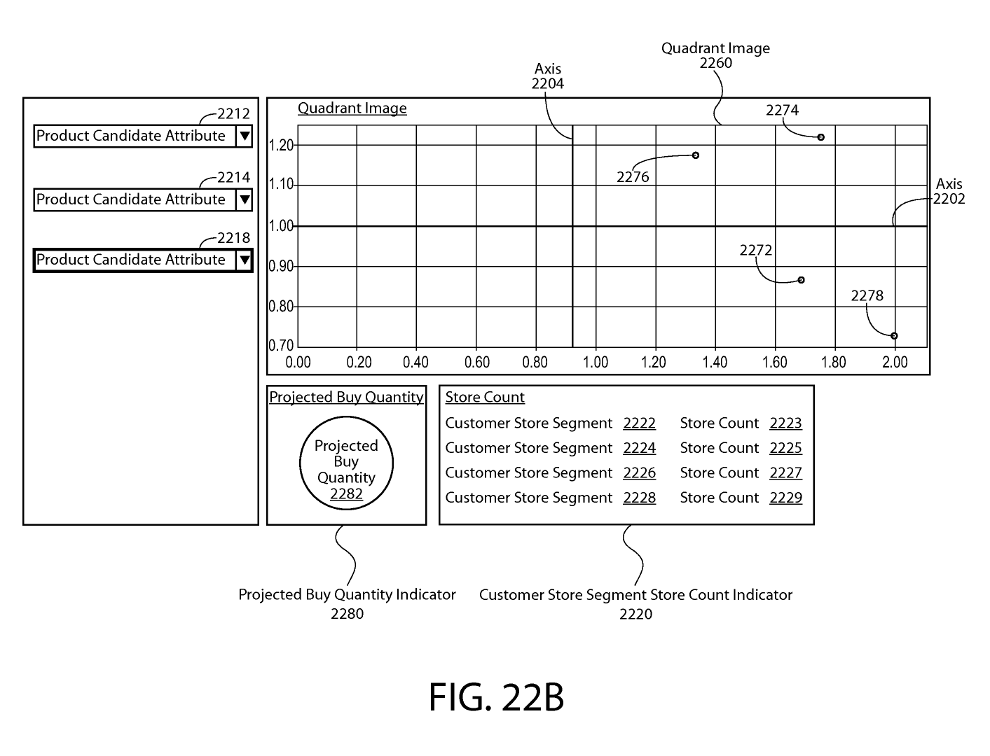

FIGS. 22A-22B are diagrams illustrating a plurality of product candidate attribute indicators in relation to a quadrant image, a store count indicator, and a projected buy quantity indicator according to at least one example embodiment. The examples of FIGS. 22A-22B are merely examples and do not limit the scope of the claims. For example, quadrant image design, configuration, placement, arrangement, and/or the like may vary, product candidate attribute indicator design, configuration, placement, arrangement, and/or the like may vary, store count indicator design, configuration, placement, arrangement, and/or the like may vary, and/or the like.

As described previously, in many circumstances, it may be desirable to provide assistance to a merchant in making informed business decisions, purchasing and assortment selections, and/or the like. As such, it may be desirable to facilitate selection of particular products by way of characteristics of the product, attributes of the product, and/or the like. In at least one example embodiment, a set of product attributes are identified. A product attribute may be an attribute of a product that classifies the product within a merchandise category. The product attribute may be an attribute that is descriptive of differences in styles of a products, descriptive of features of a product, indicative of a product characteristic that may influence the buying behavior of a customer, and/or the like.

In such circumstances, it may be desirable to reference sales data associated with a particular product attribute, a range of product attributes, a set of product attributes, and/or the like. For example, it may be desirable to base a future purchase decision on data that indicates historical sales performance of similar products, of products that are associated with similar product attributes, and/or the like. For example, it may be desirable to reference a customer store segment sales model to facilitate determination of a particular purchase order, product assortment, and/or the like. In such an example, the customer store segment sales model may comprise a set of customer store segments, historical sales data attributable to each customer store segment of the set of customer store segments, historical sales data attributable to particular products and/or product attributes, and/or the like.

As such, in many circumstances, it may be desirable to configure an apparatus such that a user of the apparatus may indicate a particular product candidate for consideration, for analysis in view of historical sales data, and/or the like. In at least one example embodiment, information indicative of a product candidate attribute selection input is received. In such an example embodiment, the product candidate attribute selection input may identify a product candidate attribute comprised by a product candidate. For example, the product candidate attribute may correspond with a product attribute that is comprised by a customer store segment sales model, such that future sales may be forecast based on the historical sales data comprised by the customer store segment sales model. In at least one example embodiment, the product candidate attribute selection input is an input that indicates selection of the product candidate attribute from a predetermined set of product candidate attributes. For example, the predetermined set of product candidate attributes may be represented by a drop-down menu. In such an example, the product candidate attribute selection input may be an input that selects the product candidate attribute from the drop-down menu. In another example, the product candidate attribute selection input may be an input that indicates selection of the product candidate attribute by way of a product candidate attribute icon that represents the product candidate attribute. In such an example, the product candidate attribute icon may be a graphical icon, a textual icon, a selection button, a radial button, a check box, and/or the like. In such an example, a user may indicate selection of a particular product candidate attribute by way of an input associated with a particular graphical icon, a textual icon, a selection button, a radial button, a check box, and/or the like.

In order to facilitate accurate and/or intuitive selection of one or more product candidate attributes, it may be desirable to configure an apparatus such that the apparatus provides visual feedback associated with such a selection, in response to receipt of a product candidate attribute selection input, and/or the like. In this manner, the user can readily understand the selection caused by the input by way of perceiving the visual feedback. In at least one example embodiment, a product candidate attribute indicator that indicates the product candidate attribute is caused to be displayed. For example, the product candidate attribute indicator may be displayed on a display, information indicative of the product candidate attribute indicator may be sent to a separate apparatus such that the separate apparatus is caused to display the product candidate attribute indicator, and/or the like. The display of the product candidate attribute indicator may, for example, be performed in response to the product candidate attribute selection input. In order to provide an intuitive and understandable user experience that accurately reflects user interactions and/or user selection of product candidate attributes, it may be desirable to cause display of a product candidate attribute indicator in a dynamic and fluid manner. For example, the causation of display of the product candidate attribute indicator may be performed absent an intervening input. In such an example, an intervening input may be an input that is received intermediate to the receipt of the product candidate attribute selection input and the causation of display of the product candidate attribute indicator. In this manner, a user may select a particular product candidate attribute by way of a product candidate attribute selection input and, in response and without an intervening input, perceive display of a product candidate attribute indicator that indicates the particular product candidate attribute. Such display of the product candidate attribute indicator absent intervening input allows the user to perceive the causal relationship between the selection input and the display of the product candidate attribute indicator without wondering about any causal relationship between the display of the product candidate attribute indicator and any intervening input.

In some circumstances, it may be desirable to group various product candidate attributes by their associated product candidate attribute type. For example, it may be intuitive to group product candidate attributes that indicate a color of the product candidate into a color product candidate attribute type, group product candidate attributes that indicate a material of the product candidate into a material product candidate attribute type, group product candidate attributes that indicate a style of the product candidate into a style product candidate attribute type, and/or the like. In this manner, grouping product candidate attributes by their product candidate attribute types may provide a user with a more intuitive user experience by way of enabling a user to perceive various relationships between a plurality of product candidate attributes, categorization among a plurality of product candidate attributes, and/or the like. The product candidate attribute type may be indicative of one or more characteristics associated with the product candidate attribute, descriptive of a classification of the product candidate attribute, and/or the like. In at least one example embodiment, a product candidate attribute type indicator that indicates a product candidate attribute type of the product candidate attribute is caused to be displayed. For example, the product candidate attribute type indicator may be displayed on a display, information indicative of the product candidate attribute type indicator may be sent to a separate apparatus such that the separate apparatus is caused to display the product candidate attribute type indicator, and/or the like.

As discussed previously, in order to facilitate a merchant in various purchase decisions, it may be desirable to classify potential future sales performance within a particular customer store segment in a manner that is easy and intuitive for the merchant. For example, the merchant may desire to view the classification of potential future sales performance of a product candidate in relation to a plurality of customer store segments in a manner that permits the merchant to quickly and intuitively make informed purchasing decisions, assortment decisions, business decisions, and/or the like, by way of quickly glancing at a visual representation of pertinent sales data. For example, such a classification may be determined by way of a quadrant representation. As such, it may be desirable to display information indicative of a quadrant representation, a set of quadrant representations, and/or the like, in a manner that facilitates a merchant's decision making process and allows the merchant to quickly and intuitively make informed business decisions. In at least one example embodiment, a quadrant image that depicts a set of quadrant representations is caused to be displayed. In such an example embodiment, the quadrant image may be displayed on a display, information indicative of the quadrant image may be sent to a separate apparatus such that the separate apparatus is caused to display the quadrant image, and/or the like. In such an example embodiment, the quadrant image may be caused to be displayed such that each quadrant representation of the set of quadrant representations represents a customer store segment of the set of customer store segments. For example, each quadrant representation may orthogonally correlate a relative intersegment quantity of sales for a customer store segment and a relative intrasegment quantity of sales for the customer store segment. In such an example, the set of quadrant representations may be depicted in the quadrant image in a manner that facilitates prompt comparisons to be made between various customer store segments, accurate assumptions to be made that may influence future purchasing decisions, and/or the like.

In at least one example embodiment, a quadrant image is determined. In such an example embodiment, the determination of the quadrant image may be based, at least in part, on the customer store segment sales model, the set of quadrant representations, and/or the like. In such an example embodiment, the causation of display of the quadrant image may be based, at least in part, on the determination of the quadrant image, may be in response to the determination of the quadrant image, and/or the like. In some circumstances, a quadrant image may be predetermined, pre-generated, and/or the like. As such, in at least one example embodiment, a quadrant image may be received from a memory, a repository, a separate apparatus, and/or the like. In such an example embodiment, the causation of display of the quadrant image may be based, at least in part, on the receipt of the quadrant image.

In order to facilitate a merchant's various decision making processes regarding product assortment, purchasing orders, inventory management, and/or the like, it may be desirable to configure an apparatus such that the apparatus provides the merchant with pertinent information that may influence such decisions. In at least one example embodiment, a store count indicator that indicates a store count is caused to be displayed. For example, the store count indicator may be displayed on a display, information indicative of the store count indicator may be sent to a separate apparatus such that the separate apparatus is caused to display the store count indicator, and/or the like. The display of the store count indicator may, for example, be in response to the product candidate attribute selection input. In order to provide an intuitive and understandable user experience that accurately reflects a user's interactions, it may be desirable to cause display of a store count indicator in a dynamic and fluid manner. For example, the causation of display of the store count indicator may be performed absent an intervening input. In such an example, an intervening input may be an input that is received intermediate to the receipt of the product candidate attribute selection input and the causation of display of the store count indicator. In this manner, a user may select a particular product candidate attribute by way of a product candidate attribute selection input and, in response and without an intervening input, perceive display of a store count indicator that indicates a store count. Such display of the store count indicator absent intervening input allows the user to perceive the causal relationship between the product candidate attribute selection input and the display of the store count indicator without wondering about any causal relationship between the display of the product candidate attribute indicator and any intervening input.

In at least one example embodiment, a store count is an aggregate count of stores comprised by the customer store segment sales model. For example, the store count may be determined to be a summation of a number of stores comprised by each set of stores for each customer store segment of the set of customer store segments. For example, a set of customer store segments may comprise four customer store segments, each customer store segment may comprise two sets of stores, and each set of stores may comprise eight stores. In such an example, the store count may be determined to be sixty-four stores, the summation of the number of stores comprised by each set of stores for each customer store segment of the set of customer store segments. The causation of display of the store count indicator may be based, at least in part, on the determination of the store count, may be in response to the determination of the store count, and/or the like.

In some circumstances, a merchant may desire to be able to distinguish between a high volume and low volume customer store segments, between high volume and low volume stores within a particular customer store segment, and/or the like. For example, a customer store segment may be divided into two or more sub-segments based, at least in part, on a relative sales volume attributable to stores within the customer store segment. For example, stores having a sales volume that exceeds a particular volume threshold may be grouped into a high volume sub-segment of the customer store segment, stores having a sales volume that fails to exceed the particular volume threshold may be grouped into a low volume sub-segment of the customer store segment, and/or the like. In at least one example embodiment, each customer store segment of the set of customer store segments is classified as either a high volume customer store segment or a low volume customer store segment based, at least in part, on the customer store segment sales model. In such an example, the classification of each customer store segment of the set of customer store segments may be based, at least in part, on a quantity of sales associated with the customer store segment. In order to convey such information to a user, such as a merchant, it may be desirable to cause display of a customer store segment volume indicator. In such an example, the customer store segment volume indicator may be a table that correlates each customer store segment to a particular volume, may be a graph that correlates each customer store segment to a relative volume, may be a chart that arranges each customer store segment relative to other customer store segments based, at least in part, on a quantity of sales associated with the customer store segment, and/or the like. In another example, a first customer store segment and a second customer store segment may be displayed differently based, at least in part, on a quantity of sales associated with the first customer store segment and the second customer store segment.

In many circumstances, much of a merchant's analysis and decision making processes focus on determination of a purchase order for a particular product based, at least in part, on forecasted sales of the product. In this manner, it may be desirable to configure an apparatus such that the apparatus may calculate a recommended purchase order to a particular product based, at least in part, on a customer store segment sales model, historical sales data attributable to a specific set of customer store segments, historical rates of sale attributable to similar products and/or similar product types, and/or the like. In at least one example embodiment, a projected buy quantity indicator that indicates a projected buy quantity is caused to be displayed. For example, the projected buy quantity indicator may be displayed on a display, information indicative of the projected buy quantity indicator may be sent to a separate apparatus such that the separate apparatus is caused to display the projected buy quantity indicator, and/or the like. The display of the projected buy quantity indicator may, for example, be in response to the product candidate attribute selection input. In order to provide an intuitive and understandable user experience that accurately reflects a user's interactions, it may be desirable to cause display of a projected buy quantity indicator in a dynamic and fluid manner. For example, the causation of display of the projected buy quantity indicator may be performed absent an intervening input. In such an example, an intervening input may be an input that is received intermediate to the receipt of the product candidate attribute selection input and the causation of display of the projected buy quantity indicator. In this manner, a user may select a particular product candidate attribute by way of a product candidate attribute selection input and, in response and without an intervening input, perceive display of a projected buy quantity indicator that indicates the projected buy quantity. In such an example, the projected buy quantity indicator may indicate a projected buy quantity that is based, at least in part, on the project candidate attribute selected by way of the product candidate attribute selection input.

In at least one example embodiment, projected buy quantity is a recommended purchase order for the product candidate. For example, the projected buy quantity may be determined to be a product of a rate of sale, a sales duration, and a store count. For example, historical sales data comprised by a customer store segment sales model may indicate that the rate of sale of similar product may have been ten units per week per store. In such an example, the merchant may desire to offer the product for sale for twelve weeks and in all fifty stores. In such an example, the projected buy quantity may be determined to be six thousand units, the product of the rate of sale of ten units per week per store, the sales duration of twelve weeks, and the store count of fifty stores. Although the previous example describes the projected buy quantity as a straight product of the three aforementioned variables, the manner in which the projected buy quantity is determined does not necessarily limit the scope of the claims. For example, the projected buy quantity may be based, at least in part, on weighted variables, multipliers, projections, expansion plans, growth factors, fashion trends, and/or the like. For example, the projected buy quantity may be trended up in comparison with historical sales data if the market for such a product is growing, if the merchant has experienced or desires to promote growth, and/or the like. The causation of display of the projected buy quantity indicator may be based, at least in part, on the determination of the projected buy quantity, may be in response to the determination of the projected buy quantity, and/or the like.

In another example, demand for a particular product may be sporadic, seasonal, and/or the like. In such an example, the demand for the particular product may be predictable, probabilistic, and/or the like. As such, the projected buy quantity may be based, at least in part, on an inventory policy, a statistical model indicative of demand for a particular product candidate, and/or the like. For example, a merchant may desire to stock sufficient inventory such that a predetermined percentage of total demand is maintained, such that a predetermined portion of total demand is satisfied, and/or the like. Such an inventory policy, stocking model, and/or the like may take into account the probabilistic nature of demand for a particular product candidate, may accommodate for irregularities in total demand that may not be apparent in an average level of demand or an average rate of sale, and/or the like. In another example, the projected buy quantity may be based, at least in part, on a presentation minimum associated with a particular product candidate. For example, the presentation minimum may indicate a minimum number of items that may be displayed on a rack, placed on a shelf, and/or the like. Such a presentation minimum may be utilized in order to maintain an aesthetically pleasing display arrangement, in order to provide a range of sizes of a particular product candidate, and/or the like. In such an example, although a particular store may expect to sell only 6 units of a product candidate, the projected buy quantity may be based, at least in part, on a presentation minimum, such as 10 units per store, 20 units per store, and/or the like. As such, the projected buy quantity may be based, at least in part, on one or more of the aforementioned modifiers, minimums, and/or the like.

FIG. 22A is a diagram illustrating a plurality of product candidate attribute indicators in relation to a quadrant image, a store count indicator, and a projected buy quantity indicator according to at least one example embodiment. The example of FIG. 22A depicts quadrant image 2200, product candidate attribute indicators 2212, 2214, and 2216, customer store segment store count indicator 2220, and projected buy quantity indicator 2240 that indicates projected buy quantity 2242.

As depicted in the example of FIG. 22A, quadrant image 2200 comprises information indicative of quadrant representations 2232, 2234, 2236, and 2238 in relation to axis 2202 and 2204. The set of quadrant representations and the depiction of each of quadrant representations 2232, 2234, 2236, and 2238 in relation to axis 2202 and 2204 may be similar as described regarding FIGS. 13A-13B, FIGS. 16A-16B, and FIGS. 19A-19B. In the example of FIG. 22A, quadrant representation 2232 is representative of customer store segment 2222, quadrant representation 2234 is representative of customer store segment 2224, quadrant representation 2236 is representative of customer store segment 2226, and quadrant representation 2238 is representative of customer store segment 2228. As can be seen in the example of FIG. 22A, each of product candidate attribute indicators 2212, 2214, and 2216 indicate a product candidate attribute associated with a product candidate. In the example of FIG. 22A, customer store segment store count indicator 2220 indicates that customer store segment 2222 comprises the number of stores indicated by store count 2223, indicates that customer store segment 2224 comprises the number of stores indicated by store count 2225, indicates that customer store segment 2226 comprises the number of stores indicated by store count 2227, and indicates that customer store segment 2228 comprises the number of stores indicated by store count 2229.

FIG. 22B is a diagram illustrating a plurality of product candidate attribute indicators in relation to a quadrant image, a store count indicator, and a projected buy quantity indicator according to at least one example embodiment. As discussed previously, in some circumstances, a user may desire to modify one or more product candidate attributes during a particular decision making and/or purchasing process. As can be seen in the progress from FIG. 22A to FIG. 22B, the product candidate attribute indicated by product candidate attribute indicator 2216 in FIG. 22A has been replaced by a different product candidate attribute indicated by product candidate attribute indicator 2218 in FIG. 22B. In this matter, a product candidate attribute selection input that selected the different product candidate attribute indicated by product candidate attribute indicator 2218 in FIG. 22B may have been received subsequent to the scenario depicted in the example of FIG. 22A. Alternatively, a product candidate attribute selection input that selected the product candidate attribute indicated by product candidate attribute indicator 2216 in FIG. 22A may have been received subsequent to the scenario depicted in the example of FIG. 22B.

As can be seen, as a result of the change to the product candidate attributes, quadrant image 2200 of FIG. 22A has been replaced by quadrant image 2260 in FIG. 22B. As depicted in the example of FIG. 22B, quadrant image 2260 comprises information indicative of quadrant representations 2272, 2274, 2276, and 2278 in relation to axis 2202 and 2204. The set of quadrant representations and the depiction of each of quadrant representations 2272, 2274, 2276, and 2278 in relation to axis 2202 and 2204 may be similar as described regarding FIGS. 13A-13B, FIGS. 16A-16B, and FIGS. 19A-19B. In the example of FIG. 22B, quadrant representation 2272 is representative of customer store segment 2222, quadrant representation 2274 is representative of customer store segment 2224, quadrant representation 2276 is representative of customer store segment 2226, and quadrant representation 2278 is representative of customer store segment 2228. As can be seen, the arrangement of the quadrant representations within quadrant image 2260 of FIG. 22B differs from the arrangement of the corresponding quadrant representations within quadrant image 2200 of FIG. 22A. In this manner, quadrant image 2260 reflects the set of quadrant representations resulting from the selection of the product candidate attribute indicated by product candidate attribute 2218.

Additionally, it can be seen in the example of FIG. 22B that the projected buy quantity associated with the product candidate has changed from projected buy quantity 2242 in the example of FIG. 22A to projected buy quantity 2282 in the example of FIG. 22B. In this manner, projected buy quantity 2282 indicated by projected buy quantity indicator 2280 is based, at least in part, on the product candidate attributes indicated by product candidate attribute indicators 2212, 2214, and 2218, while projected buy quantity 2242 indicated by projected buy quantity indicator 2240 is based, at least in part, on the product candidate attributes indicated by product candidate attribute indicators 2212, 2214, and 2216. In this manner, a user may dynamically change one or more product candidate attributes and directly perceive a changed quadrant representation, a changed projected buy quantity, and/or the like, such that the user may formulate well-reasoned purchase decisions, inventory assortments, and/or the like.

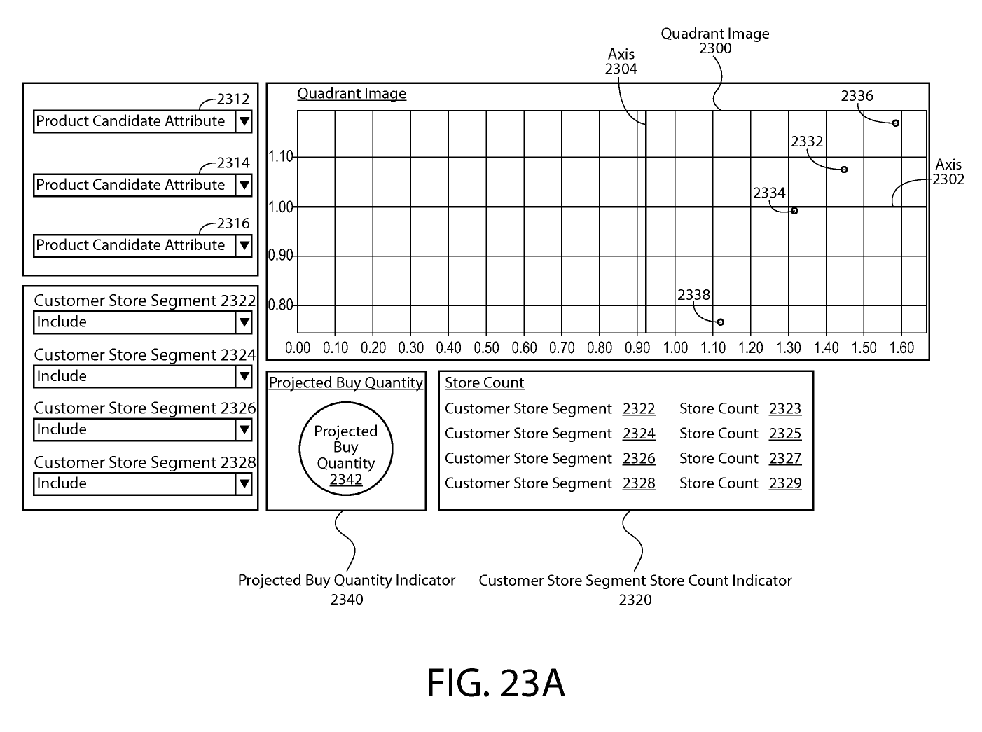

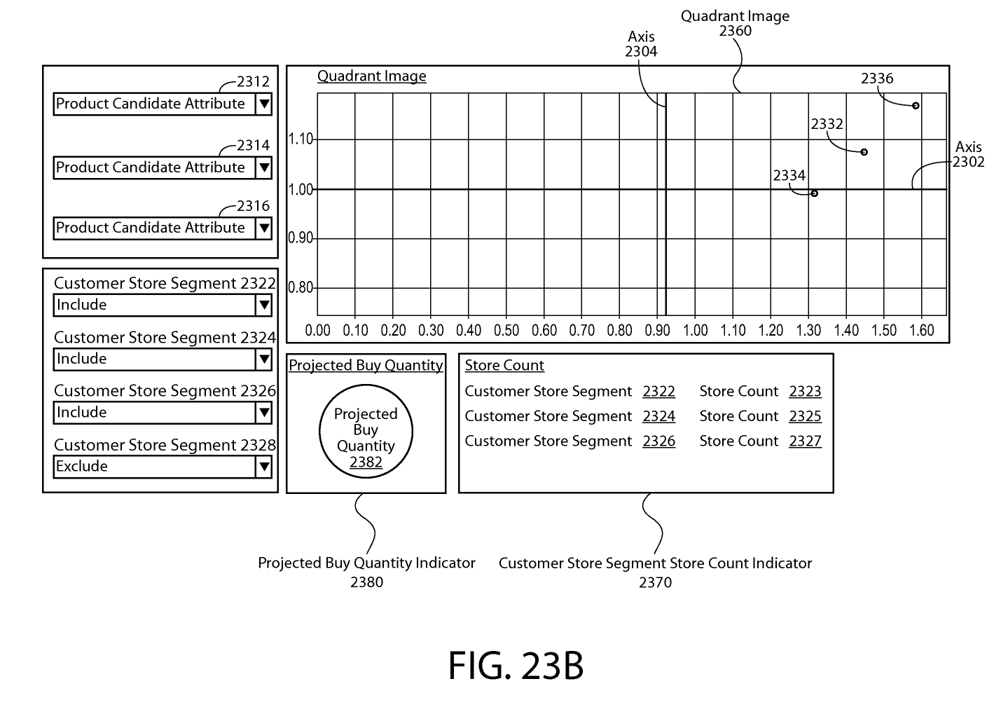

FIGS. 23A-23B are diagrams illustrating a plurality of product candidate attribute indicators in relation to a quadrant image, a store count indicator, and a projected buy quantity indicator according to at least one example embodiment. The examples of FIGS. 23A-23B are merely examples and do not limit the scope of the claims. For example, quadrant image design, configuration, placement, arrangement, and/or the like may vary, product candidate attribute indicator design, configuration, placement, arrangement, and/or the like may vary, store count indicator design, configuration, placement, arrangement, and/or the like may vary, and/or the like.

In some circumstances, a merchant may desire to vary product assortment across one or more customer store segments of a set of customer store segments. For example, a particular product may be better suited for stores in affluent areas, in regions that are predominately young to middle-aged, and/or the like. In such an example, a merchant may desire to cause adjustment to the projected buy quantity by way of inclusion of a particular customer store segment, exclusion of a particular customer store segment, and/or the like. For example, a set of customer store segments may include a first customer store segment and a second customer store segment. In such an example, the projected buy quantity may be based, at least in part, on the first customer store segment and the second customer store segment. For example, the projected buy quantity may be determined to be a projected buy quantity that is based, at least in part, on the first customer store segment and the second customer store segment. In such an example, it may be desirable to configure an apparatus such that a merchant may indicate a desire to include a particular customer store segment in the determination of the projected buy quantity, to exclude a particular customer store segment from the determination of the projected buy quantity, and/or the like.

For example, continuing the previous discussion, the customer store segment exclusion input may indicate exclusion of the second customer store segment. As such, in at least one example embodiment, information indicative of a customer store segment exclusion input that indicates exclusion of a customer store segment is received. In such an example, a changed projected buy quantity may be determined. Such a determination of the changed projected buy quantity may be in response to the customer store segment exclusion input that indicates exclusion of the second customer store segment. In such an example, the changed projected buy quantity may be based, at least in part, on the first customer store segment. In this manner, the changed projected buy quantity may be independent of the second customer store segment based, at least in part, on the customer store segment exclusion input that indicates exclusion of the second customer store segment. In order to convey such a change to the projected buy quantity to the merchant, it may be desirable to cause display of an updated projected buy quantity indicator. In at least one example embodiment, a changed projected buy quantity indicator that indicates the change projected buy quantity is caused to be displayed. The causation of display of the changed projected buy quantity indicator may be based, at least in part, on the receipt of the customer store segment exclusion input, may be in response to the customer store segment exclusion input, and/or the like. In at least one example embodiment, display of the projected buy quantity indicator is terminated. For example, display of the projected buy quantity indicator may be terminated prior to the causation of display of the changed projected buy quantity indicator, may be terminated subsequent to the causation of display of the changed projected buy quantity indicator, and/or the like. The causation of termination of display of the projected buy quantity indicator may be based, at least in part, on the receipt of the customer store segment exclusion input that indicates exclusion of the second customer store segment, may be in response to the customer store segment exclusion input that indicates exclusion of the second customer store segment, and/or the like.

In at least one example embodiment, information indicative of a customer store segment inclusion input that indicates inclusion of a customer store segment is received. For example, continuing the previous discussion, the customer store segment inclusion input may indicate re-inclusion of the second customer store segment. In such an example, a changed projected buy quantity may be determined. Such a determination of the changed projected buy quantity may be in response to the customer store segment inclusion input that indicates inclusion of the second customer store segment. In such an example, the changed projected buy quantity may be based, at least in part, on the first customer store segment and the second customer store segment. In this manner, the changed projected buy quantity may again be, at least partially, dependent on the second customer store segment based, at least in part, on the customer store segment inclusion input that indicates inclusion of the second customer store segment. In such an example embodiment, the changed projected buy quantity may be determined to be the originally determined projected buy quantity prior to the initial exclusion of the second customer store segment. In at least one example embodiment, a customer store segment inclusion indicator is caused to be displayed. A customer store segment inclusion indicator may be an indicator that indicates inclusion of a particular customer store segment, exclusion of a particular customer store segment, and/or the like. In at least one example embodiment, a customer store segment inclusion input is received at a position that corresponds with a display position of the customer store segment inclusion indicator. In at least one example embodiment, a customer store segment exclusion input is received at a position that corresponds with a display position of the customer store segment inclusion indicator.

FIG. 23A is a diagram illustrating a plurality of product candidate attribute indicators in relation to a quadrant image, a store count indicator, and a projected buy quantity indicator according to at least one example embodiment. The example of FIG. 23A depicts quadrant image 2300, product candidate attribute indicators 2312, 2314, and 2316, customer store segment store count indicator 2320, customer store segment inclusion indicators for each of customer store segments 2322, 2324, 2326, and 2328, and projected buy quantity indicator 2340 that indicates projected buy quantity 2342.

As depicted in the example of FIG. 23A, quadrant image 2300 comprises information indicative of quadrant representations 2332, 2334, 2336, and 2338 in relation to axis 2302 and 2304. The set of quadrant representations and the depiction of each of quadrant representations 2332, 2334, 2336, and 2338 in relation to axis 2302 and 2304 may be similar as described regarding FIGS. 13A-13B, FIGS. 16A-16B, and FIGS. 19A-19B. In the example of FIG. 23A, quadrant representation 2332 is representative of customer store segment 2322, quadrant representation 2334 is representative of customer store segment 2324, quadrant representation 2336 is representative of customer store segment 2326, and quadrant representation 2338 is representative of customer store segment 2328. As can be seen in the example of FIG. 23A, each of product candidate attribute indicators 2312, 2314, and 2316 indicate a product candidate attribute associated with a product candidate. In the example of FIG. 23A, customer store segment store count indicator 2320 indicates that customer store segment 2322 comprises the number of stores indicated by store count 2323, indicates that customer store segment 2324 comprises the number of stores indicated by store count 2325, indicates that customer store segment 2326 comprises the number of stores indicated by store count 2327, and indicates that customer store segment 2328 comprises the number of stores indicated by store count 2329.

As can be seen in the example of FIG. 23A, each of the customer store segment inclusion indicators customer store segments 2322, 2324, 2326, and 2328 indicate that the respective customer store segment is to be included in the calculation of projected by quantity 2382 indicated by projected buy quantity indicator 2380.

FIG. 23B is a diagram illustrating a plurality of product candidate attribute indicators in relation to a quadrant image, a store count indicator, and a projected buy quantity indicator according to at least one example embodiment. As discussed previously, in some circumstances, a user may desire to exclude one or more customer store segments during a particular decision making and/or purchasing process. For example, the user may determine that a customer store segment predominately in a tropical environment should not be considered when determining a number of heavy arctic coats to purchase. As can be seen in the progress from FIG. 23A to FIG. 23B, inclusion of customer store segment 2328 indicated by the respective customer store segment inclusion indicator in FIG. 23A has been changed to exclusion of customer store segment 2328 indicated by the respective customer store segment inclusion indicator in FIG. 22B. In this matter, a customer store segment exclusion input that indicated exclusion of customer store segment 2328 may have been received subsequent to the scenario depicted in the example of FIG. 23A, resulting in the scenario depicted in the example of FIG. 23B. Alternatively, a customer store segment inclusion input that indicated inclusion of customer store segment 2328 may have been received subsequent to the scenario depicted in the example of FIG. 23B, resulting in the scenario depicted in the example of FIG. 23A.

As can be seen in the example of FIG. 23B, quadrant image 2300 of FIG. 23A has been replaced by quadrant image 2360 in FIG. 23B. As depicted in the example of FIG. 23B, quadrant image 2360 comprises information indicative of quadrant representations 2332, 2334, and 2336 in relation to axis 2202 and 2204. As can be seen, quadrant representation 2338, depicted in quadrant image 2300 of FIG. 23A, is noticeably lacking in quadrant representation 2360. In this manner, the exclusion of customer store segment 2328 has resulted in the removal of the quadrant representation that represented customer store segment 2328 from the quadrant image. Similarly, customer store count indicator 2370 is noticeably lacking information indicative of customer store segment 2328 and its associated store count 2329 of FIG. 23A. In this manner, the exclusion of customer store segment 2328 has resulted in the removal of the information indicative of the customer store segment and its associated stores from the customer store segment store count indicator.

As such, it may be desirable to perceive the effect such an exclusion of customer store segment 2328 may have on a projected buy quantity. As can be seen, projected buy quantity indicator 2340 indicating projected buy quantity 2342 of FIG. 23A has been replaced by projected buy quantity indicator 2380 indicating projected buy quantity 2382 in FIG. 23A. In this manner, projected buy quantity 2342 may have been determined based, at least in part, on customer store segments 2322, 2324, 2326, and 2328, while projected buy quantity 2382 may have been determined based, at least in part, on customer store segments 2322, 2324, and 2326.

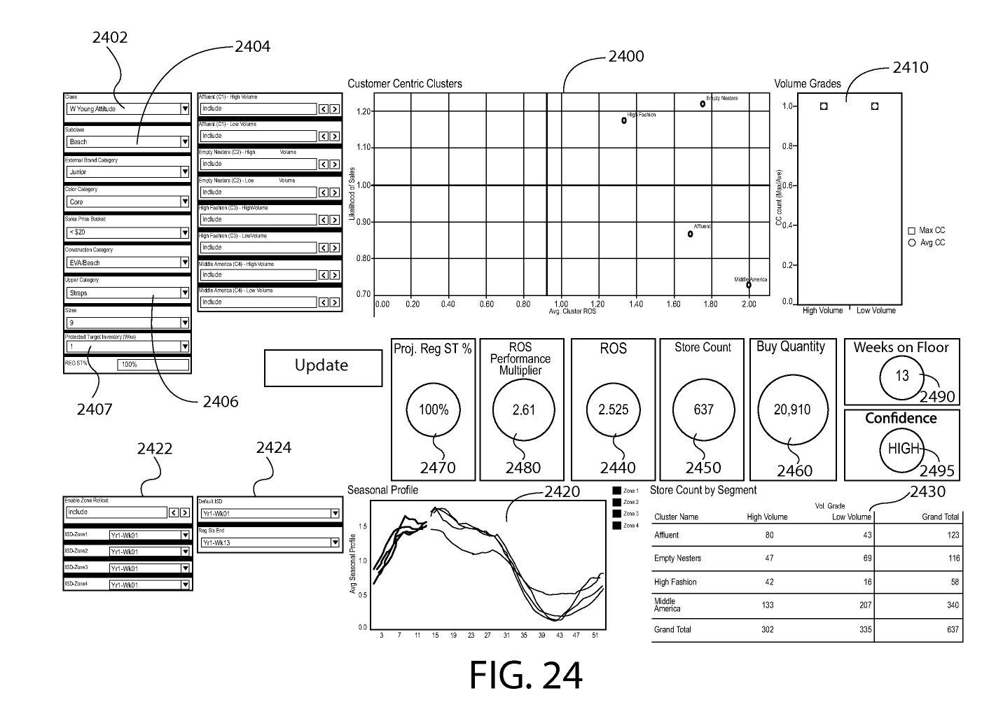

FIG. 24 is a diagram illustrating a plurality of product candidate attribute indicators in relation to a quadrant image, a store count indicator, and a projected buy quantity indicator according to at least one example embodiment. The example of FIG. 24 is merely an example and does not limit the scope of the claims. For example, quadrant image design, configuration, placement, arrangement, and/or the like may vary, product candidate attribute indicator design, configuration, placement, arrangement, and/or the like may vary, store count indicator design, configuration, placement, arrangement, and/or the like may vary, seasonal profile indicator design, configuration, placement, arrangement, and/or the like may vary and/or the like.

In order to facilitate a merchant's various decision making processes regarding product assortment, purchasing orders, inventory management, and/or the like, it may be desirable to configure an apparatus such that the apparatus provides the merchant with pertinent information that may influence such decisions. In at least one example embodiment, an aggregate rate of sale indicator that indicates an aggregate rate of sale is caused to be displayed. For example, the aggregate rate of sale indicator may be displayed on a display, information indicative of the aggregate rate of sale indicator may be sent to a separate apparatus such that the separate apparatus is caused to display the aggregate rate of sale indicator, and/or the like. The display of the aggregate rate of sale indicator may, for example, be in response to the product candidate attribute selection input. In order to provide an intuitive and understandable user experience that accurately reflects a user's interactions, it may be desirable to cause display of an aggregate rate of sale indicator in a dynamic and fluid manner. For example, the causation of display of the aggregate rate of sale indicator may be performed absent an intervening input. In such an example, an intervening input may be an input that is received intermediate to the receipt of the product candidate attribute selection input and the causation of display of the aggregate rate of sale indicator. In this manner, a user may select a particular product candidate attribute by way of a product candidate attribute selection input and, in response and without an intervening input, perceive display of an aggregate rate of sale indicator that indicates an aggregate rate of sale. For example, the aggregate rate of sale may be determined to be an average of a rate of sale attributable to the product candidate for each store comprised by each customer store segment of the set of customer store segments. For example, a set of customer store segments may comprise a first customer store segment and a second customer store segment. In such an example, a project candidate may have a rate of sale of twenty units per week per store for each of two stores within a first customer store segment and a rate of sale of forty units per week per store for each of three stores within a second customer store segment. In such an example, the aggregate rate of sale may be determined to be (20+20+40+40+40)/5=32 sales per week per store, the average of the rate of sale attributable to the product candidate for each store comprised by each customer store segment of the set of customer store segments.

Please note that the preceding example is merely an example and does not limit the scope of the claims. For example, the example reflects a simplified calculation and is merely demonstrative in nature. In practice, the aggregate rate of sale may be based, at least in part, on one or more additional factors, such as a seasonal profile, weighted averaged, multipliers, and/or the like. For example, the aggregate rate of sale may be based, at least in part, on a seasonal profile such that the aggregate rate of sale accounts for any distortion that may be caused by repeatable seasonal patterns. For example, the aforementioned aggregate rate of sale of 32 sales per week per store may fail to adequately characterize demand for a particular product at a particular time of year. For example, although the aggregate rate of sale for a winter parka may be 32 sales per week per store, the rate of sale of the winter parka will likely be higher in the fall and winter months, and lower in the spring and summer months. As such, the aggregate rate of sale may be analyzed in view of the seasonal profile. In this manner, the shape of the level of demand indicated in the seasonal profile may be applied to the aggregate rate of sale such that a relative demand may be determined for any point along the seasonal profile. Such an analysis may allow a merchant to perceive spikes and/or droughts in demand for a particular product candidate that may not otherwise be ascertainable by way of the aggregate rate of sale.

In some circumstances, a merchant may desire to perceive detailed information associated with a particular store count. For example, the merchant may desire to see what type of stores are represented by the store count, may desire to see a breakdown of customer store segments included in the store count, and/or the like. As such, it may be desirable to cause display of additional information pertaining to the store count. In at least one example embodiment, a customer store segment store count indicator that indicates a store count for each customer store segment of the set of customer store segments is caused to be displayed. For example, the customer store segment store count indicator may be displayed on a display, information indicative of the customer store segment store count indicator may be sent to a separate apparatus such that the separate apparatus is caused to display the customer store segment store count indicator, and/or the like. The display of the customer store segment store count indicator may, for example, be in response to the product candidate attribute selection input. In order to provide an intuitive and understandable user experience that accurately reflects a user's interactions, it may be desirable to cause display of a customer store segment store count indicator in a dynamic and fluid manner. For example, the causation of display of the customer store segment store count indicator may be performed absent an intervening input. In such an example, an intervening input may be an input that is received intermediate to the receipt of the product candidate attribute selection input and the causation of display of the customer store segment store count indicator. In this manner, a user may select a particular product candidate attribute by way of a product candidate attribute selection input and, in response and without an intervening input, perceive display of a customer store segment store count indicator that indicates an aggregate rate of sale. In at least one example embodiment, the customer store segment store count indicator is a customer store segment store count table that correlates each customer store segment of the set of customer store segments to a store count. For example, the customer store segment store count table may comprise information indicative of four customer store segments and associate each of the four customer store segments with a store count that represents the number of stores within the particular customer store segment. In some circumstances, the customer store segment store count indicator may be determined, generated, and/or the like, based, at least in part, on the customer store segment sales model. In at least one example embodiment, the customer store segment store count indicator corresponds with the customer store segment sales model.

In some circumstances, a merchant may desire to perceive detailed information associated with one or more characteristics associated with a particular customer store segment. For example, such characteristics may affect sell-through rates for a product, may affect sales durations for a product, may dictate product selection and/or product assortment for the particular customer store segment, and/or the like. For example, the merchant may desire to see what sort of climate is associated with a particular customer store segment, may desire to compare a phased roll-out and/or varying sales durations regarding a plurality of customer store segments, and/or the like. As such, it may be desirable to cause display of additional information pertaining to roll-out of a particular product, sales durations across a plurality of customer store segments, and/or the like. In at least one example embodiment, a seasonal profile indicator that indicates a seasonal profile for each customer store segment of the set of customer store segments is caused to be displayed. For example, the seasonal profile indicator may be displayed on a display, information indicative of the seasonal profile indicator may be sent to a separate apparatus such that the separate apparatus is caused to display the seasonal profile indicator, and/or the like. The display of the seasonal profile indicator may, for example, be in response to the product candidate attribute selection input. In order to provide an intuitive and understandable user experience that accurately reflects a user's interactions, it may be desirable to cause display of a seasonal profile indicator in a dynamic and fluid manner. For example, the causation of display of the seasonal profile indicator may be performed absent an intervening input. In such an example, an intervening input may be an input that is received intermediate to the receipt of the product candidate attribute selection input and the causation of display of the seasonal profile indicator. In this manner, a user may select a particular product candidate attribute by way of a product candidate attribute selection input and, in response and without an intervening input, perceive display of a seasonal profile indicator that indicates an aggregate rate of sale. In at least one example embodiment, the seasonal profile indicator is a seasonal profile graph that indicates a seasonal profile for each customer store segment of the set of customer store segments. In such an example embodiment, the seasonal profile may be indicative of a sales duration for each customer store segment of the set of customer store segments. In such an example embodiment, the seasonal profile indicator may indicate a sales duration for each customer store segment of the set of customer store segments. The sales duration may, for example, comprise information indicative of an interval associated with the product candidate being offered for sale. For example, the sales duration may be indicative of a sales start date, a sales end date, a sales interval duration, and/or the like. In this manner, the seasonal profile indicator may indicate the sales start date, the sales end date, the sales interval duration, and/or the like, for each customer store segment of the set of customer store segments. As noted previously, the seasonal profile may also indicate a relative level of demand for a particular product candidate at a particular time of year. For example, the seasonal profile may be based, at least in part, on a rate of sale of the product candidate at a particular time of year. As such, a merchant may readily ascertain relative demand for a particular product during various times of years, seasons, and/or the like by way of the season profile. In some circumstances, the seasonal profile indicator may be determined based, at least in part, on the seasonal profile for each customer store segment of the set of customer store segments. In such circumstances, information indicative of the seasonal profile for each customer store segment of the set of customer store segments may be comprised by the customer store segment sales model, may be received from a memory, a repository, a separate apparatus, etc., and/or the like.

FIG. 24 is a diagram illustrating a plurality of product candidate attribute indicators in relation to a quadrant image, a store count indicator, and a projected buy quantity indicator according to at least one example embodiment. The example of FIG. 24 depicts a user interface comprising quadrant image 2400, product candidate attribute indicators 2402, 2404, and 2406, protected target inventory interface element 2407, projected regular sell-through percentage interface element, update interface element, customer store segment volume indicator 2410, seasonal profile indicator 2420, sales duration indicators 2422 and 2424, customer store segment store count indicator 2430, aggregate rate of sale indicator 2440, store count indicator 2450, projected buy quantity indicator 2460, projected regular sell-through percentage indicator 2470, rate of sale performance multiplier indicator 2480, weeks on floor indicator 2490, and confidence indicator 2495. As can be seen in the example of FIG. 24, the three product candidate attributes indicated by product candidate attribute indicators 2402, 2404, and 2406 have been selected. The product candidate attributes may, for example, characterize a product candidate that a merchant desires to make available for sale in certain stores, in certain customer store segments, and/or the like. As can been seen in the example of FIG. 24, both high and low volume sub-segments of four customer store segments, “Affluent”, “Empty Nesters”, “High Fashion”, and “Middle America”, are included in the determination of the projected buy quantity indicated by projected buy quantity indicator 2460.

In some circumstances, it may be desirable to determine a projected buy quantity such that certain business strategies, sales goals, and/or the like are satisfied. For example, it may be desirable to ensure that an adequate level of inventory for a particular product is maintained during an introductory period, a period of enhanced demand for the product, and/or the like. As such, a merchant may utilize a protected target inventory period that indicates a duration associated with maintenance of a predetermined level of inventory. For example, the protected target inventory period may indicate that a certain level of inventory, for instance, a quantity sufficient to meet up to seventy-five percent, eighty percent, etc. of customer demand, accounting for the random and/or varied nature of the customer demand, needs to be maintained for a particular duration of time, such as two weeks, six weeks, one month, one quarter, and/or the like. Such a protected target inventory period may facilitate the balancing of product availability during important selling periods, such as certain quarters, seasons, holidays, etc., with avoiding excessive remaining inventory in the weeks prior to the end of the sales period. Such a balance may allow the level of inventory to fall prior to the clearance of the remaining inventory, usually at discounted prices, and/or the like. In the example of FIG. 24, protected target inventory interface element 2407 indicates a desire to protect inventory for one week at the beginning of the sales duration, after which time the level of inventory may be allowed to degrade as the sales duration progresses.

In the example of FIG. 24, seasonal profile indicator 2420 depicts a seasonal profile graph for each of the four customer store segments. As indicated by sales duration indicators 2422 and 2424, each of the four customer store segments will begin selling the product candidate the first week of the first year, and will discontinue selling the product candidate the thirteenth week of the first year. Although, in the example of FIG. 24, there is not a zoned roll out of the product across the customer store segments, in some circumstances, sales duration indicator 2422 may indicate various different start dates for each of the customer store segments. As such, it can be seen in the example of FIG. 24 that seasonal profile 2420 indicates the sales duration for each of the four customer store segments by way of a bolded seasonal profile graph line for the weeks between the first week and the thirteenth week of the first year. As can be seen, weeks on floor indicator 2490 indicates a sales duration associated with the product candidate. The sales duration indicated by weeks on floor indicator 2490 may be an average of each sales duration attributable to each customer store segment of the set of customer store segments, a total duration of time from the earliest start date to the latest end date attributable to the selected set of customer store segments, and/or the like.

In the example of FIG. 24, customer store segment store count indicator 2430 is a customer store segment store count table that correlates each of the four customer store segments with a store count. As can be seen, each customer store segment has been divided into a high volume sub-segment and a low volume sub-segment. In the example of FIG. 24, the customer store segment store count table comprises a store count for each of the two sub-segments per customer store segment, as well as row and column summations for total high volume store count, total low volume store count, total store count for each customer store segment, and a grand total store count for the set of customer store segments. Additionally, as can be seen in the example of FIG. 24, the store count for the set of customer store segments is indicated by store count indicator 2450.

As depicted in the example of FIG. 24, rate of sale performance multiplier indicator 2480 indicates a rate of sale performance multiplier for the particular product candidate. In some circumstances, a plurality of product candidates may be closely associated with one another. For example, such product candidates may share a number of common product candidate attributes, may be similar products in various colors, styles, etc., and/or the like. In such circumstances, although a particular type of product candidate may perform in a certain manner, may be associated with a certain rate of sale, and/or the like, a similar product candidate may perform in a different manner, may be associated with a different rate of sale, and/or the like. For example, although comfort flat sandals as a whole may be associated with a rate of sale of ten units per week per store, in the selected customer store segments, comfort flat sandals in a particular color, style, and/or the like may be associated with a rate of sale of twenty units per week per store in the selected store segments. In such an example, the rate of sale performance multiplier of the comfort flat sandals in the particular color, style, and/or the like may be 2, for the selected store segments, as the rate of sale of the comfort flat sandals in the particular color, style, and/or the like is double the rate of sale of the comfort flat sandals as a whole in the selected store segments. In the example of FIG. 24, rate of sale performance multiplier indicator 2480 indicates a rate of sale performance multiplier of 2.61. In this manner, a projected buy quantity may be determined based, at least in part, on the rate of sale performance multiplier indicated by rate of sale performance multiplier indicator 2480.

As depicted in the example of FIG. 24, aggregate rate of sale indicator 2440 indicates an aggregate rate of sale for the set of selected customer store segments. In the example of FIG. 24, aggregate rate of sale indicator 2440 indicates an aggregate rate of sale of 2.525 units per week per store. In this manner, a projected buy quantity may be determined based, at least in part, on the aggregate rate of sale indicated by aggregate rate of sale indicator 2440, the sales duration indicated by seasonal profile indicator 2420 and sales duration indicators 2422 and 2424, and the store count indicated by store count indicator 2450. In a highly simplified but illustrative example calculation of the projected buy quantity, multiplying 2.525 units per week per store, by 13 weeks, and 637 stores, results in a projected buy quantity of 20,910 units, as would be indicated by the projected buy quantity indicator 2460. It is important to note that this example is merely for illustrative purposes. The projected buy quantity may be based, at least in part, on any number of variables and/or information sources. For example, a more complex calculation may account for additional factors, such as variation in sales duration by customer store segment, implementation of a protected inventory period, and/or the like, as discussed previously.

In some circumstances, it may be desirable for the merchant to be aware of the forecasted percentage of the purchased inventory that is expected to sell at full retail price, prior to markdowns, discounts, clearance, and/or the like. In the example of FIG. 24, the merchant may have visibility to the sell-through percentage by way of projected regular sell-through percentage indicator 2470.

In many circumstances, it may be desirable to provide a user with an indication of statistical confidence in the projected buy quantity for a specific product candidate. For example, if the projected buy quantity is generated based, at least in part, on a limited data set, the confidence in the resulting projected buy quantity may be lower that if the projected buy quantity is generated based, at least in part, on a large and robust data set. In this manner, the statistical confidence associated with a projected buy quantity may be an indication of the relative number of instances within the historical sales data comprised by a customer store segment sales model. For example, the number of instances within the historical sales data may indicate a number of instances of sales that support the determination of a projected buy quantity, a number of prior sales of products similar to the product candidate, and/or the like. In another example, a particularly robust data set may nonetheless lack data that pertains to a particular set of product candidate attributes that characterize a particular product candidate. In such an example, the statistical confidence in the projected buy quantity may indicate a relative level of correspondence between an indicated set of product candidate attributes and product attributes comprised by the customer store segment sales model. In the example of FIG. 24, confidence indicator 2495 indicates a high level of confidence in the projected buy quantity indicated by projected buy quantity indicator 2460. Although the example of FIG. 24 depicts confidence indicator 2495 as indicating a relative confidence by way of a relative English language word, the confidence may be indicated by any statistical value commonly utilized in conveying a level of confidence resulting from a particular data set.

In many circumstances, it may be desirable to cause display of the various information and data described herein simultaneous to the display of a quadrant image. In such circumstances, a user may readily perceive information that may influence a variety of business decisions, such as assortment selection, purchase order quantity, and/or the like. For example, the display of a product candidate attribute indicator, a product candidate attribute type indicator, a store count indicator, a projected buy quantity indicator, an aggregate rate of sale indicator, a seasonal profile indicator, a customer store segment store count indicator, any other indicator that indicates information comprised by a customer store segment sales model, and/or the like, may be concurrent with the display of the quadrant image. In this manner, a user may simultaneously perceive the quadrant image and additional information indicated by the various indicators such that the user may quickly and intuitively form well-supported assumptions, business decisions, purchasing decisions, and/or the like. As can be seen in the example of FIG. 24, various indicators, including product candidate attribute indicators 2402, 2404, and 2406, projected buy quantity indicator 2460, customer store segment store count indicator 2430, seasonal profile indicator 2420, and/or the like, are displayed concurrently with quadrant image 2400.

Additionally, in many circumstances, it may be desirable to configure the user interface such that the various indicators are arranged in a logical spatial arrangement, in an arrangement that allows a user to quickly reference related information, in a manner that implies the procedural flow of the user interface, and/or the like. For example, the adjacency and/or relative adjacency of two or more indicators may be indicative of a relationship between the information indicated by the indicators. For example, an indicator that is adjacent to another indicator may be more often compared and/or referenced together by a user than a different indicator that fails to be adjacent to the indicator.

In another example, it may be desirable to group interface elements and/or indicators that may be user-changeable, user-selectable, associated with input, and/or the like. In such an example, for each of perception and interaction, it may be desirable to group all changeable indicators and/or interface elements in a particular region of the display, such as the leftward region of the display. In such an example, any output that is displayed as a result of the user interactions may be displayed in a different region, such as a rightward region. This leftward to rightward flow and/or a similar top to bottom flow of user interaction and user perception may be familiar to a user that commonly navigates through programs, information, internet sites, books, magazines, and/or the like. For example, in the example of FIG. 24, store count indicator 2450 is adjacent to various indicators, such as customer store segment store count indicator 2430 and projected buy quantity indicator 2460. As can be seen, customer store segment store count indicator 2430 is directly associated with store count indicator 2450. Additionally, the projected buy quantity indicated by projected buy quantity indicator 2460 is directly dependent on the store count indicated by store count indicator 2450. In this manner, a user may quickly reference related information that is indicated by adjacent indicators. For example, in at least one example embodiment, the display of the projected buy quantity indicator may be performed such that the projected buy quantity indicator is proximate to the store count indicator, the display of the store count indicator is performed such that the store count indicator is proximate to the projected buy quantity indicator, and/or the like. In such an example embodiment, the projected buy quantity indicator being proximate to the store count indicator may be associated with the projected buy quantity indicator and the store count indicator being displayed within a predefined display region. The predefined display region may be a directional region, such as a leftward region, a rightward region, a top region, a bottom region, and/or the like, an input region, an output region, and/or the like. In such an example, the projected buy quantity indicator being proximate to the store count indicator may be associated with the projected buy quantity indicator being displayed at a position that is adjacent to a position of the store count indicator.

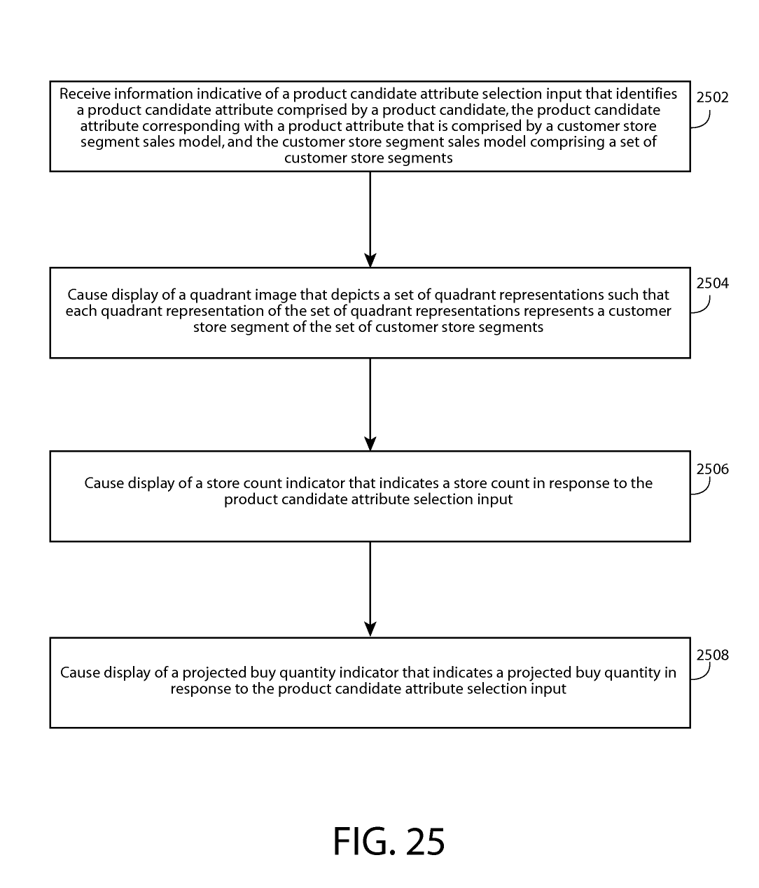

FIG. 25 is a flow diagram illustrating activities associated with causation of display of a projected buy quantity indicator that indicates a projected buy quantity according to at least one example embodiment. In at least one example embodiment, there is a set of operations that corresponds with the activities of FIG. 25. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 25.

At block 2502, the apparatus receives information indicative of a product candidate attribute selection input that identifies a product candidate attribute comprised by a product candidate. In at least one example embodiment, the product candidate attribute corresponds with a product attribute that is comprised by a customer store segment sales model. In at least one example embodiment, the customer store segment sales model comprises a set of customer store segments. The receipt, the product candidate attribute selection input, the product candidate, the product candidate attribute, the product attribute, the customer store segment sales model, and the set of customer store segments may be similar as described regarding FIGS. 2A-2B, FIGS. 3A-3E, FIGS. 4A-4C, FIGS. 5A-5E, FIGS. 13A-13B, FIGS. 16A-16B, FIGS. 19A-19B, FIGS. 22A-22B, FIGS. 23A-23B, and FIG. 24.

At block 2504, the apparatus causes display of a quadrant image that depicts a set of quadrant representations such that each quadrant representation of the set of quadrant representations represents a customer store segment of the set of customer store segments. In at least one example embodiment, the quadrant representation orthogonally correlates a relative intersegment quantity of sales for the customer store segment and a relative intrasegment quantity of sales for the customer store segment. The causation, the display, the quadrant image, the set of quadrant representations, the relative intersegment quantity of sales, and the relative intrasegment quantity of sales may be similar as described regarding FIGS. 13A-13B, FIGS. 16A-16B, FIGS. 19A-19B, FIGS. 22A-22B, FIGS. 23A-23B, and FIG. 24.

At block 2506, the apparatus causes display of a store count indicator that indicates a store count in response to the product candidate attribute selection input. In at least one example embodiment, the display of the store count indicator is concurrent with the display of the quadrant image. The causation, the display, the store count indicator, and the store count may be similar as described regarding FIGS. 22A-22B, FIGS. 23A-23B, and FIG. 24.

At block 2508, the apparatus causes display of a projected buy quantity indicator that indicates a projected buy quantity in response to the product candidate attribute selection input. In at least one example embodiment, the display of the projected buy quantity indicator is concurrent with the display of the quadrant image. The causation, the display, the projected buy quantity indicator, and the projected buy quantity may be similar as described regarding FIGS. 22A-22B, FIGS. 23A-23B, and FIG. 24.

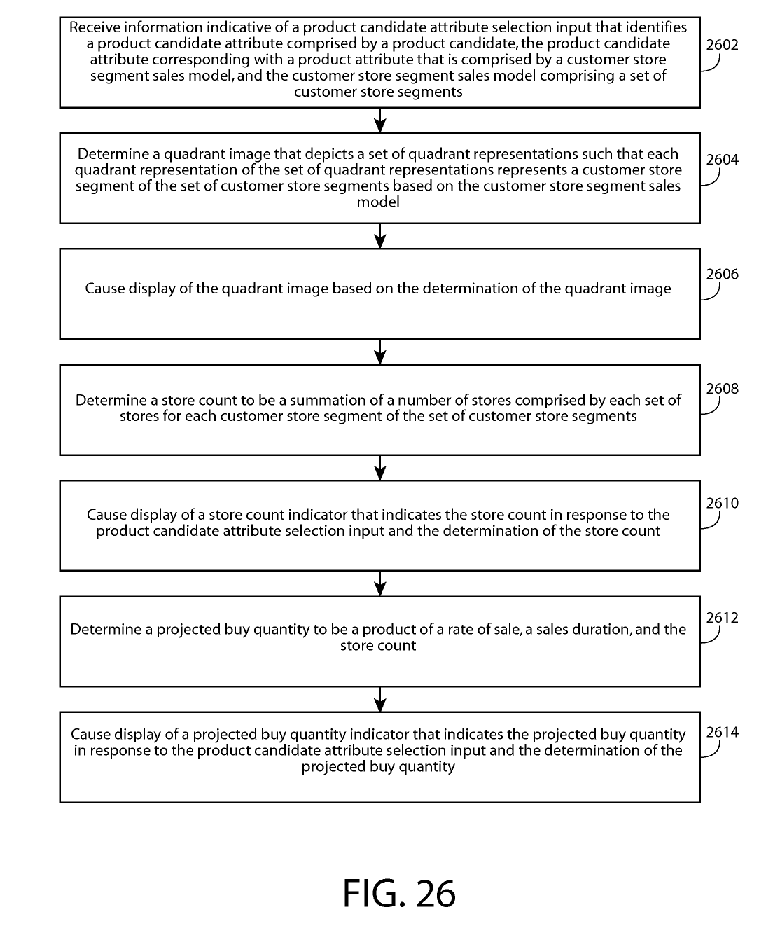

FIG. 26 is a flow diagram illustrating activities associated with causation of display of a projected buy quantity indicator that indicates a projected buy quantity according to at least one example embodiment. In at least one example embodiment, there is a set of operations that corresponds with the activities of FIG. 26. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 26.

At block 2602, the apparatus receives information indicative of a product candidate attribute selection input that identifies a product candidate attribute comprised by a product candidate. In at least one example embodiment, the product candidate attribute corresponds with a product attribute that is comprised by a customer store segment sales model. In at least one example embodiment, the customer store segment sales model comprises a set of customer store segments. The receipt, the product candidate attribute selection input, the product candidate, the product candidate attribute, the product attribute, the customer store segment sales model, and the set of customer store segments may be similar as described regarding FIGS. 2A-2B, FIGS. 3A-3E, FIGS. 4A-4C, FIGS. 5A-5E, FIGS. 13A-13B, FIGS. 16A-16B, FIGS. 19A-19B, FIGS. 22A-22B, FIGS. 23A-23B, and FIG. 24.

At block 2604, the apparatus determines a quadrant image that depicts a set of quadrant representations such that each quadrant representation of the set of quadrant representations represents a customer store segment of the set of customer store segments. In at least one example embodiment, the determination of the quadrant image is based, at least in part, on the customer store segment sales model. In at least one example embodiment, the quadrant representation orthogonally correlates a relative intersegment quantity of sales for the customer store segment and a relative intrasegment quantity of sales for the customer store segment. The determination, the quadrant image, the set of quadrant representations, the relative intersegment quantity of sales, and the relative intrasegment quantity of sales may be similar as described regarding FIGS. 13A-13B, FIGS. 16A-16B, FIGS. 19A-19B, FIGS. 22A-22B, FIGS. 23A-23B, and FIG. 24.

At block 2606, the apparatus causes display of the quadrant image based, at least in part, on the determination of the quadrant image. The causation and the display of the quadrant image may be similar as described regarding FIGS. 22A-22B, FIGS. 23A-23B, and FIG. 24.

At block 2608, the apparatus determines a store count to be a summation of a number of stores comprised by each set of stores for each customer store segment of the set of customer store segments. The determination, the store count, the summation, and the number of stores comprised by each set of stores may be similar as described regarding FIGS. 22A-22B, FIGS. 23A-23B, and FIG. 24.

At block 2610, the apparatus causes display of a store count indicator that indicates the store count in response to the product candidate attribute selection input and the determination of the store count. In at least one example embodiment, the display of the store count indicator is concurrent with the display of the quadrant image. The causation, the display, and the store count indicator may be similar as described regarding FIGS. 22A-22B, FIGS. 23A-23B, and FIG. 24.

At block 2612, the apparatus determines a projected buy quantity to be a product of a rate of sale, a sales duration, and the store count. The projected buy quantity, the rate of sale, and the sales duration may be similar as described regarding FIGS. 3A-3E, FIGS. 5A-5E, FIGS. 13A-13B, FIGS. 16A-16B, and FIGS. 19A-19B, FIGS. 22A-22B, FIGS. 23A-23B, and FIG. 24.

At block 2614, the apparatus causes display of a projected buy quantity indicator that indicates the projected buy quantity in response to the product candidate attribute selection input and the determination of the projected buy quantity. In at least one example embodiment, the display of the projected buy quantity indicator is concurrent with the display of the quadrant image. The causation, the display, and the projected buy quantity indicator may be similar as described regarding FIGS. 22A-22B, FIGS. 23A-23B, and FIG. 24.

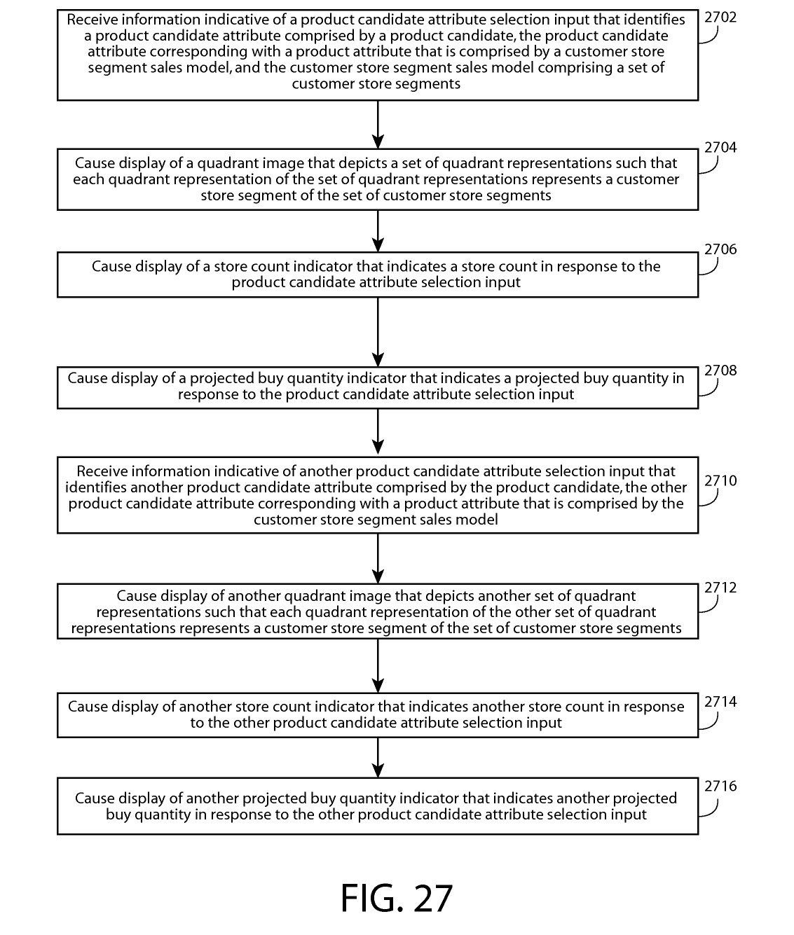

FIG. 27 is a flow diagram illustrating activities associated with causation of display of a projected buy quantity indicator that indicates a projected buy quantity according to at least one example embodiment. In at least one example embodiment, there is a set of operations that corresponds with the activities of FIG. 27. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 27.

At block 2702, the apparatus receives information indicative of a product candidate attribute selection input that identifies a product candidate attribute comprised by a product candidate. In at least one example embodiment, the product candidate attribute corresponds with a product attribute that is comprised by a customer store segment sales model. In at least one example embodiment, the customer store segment sales model comprises a set of customer store segments. The receipt, the product candidate attribute selection input, the product candidate, the product candidate attribute, the product attribute, the customer store segment sales model, and the set of customer store segments may be similar as described regarding FIGS. 2A-2B, FIGS. 3A-3E, FIGS. 4A-4C, FIGS. 5A-5E, FIGS. 13A-13B, FIGS. 16A-16B, FIGS. 19A-19B, FIGS. 22A-22B, FIGS. 23A-23B, and FIG. 24.

At block 2704, the apparatus causes display of a quadrant image that depicts a set of quadrant representations such that each quadrant representation of the set of quadrant representations represents a customer store segment of the set of customer store segments. In at least one example embodiment, the quadrant representation orthogonally correlates a relative intersegment quantity of sales for the customer store segment and a relative intrasegment quantity of sales for the customer store segment. The causation, the display, the quadrant image, the set of quadrant representations, the relative intersegment quantity of sales, and the relative intrasegment quantity of sales may be similar as described regarding FIGS. 13A-13B, FIGS. 16A-16B, FIGS. 19A-19B, FIGS. 22A-22B, FIGS. 23A-23B, and FIG. 24.

At block 2706, the apparatus causes display of a store count indicator that indicates a store count in response to the product candidate attribute selection input. In at least one example embodiment, the display of the store count indicator is concurrent with the display of the quadrant image. The causation, the display, the store count indicator, and the store count may be similar as described regarding FIGS. 22A-22B, FIGS. 23A-23B, and FIG. 24.

At block 2708, the apparatus causes display of a projected buy quantity indicator that indicates a projected buy quantity in response to the product candidate attribute selection input. In at least one example embodiment, the display of the projected buy quantity indicator is concurrent with the display of the quadrant image. The causation, the display, the projected buy quantity indicator, and the projected buy quantity may be similar as described regarding FIGS. 22A-22B, FIGS. 23A-23B, and FIG. 24.

At block 2710, the apparatus receives information indicative of another product candidate attribute selection input that identifies another product candidate attribute comprised by a product candidate. In at least one example embodiment, the other product candidate attribute corresponds with a product attribute that is comprised by the customer store segment sales model. The receipt, the other product candidate attribute selection input, the other product candidate attribute, and the product attribute may be similar as described regarding FIGS. 2A-2B, FIGS. 3A-3E, FIGS. 4A-4C, FIGS. 5A-5E, FIGS. 13A-13B, FIGS. 16A-16B, FIGS. 19A-19B, FIGS. 22A-22B, FIGS. 23A-23B, and FIG. 24.

At block 2712, the apparatus causes display of another quadrant image that depicts another set of quadrant representations such that each quadrant representation of the other set of quadrant representations represents a customer store segment of the set of customer store segments. In at least one example embodiment, the other quadrant representation orthogonally correlates a relative intersegment quantity of sales for the customer store segment and a relative intrasegment quantity of sales for the customer store segment. The causation, the display, the other quadrant image, the other set of quadrant representations, the relative intersegment quantity of sales, and the relative intrasegment quantity of sales may be similar as described regarding FIGS. 13A-13B, FIGS. 16A-16B, FIGS. 19A-19B, FIGS. 22A-22B, FIGS. 23A-23B, and FIG. 24.

At block 2714, the apparatus causes display of another store count indicator that indicates another store count in response to the product candidate attribute selection input. In at least one example embodiment, the display of the other store count indicator is concurrent with the display of the quadrant image. In at least one example embodiment, the other store count corresponds with the store count. In at least one example embodiment, the other store count indicator corresponds with the store count indicator. The causation, the display, the other store count indicator, and the other store count may be similar as described regarding FIGS. 22A-22B, FIGS. 23A-23B, and FIG. 24.

At block 2716, the apparatus causes display of another projected buy quantity indicator that indicates another projected buy quantity in response to the other product candidate attribute selection input. In at least one example embodiment, the display of the other projected buy quantity indicator is concurrent with the display of the other quadrant image. The causation, the display, the other projected buy quantity indicator, and the other projected buy quantity may be similar as described regarding FIGS. 22A-22B, FIGS. 23A-23B, and FIG. 24.

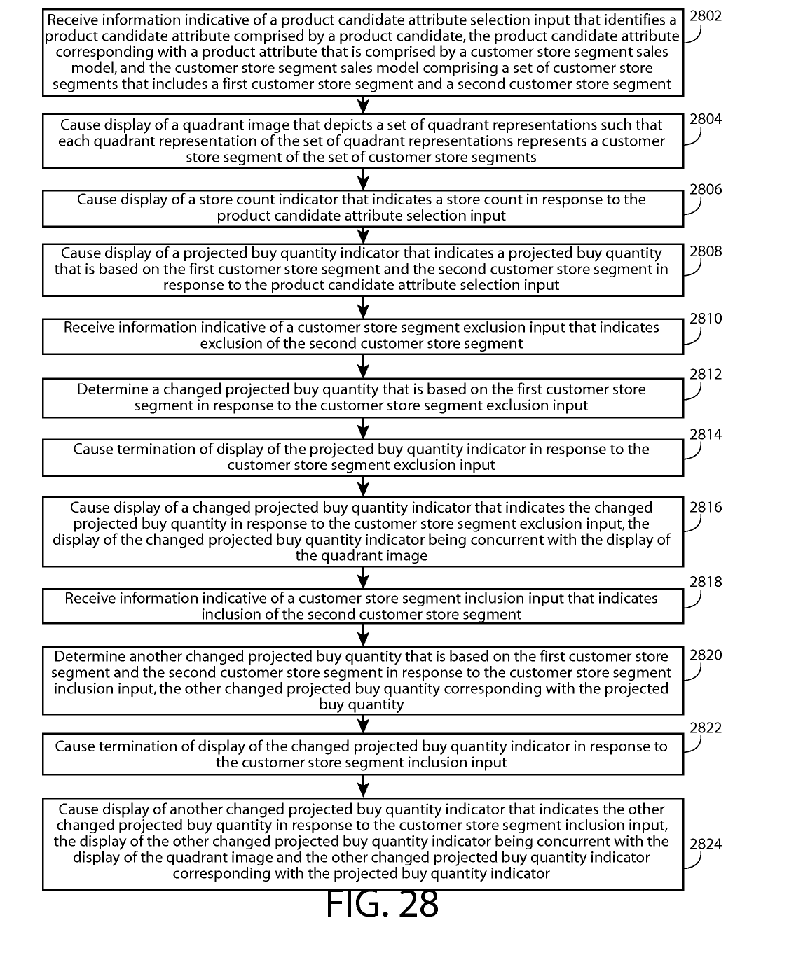

FIG. 28 is a flow diagram illustrating activities associated with causation of display of a projected buy quantity indicator that indicates a projected buy quantity according to at least one example embodiment. In at least one example embodiment, there is a set of operations that corresponds with the activities of FIG. 28. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 28.

At block 2802, the apparatus receives information indicative of a product candidate attribute selection input that identifies a product candidate attribute comprised by a product candidate. In at least one example embodiment, the product candidate attribute corresponds with a product attribute that is comprised by a customer store segment sales model. In at least one example embodiment, the customer store segment sales model comprises a set of customer store segments that includes a first customer store segment and a second customer store segment. The receipt, the product candidate attribute selection input, the product candidate, the product candidate attribute, the product attribute, the customer store segment sales model, the set of customer store segments, the first customer store segment, and the second customer store segment may be similar as described regarding FIGS. 2A-2B, FIGS. 3A-3E, FIGS. 4A-4C, FIGS. 5A-5E, FIGS. 13A-13B, FIGS. 16A-16B, FIGS. 19A-19B, FIGS. 22A-22B, FIGS. 23A-23B, and FIG. 24.

At block 2804, the apparatus causes display of a quadrant image that depicts a set of quadrant representations such that each quadrant representation of the set of quadrant representations represents a customer store segment of the set of customer store segments. In at least one example embodiment, the quadrant representation orthogonally correlates a relative intersegment quantity of sales for the customer store segment and a relative intrasegment quantity of sales for the customer store segment. The causation, the display, the quadrant image, the set of quadrant representations, the relative intersegment quantity of sales, and the relative intrasegment quantity of sales may be similar as described regarding FIGS. 13A-13B, FIGS. 16A-16B, FIGS. 19A-19B, FIGS. 22A-22B, FIGS. 23A-23B, and FIG. 24.

At block 2806, the apparatus causes display of a store count indicator that indicates a store count in response to the product candidate attribute selection input. In at least one example embodiment, the display of the store count indicator is concurrent with the display of the quadrant image. The causation, the display, the store count indicator, and the store count may be similar as described regarding FIGS. 22A-22B, FIGS. 23A-23B, and FIG. 24.

At block 2808, the apparatus causes display of a projected buy quantity indicator that indicates a projected buy quantity in response to the product candidate attribute selection input. In at least one example embodiment, the projected buy quantity is based, at least in part, on the first customer store segment and the second customer store segment. In at least one example embodiment, the display of the projected buy quantity indicator is concurrent with the display of the quadrant image. The causation, the display, the projected buy quantity indicator, and the projected buy quantity may be similar as described regarding FIGS. 22A-22B, FIGS. 23A-23B, and FIG. 24.

At block 2810, the apparatus receives information indicative of a customer store segment exclusion input that indicates exclusion of the second customer store segment. The receipt, the customer store segment exclusion input, and the exclusion of a customer store segment may be similar as described regarding FIGS. 23A-23B and FIG. 24.

At block 2812, the apparatus determines a changed projected buy quantity in response to the customer store segment exclusion input that indicates exclusion of the second customer store segment. In at least one example embodiment, the changed projected buy quantity is based, at least in part, on the first customer store segment. In at least one example embodiment, the changed projected buy quantity is independent of the second customer store segment based, at least in part, on the customer store segment exclusion input that indicates exclusion of the second customer store segment. The determination and the changed projected buy quantity may be similar as described regarding FIGS. 22A-22B, FIGS. 23A-23B, and FIG. 24.

At block 2814, the apparatus causes termination of display of the projected buy quantity indicator. In at least one example embodiment, the termination of display of the projected buy quantity indicator is in response to the customer store segment exclusion input that indicates exclusion of the second customer store segment. The causation and the termination of display may be similar as described regarding FIGS. 23A-23B and FIG. 24.

At block 2816, the apparatus causes display of a changed projected buy quantity indicator that indicates the changed projected buy quantity in response to the customer store segment exclusion input. In at least one example embodiment, the display of the changed projected buy quantity indicator is concurrent with the display of the quadrant image. The causation, the display, and the changed projected buy quantity indicator may be similar as described regarding FIGS. 22A-22B, FIGS. 23A-23B, and FIG. 24.

At block 2818, the apparatus receives information indicative of a customer store segment inclusion input that indicates inclusion of the second customer store segment. The receipt, the customer store segment inclusion input, and the inclusion of a customer store segment may be similar as described regarding FIGS. 23A-23B and FIG. 24.

At block 2820, the apparatus determines another changed projected buy quantity in response to the customer store segment inclusion input that indicates inclusion of the second customer store segment. In at least one example embodiment, the changed projected buy quantity is based, at least in part, on the first customer store segment and the second customer store segment. The determination and the other changed projected buy quantity may be similar as described regarding FIGS. 22A-22B, FIGS. 23A-23B, and FIG. 24.

At block 2822, the apparatus causes termination of display of the changed projected buy quantity indicator in response to the customer store segment inclusion input. The causation and the termination of display may be similar as described regarding FIGS. 22A-22B, FIGS. 23A-23B, and FIG. 24.

At block 2824, the apparatus causes display of another changed projected buy quantity indicator that indicates the other changed projected buy quantity in response to the customer store segment inclusion input. In at least one example embodiment, the display of the other changed projected buy quantity indicator is concurrent with the display of the quadrant image. In at least one example embodiment, the other changed projected buy quantity indicator corresponds with the projected buy quantity indicator. In at least one example embodiment, the other changed projected buy quantity corresponds with the projected buy quantity. The causation, the display, and the other changed projected buy quantity indicator may be similar as described regarding FIGS. 22A-22B, FIGS. 23A-23B, and FIG. 24.

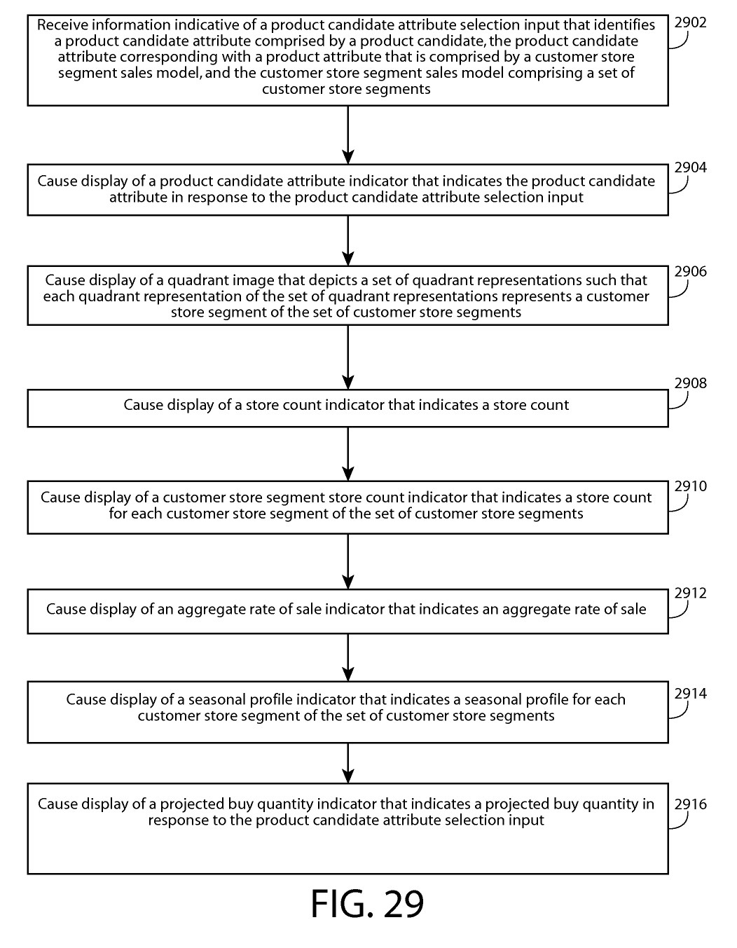

FIG. 29 is a flow diagram illustrating activities associated with causation of display of a projected buy quantity indicator that indicates a projected buy quantity according to at least one example embodiment. In at least one example embodiment, there is a set of operations that corresponds with the activities of FIG. 29. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 29.

At block 2902, the apparatus receives information indicative of a product candidate attribute selection input that identifies a product candidate attribute comprised by a product candidate. In at least one example embodiment, the product candidate attribute corresponds with a product attribute that is comprised by a customer store segment sales model. In at least one example embodiment, the customer store segment sales model comprises a set of customer store segments. The receipt, the product candidate attribute selection input, the product candidate, the product candidate attribute, the product attribute, the customer store segment sales model, and the set of customer store segments may be similar as described regarding FIGS. 2A-2B, FIGS. 3A-3E, FIGS. 4A-4C, FIGS. 5A-5E, FIGS. 13A-13B, FIGS. 16A-16B, FIGS. 19A-19B, FIGS. 22A-22B, FIGS. 23A-23B, and FIG. 24.

At block 2904, the apparatus causes display of a product candidate attribute indicator that indicates the project candidate attribute. In at least one example embodiment, the causation of display of the product candidate attribute indicator is in response to the project candidate attribute input. The causation, the display, and the product candidate attribute indicator may be similar as described regarding FIGS. 22A-22B, FIGS. 23A-23B, and FIG. 24.

At block 2906, the apparatus causes display of a quadrant image that depicts a set of quadrant representations such that each quadrant representation of the set of quadrant representations represents a customer store segment of the set of customer store segments. In at least one example embodiment, the quadrant representation orthogonally correlates a relative intersegment quantity of sales for the customer store segment and a relative intrasegment quantity of sales for the customer store segment. The causation, the display, the quadrant image, the set of quadrant representations, the relative intersegment quantity of sales, and the relative intrasegment quantity of sales may be similar as described regarding FIGS. 13A-13B, FIGS. 16A-16B, FIGS. 19A-19B, FIGS. 22A-22B, FIGS. 23A-23B, and FIG. 24.

At block 2908, the apparatus causes display of a store count indicator that indicates a store count in response to the product candidate attribute selection input. In at least one example embodiment, the display of the store count indicator is concurrent with the display of the quadrant image. The causation, the display, the store count indicator, and the store count may be similar as described regarding FIGS. 22A-22B, FIGS. 23A-23B, and FIG. 24.

At block 2910, the apparatus causes display of a customer store segment store count indicator that indicates a store count for each customer store segment of the set of customer store segments. In at least one example embodiment, the causation of display of the customer store segment store count indicator is in response to the project candidate attribute input. In at least one example embodiment, the display of the customer store segment store count indicator is concurrent with the display of the quadrant image. The causation, the display, the customer store segment store count indicator, and the store count for each customer store segment of the set of customer store segments may be similar as described regarding FIGS. 22A-22B, FIGS. 23A-23B, and FIG. 24.

At block 2912, the apparatus causes display of an aggregate rate of sale indicator that indicates an aggregate rate of sale. In at least one example embodiment, the aggregate rate of sale is an aggregate rate of sale for the set of customer store segments. In at least one example embodiment, the display of the aggregate rate of sale indicator is concurrent with the display of the quadrant image. The causation, the display, the aggregate rate of sale indicator, and the aggregate rate of sale may be similar as described regarding FIGS. 22A-22B, FIGS. 23A-23B, and FIG. 24.

At block 2914, the apparatus causes display of a seasonal profile indicator that indicates a seasonal profile for each customer store segment of the set of customer store segments. In at least one example embodiment, the display of the seasonal profile indicator is concurrent with the display of the quadrant image. The causation, the display, the seasonal profile indicator, and the seasonal profile may be similar as described regarding FIGS. 22A-22B, FIGS. 23A-23B, and FIG. 24.

At block 2916, the apparatus causes display of a projected buy quantity indicator that indicates a projected buy quantity in response to the product candidate attribute selection input. In at least one example embodiment, the display of the projected buy quantity indicator is concurrent with the display of the quadrant image. The causation, the display, the projected buy quantity indicator, and the projected buy quantity may be similar as described regarding FIGS. 22A-22B, FIGS. 23A-23B, and FIG. 24.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 608 of FIG. 6 may be performed before block 606 of FIG. 6. In another example, block 1404 of FIG. 14 may be performed after block 1406 of FIG. 14. In yet another example, block 2508 of FIG. 25 may be performed before block 2504 of FIG. 25. Furthermore, if desired, one or more of the above-described functions may be optional or may be combined. For example, block 1510 of FIG. 15 may be optional or may be combined with block 1504 of FIG. 15. In another example, block 2908 of FIG. 29 may be optional or may be combined with block 2910 of FIG. 29.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
receipt of information indicative of a product candidate attribute selection input that identifies a product candidate attribute comprised by a product candidate, the product candidate attribute corresponding with a product attribute that is comprised by a customer store segment sales model, and the customer store segment sales model comprising a set of customer store segments;
causation of display of a quadrant image that depicts a set of quadrant representations such that each quadrant representation of the set of quadrant representations represents a customer store segment of the set of customer store segments, and the quadrant representation orthogonally correlates a relative intersegment quantity of sales for the customer store segment and a relative intrasegment quantity of sales for the customer store segment;
causation of display of a store count indicator that indicates a store count in response to the product candidate attribute selection input, the display of the store count indicator being concurrent with the display of the quadrant image; and
causation of display of a projected buy quantity indicator that indicates a projected buy quantity in response to the product candidate attribute selection input, the display of the projected buy quantity indicator being concurrent with the display of the quadrant image.

2. The apparatus of claim 1, wherein the memory includes computer program code configured to, working with the processor, cause the apparatus to perform determination of the quadrant image based, at least in part, on the customer store segment sales model, wherein the causation of display of the quadrant image is based, at least in part, on the determination of the quadrant image.

3. The apparatus of claim 1, wherein the memory includes computer program code configured to, working with the processor, cause the apparatus to perform receipt of the quadrant image from at least one of a memory, a repository, or a separate apparatus, wherein the causation of display of the quadrant image is based, at least in part, on the receipt of the quadrant image.

4. The apparatus of claim 1, wherein the memory includes computer program code configured to, working with the processor, cause the apparatus to perform determination of the projected buy quantity to be a product of a rate of sale, a sales duration, and the store count.

5. The apparatus of claim 1, wherein the memory includes computer program code configured to, working with the processor, cause the apparatus to perform:
determination of an aggregate rate of sale to be an average of a rate of sale attributable to the product candidate for each store comprised by each customer store segment of the set of customer store segments; and
causation of display of an aggregate rate of sale indicator that indicates the aggregate rate of sale in response to the product candidate attribute selection input, such that the display of the aggregate rate of sale indicator is concurrent with the display of the quadrant image.

6. The apparatus of claim 1, wherein the set of customer store segments includes a first customer store segment and a second customer store segment, the projected buy quantity is based, at least in part, on the first customer store segment and the second customer store segment, and the memory includes computer program code configured to, working with the processor, cause the apparatus to perform:
receipt of information indicative of a customer store segment exclusion input that indicates exclusion of the second customer store segment;
determination of a changed projected buy quantity in response to the customer store segment exclusion input that indicates exclusion of the second customer store segment; and
causation of display of a changed projected buy quantity indicator that indicates the changed projected buy quantity in response to the customer store segment exclusion input, the display of the changed projected buy quantity indicator being concurrent with the display of the quadrant image.

7. The apparatus of claim 6, wherein the memory includes computer program code configured to, working with the processor, cause the apparatus to perform:
receipt of information indicative of a customer store segment inclusion input that indicates inclusion of the second customer store segment;
determination of another changed projected buy quantity in response to the customer store segment inclusion input that indicates inclusion of the second customer store segment such that the other changed projected buy quantity is the projected buy quantity; and
causation of display of another changed projected buy quantity indicator that indicates the other changed projected buy quantity in response to the customer store segment exclusion input, the display of the other changed projected buy quantity indicator being concurrent with the display of the quadrant image.

8. The apparatus of claim 1, wherein the product candidate attribute selection input is an input that indicates selection of the product candidate attribute from a predetermined set of product candidate attributes.

9. The apparatus of claim 1, wherein the product candidate attribute selection input is an input that indicates selection of the product candidate attribute by way of a product candidate attribute icon that represents the product candidate attribute.

10. A method comprising:
receiving information indicative of a product candidate attribute selection input that identifies a product candidate attribute comprised by a product candidate, the product candidate attribute corresponding with a product attribute that is comprised by a customer store segment sales model, and the customer store segment sales model comprising a set of customer store segments;
causing display of a quadrant image that depicts a set of quadrant representations such that each quadrant representation of the set of quadrant representations represents a customer store segment of the set of customer store segments, and the quadrant representation orthogonally correlates a relative intersegment quantity of sales for the customer store segment and a relative intrasegment quantity of sales for the customer store segment;
causing display of a store count indicator that indicates a store count in response to the product candidate attribute selection input, the display of the store count indicator being concurrent with the display of the quadrant image; and
causing display of a projected buy quantity indicator that indicates a projected buy quantity in response to the product candidate attribute selection input, the display of the projected buy quantity indicator being concurrent with the display of the quadrant image.

11. The method of claim 10, further comprising determining the quadrant image based, at least in part, on the customer store segment sales model, wherein the causation of display of the quadrant image is based, at least in part, on the determination of the quadrant image.

12. The method of claim 10, further comprising receiving the quadrant image from at least one of a memory, a repository, or a separate apparatus, wherein the causation of display of the quadrant image is based, at least in part, on the receipt of the quadrant image.

13. The method of claim 10, further comprising determining the projected buy quantity to be a product of a rate of sale, a sales duration, and the store count.

14. The method of claim 10, further comprising:
determining an aggregate rate of sale to be an average of a rate of sale attributable to the product candidate for each store comprised by each customer store segment of the set of customer store segments; and
causing display of an aggregate rate of sale indicator that indicates the aggregate rate of sale in response to the product candidate attribute selection input, such that the display of the aggregate rate of sale indicator is concurrent with the display of the quadrant image.

15. The method of claim 10, wherein the set of customer store segments includes a first customer store segment and a second customer store segment, the projected buy quantity is based, at least in part, on the first customer store segment and the second customer store segment, and further comprising:
receiving information indicative of a customer store segment exclusion input that indicates exclusion of the second customer store segment;
determining a changed projected buy quantity in response to the customer store segment exclusion input that indicates exclusion of the second customer store segment; and
causing display of a changed projected buy quantity indicator that indicates the changed projected buy quantity in response to the customer store segment exclusion input, the display of the changed projected buy quantity indicator being concurrent with the display of the quadrant image.

16. The method of claim 15, further comprising:
receiving information indicative of a customer store segment inclusion input that indicates inclusion of the second customer store segment;
determining another changed projected buy quantity in response to the customer store segment inclusion input that indicates inclusion of the second customer store segment such that the other changed projected buy quantity is the projected buy quantity; and
causing display of another changed projected buy quantity indicator that indicates the other changed projected buy quantity in response to the customer store segment exclusion input, the display of the other changed projected buy quantity indicator being concurrent with the display of the quadrant image.

17. At least one non-transitory computer-readable medium encoded with instructions that, when executed by a processor, perform:
receipt of information indicative of a product candidate attribute selection input that identifies a product candidate attribute comprised by a product candidate, the product candidate attribute corresponding with a product attribute that is comprised by a customer store segment sales model, and the customer store segment sales model comprising a set of customer store segments;
causation of display of a quadrant image that depicts a set of quadrant representations such that each quadrant representation of the set of quadrant representations represents a customer store segment of the set of customer store segments, and the quadrant representation orthogonally correlates a relative intersegment quantity of sales for the customer store segment and a relative intrasegment quantity of sales for the customer store segment;
causation of display of a store count indicator that indicates a store count in response to the product candidate attribute selection input, the display of the store count indicator being concurrent with the display of the quadrant image; and
causation of display of a projected buy quantity indicator that indicates a projected buy quantity in response to the product candidate attribute selection input, the display of the projected buy quantity indicator being concurrent with the display of the quadrant image.

18. The medium of claim 17, further encoded with instructions that, when executed by a processor, perform determination of the quadrant image based, at least in part, on the customer store segment sales model, wherein the causation of display of the quadrant image is based, at least in part, on the determination of the quadrant image.

19. The medium of claim 17, further encoded with instructions that, when executed by a processor, perform receipt of the quadrant image from at least one of a memory, a repository, or a separate apparatus, wherein the causation of display of the quadrant image is based, at least in part, on the receipt of the quadrant image.

20. The medium of claim 17, further encoded with instructions that, when executed by a processor, perform determination of the projected buy quantity to be a product of a rate of sale, a sales duration, and the store count.
